(19) United States
(12) Patent Application Publication
(10) Pub. No.: US 2026/0093237 A1
(43) Pub. Date: Apr. 2, 2026

(54) Generating optimized process variable values and control data for an additive construction process

(71) Applicant: EOS GMBH ELECTRO OPTICAL SYSTEMS, Krailling (DE)

(72) Inventor: Peter Holfelder-Schwalme, Saal an der Donau (DE)

(21) Appl. No.: 19/112,579

(22) PCT Filed: Sep. 28, 2023
(86) PCT No.: PCT/EP2023/076875

§ 371 Date: Mar. 17, 2025

(30) Foreign Application Priority Data
Sep. 29, 2022 (DE) 10 2022 125 147.0

(51) Int. Cl. G05B 19/4099

(52) U.S. Cl. CPC G05B 19/4099; G05B 2219/49023

(57) ABSTRACT

Disclosed is a method and a device for generating optimized process variable values for an additive manufacturing process of a manufacturing product. For this purpose, requirement data of the manufacturing product is provided. An optimization process is then carried out in order to determine the optimized process variable values while taking into consideration the requirement data, wherein at least one optimized scanning direction distribution for at least one region of the manufacturing product is determined as an optimized process variable value using an AI-based optimization unit. The optimized process variable values are then provided. Further disclosed is a method and a control data generating device for generating control data, to a method for creating an AI-based optimization unit, to a control method, and to a controller for a production device for the additive manufacturing process, and to a corresponding production device.

The invention relates to a method and a device for generating or determining optimized process variable values for an additive manufacturing process of a manufacturing product (hereinafter also referred to as “component”), to a method and a control data generation device for generating control data for a production device for additive manufacturing of at least one manufacturing product in an additive manufacturing process, and to a method and a controller for controlling a production device for additive manufacturing of a manufacturing product. The invention further relates to a method for creating an AI-based optimization unit, for example a neural network, which can be used in one of the aforementioned methods. The invention also relates to a production device for additive manufacturing of manufacturing products in an additive manufacturing process with at least one such controller.

Additive manufacturing processes (also known as “additive construction processes”) are becoming increasingly relevant in the production of prototypes and now also in series production. In general, “additive manufacturing processes” are those manufacturing processes in which the manufacturing product is usually built up on the basis of digital 3D design data by depositing material (the “construction material”). The construction usually, but not necessarily, takes place in layers. The term “3D printing” is often used as a synonym for additive manufacturing; the production of models, samples and prototypes using additive manufacturing processes is often referred to as “rapid prototyping” and the production of tools as “rapid tooling”.

One basic way of realizing an additive manufacturing process involves the selective solidification of the construction material, wherein this solidification can take place in many manufacturing processes with the help of radiant energy, e.g. electromagnetic radiation, in particular light and/or heat radiation, but possibly also with particle radiation, such as electron radiation. Such processes using irradiation are also known as “beam melting processes”. Examples of this are so-called “laser powderbed fusion processes” (also known as “selective laser sintering” or “selective laser melting”) or “electron powderbed fusion processes”. In this case, thin layers of a mostly powdered construction material are repeatedly applied on top of each other, and in each layer the construction material is selectively solidified by spatially limited irradiation of the points that are to be part of the manufacturing product to be manufactured after production in a kind of “welding process”, in which the powder grains of the construction material are partially or completely melted with the help of the energy introduced locally by the radiation at this point. After cooling, these powder grains are then bonded together to form a solid.

When solidifying the construction material, the energy beam is guided along predetermined scan paths, usually taking into account a defined irradiation strategy, usually a so-called “hatching strategy”, within the contours of the region to be solidified in the respective layer over the layer located on the construction field in order to melt and solidify the material in a desired spatial and temporal sequence. In addition, further process parameter values, such as an intensity, a focus extent or an energy beam extent (e.g. an energy beam diameter) and a form of the intensity distribution (or the intensity profile) as well as a feed rate (or scanning speed) of the energy beam, a thickness of the layers, etc. are specified and should be adhered to as closely as possible.

The latest findings show that, in additive manufacturing, some of the process variables have a significant influence on the resulting local microstructure in the component. This can be the case, not only, but above all, with metals as the construction material. The microstructure in turn results in component properties at macro level and thus the quality of the component, in particular whether it fulfils certain quality requirements. As will be explained later, the key process variables can include not only the aforementioned process parameter values of the energy beam, but also the hatching strategy in particular. Furthermore, all of these process variables also have an influence on the construction speed and therefore on productivity, energy consumption and construction costs. When optimizing some of the process parameters, i.e. selecting suitable process parameter values, it may be necessary to weigh up competing objectives (such as construction speed on the one hand and rigidity or strength of the component on the other).

Similarly, in other additive manufacturing processes, e.g. processes in which material is only applied at the desired points by means of a material application head, which subsequently solidifies or is solidified, various process variables, in particular the choice of material solidification paths (in the following, such solidification paths are also generally referred to as “scan paths”) and the feed rate, etc., can have a considerable influence on the component properties and quality of the component on the one hand and the productivity on the other, which is why the process variable values must be selected skillfully. This also applies in principle to additive manufacturing processes such as powder deposition (laser cladding) and wire deposition (direct energy deposition (DED) or wire-based arc-light additive manufacturing (WAAM)).

It is therefore an object of the present invention to provide suitable methods for generating optimized process variable values for an additive manufacturing process and for generating control data based thereon or for additive manufacturing of a manufacturing product, as well as suitable devices therefor.

This object is achieved by a method for generating optimized process variable values according to claim 1, a method for generating control data according to claim 11, a method for controlling a production device for additive manufacturing of a manufacturing product according to claim 12, a method for creating an AI-based optimization unit according to claim 13, a device for generating optimized process variable values according to claim 14, a control data generation device according to claim 15, a controller for a production device for additive manufacturing of a manufacturing product according to claim 16 and a production device for additive manufacturing of manufacturing products according to claim 17.

The method according to the invention for generating or determining optimized process variable values for an additive manufacturing process (or construction process) of a manufacturing product comprising a plurality of layers of a construction material has at least the following method steps:

Firstly, requirement data for the manufacturing product is provided. This includes, for example, geometric data for the manufacturing product. In the simplest case, the geometric data can be only maximum dimensions, which can, for example, be determined by the available build space, and/or minimum dimensions. However, the geometric data can also include certain exact dimensions, e.g. of parts or sections of the component, such as dimensions of connecting pieces in order to be able to couple the component with other parts, lengths of the component to be maintained precisely in certain directions of extension, etc. In particular, they can also include the exact dimensions of the component with all details. The geometric data can be provided in any way, for example by input at a user interface, by transfer from other program parts, networks and/or data memories. For example, the geometric data can also include CAD data of the component, which can be transferred from a design program, for example. However, the requirement data can also include data relating to other requirements in particular, such as mechanical stress requirements and heat treatment requirements, etc. If no special heat treatment is required after production of the component, the heat treatment requirements are, for example, simply the thermal requirements resulting from the cooling of the component, in particular the cooling rates. The heat treatment requirements are usually defined by a function with a time-temperature profile (i.e. a temperature-time curve function). In many cases, e.g. if the component cools down after production without any special measures, these heat treatment requirements (or a corresponding function that defines these heat requirements) can also be disregarded in the optimization process.

Taking into account the requirement data, an optimization process is then carried out in the method according to the invention to determine the optimized process variable values. At least one optimized scanning direction distribution for at least one region of the manufacturing product is determined as an optimized process variable value using an AI-based optimization unit. Here, “AI-based” means that the optimization unit is based on artificial intelligence (AI). For example, this may be a neural network, as will be explained in greater detail later using examples.

Such a “region of the manufacturing product” can be, for example, a (virtual) segment of the component, which, as will be explained later, preferably extends over several layers. As will also be explained, a component can be divided (virtually) into so-called “segments”, wherein a segment here preferably comprises a partial section/region of the manufacturing product. The sum of the segments of the manufacturing product then results in the manufacturing product. However, it is also possible—particularly in the case of small objects—for the complete manufacturing product to be formed from just one segment. More complex components, however, usually comprise several segments. In principle, however, the “region of the manufacturing product” itself can also include several segments or any sections or the entire manufacturing product.

A scanning direction distribution in a segment will also be referred to hereinafter as a “segment scanning direction distribution”, since it is a distribution of the scanning directions within the segment. A segment scanning direction distribution thus specifies the frequency with which scanning directions (for example what scanning direction angles) occur in the segment in question. The term “scanning” is generally understood to mean the movement of the unit responsible for solidifying the material at the respective points along the specified “scan path”, for example a material application head that dispenses material, which then solidifies, and/or an energy beam for solidification, etc. For example, in the beam melting processes mentioned at the outset, “scanning” refers to the movement of the impact point of the energy beam (i.e. the movement of the laser focus in selective laser melting and similar processes) on the current working plane along the specified “scan path”. The current “scanning direction” is the current direction along the currently travelled scan path. The scanning direction can be specified for example by a scanning direction angle in the current working plane with respect to an arbitrarily predefinable reference direction. The speed of movement of the impact surface of the energy beam or the unit responsible for solidifying the material at the respective points on the construction field is the scanning speed, which can also be modified depending on the location, i.e. it does not have to be constant. The “working plane” is generally the plane that is perpendicular to the construction direction of the component at the respective point. In the “laser powderbed fusion process” described above, this is the plane in which the powder layers are applied, i.e. the scan paths of a layer generally lie in a plane that does not tilt during the solidification of a layer. For other additive manufacturing processes such as laser cladding, direct energy deposition (DED) and wire-based arc-light additive manufacturing (WAAM), a working plane could also be defined by the so-called tangential plane without limiting the generality. Such a tangential plane has its origin in the point of impact of the beam energy on the material.

It should be mentioned at this juncture that a scan path does not have to be continuous, but can also comprise several spaced-apart scan path sections, in particular also in one plane. For example, the individual “hatching lines” explained below, along which an energy beam is moved over the material layer in the working plane in accordance with a “hatching direction arrangement” (generally also referred to as a “hatching strategy” for short) in order to solidify the cross-section of the component in the plane, can each be seen as individual “scan path sections”.

The selective irradiation or the movement of the impact surface of the energy beam on the construction field in a beam melting process is usually carried out according to a suitable irradiation strategy, as mentioned above. As a rule, larger two-dimensional regions, i.e. larger regions on the construction field, are to be irradiated during a solidification process. Irrespective of how the energy beam is generated and the exact point of impact on the construction field, it has proven to be advantageous to first virtually “divide” at least such larger regions to be irradiated according to a selected pattern, for example into virtual “strips”, a diamond pattern, a chequerboard pattern or similar. The individual regions of this pattern, i.e. defined sub-regions, for example geometrically standardized surface sections such as stripes or fields, are then usually scanned with the energy beam in the form of a so-called “hatching” (generally also called a “hatch”). In a stripe pattern, the construction material—viewed macroscopically—is gradually solidified along parallel stripes and in detail—viewed microscopically—the movement of the impact surface of the energy beam on the construction field takes place along closely spaced hatching lines, which run back and forth across the direction of extent of the respective irradiation stripes within the boundaries of the irradiation stripe. A hatching direction arrangement or hatching strategy can define, for example, whether alternating hatching directions (alternating irradiation) or constant hatching directions (unidirectional irradiation, i.e. with a return from one hatching line end to the beginning of the subsequent adjacent hatching line in the irradiation strip) are used. A hatching direction can therefore also be regarded as a localized set of scanning directions. In the contour regions of the component, the scan paths generally run along the contour so that the surface is as smooth as possible.

The above-mentioned “scanning direction distribution” (or the “segment scanning direction distribution”) can—as will be explained in greater detail later—depend, among other things, on a “layer scanning direction arrangement” selected in the manufacturing process. The “layer scanning direction arrangement” generally defines the fundamental strategy of the course of the scan paths, i.e. the irradiation strategy in the case of beam melting, in a respective layer, i.e. in which way or direction the scan paths in a layer run relative to each other, and possibly also in which order the scan paths in the layer are run in order to melt and solidify the material in the desired spatial and temporal sequence. The “layer scanning direction arrangement” thus defines the relevant scanning directions that are or were specified within a layer in the manufacturing process for the main part of the surface of the layer. As already mentioned above for the hatching strategy, the layer scanning direction arrangement can therefore also have a significant influence as a process variable on the locally resulting microstructure in the component. It should be noted here that a rotation of the orientation of the layer scanning direction arrangement from layer to layer—as will be explained later—is not to be understood here as a change in the layer scanning direction arrangement. This means that layers can be regarded as having been created with the same layer scanning direction arrangement, even if the orientation has been changed (by rotation about the main build direction in which the layers are superimposed). Changes to individual scan path sections, in particular along the component contours in the respective layers, which are caused, for example, by this change in orientation or by the change in the component contour from layer to layer, etc., are not regarded as significant changes to the layer scanning direction arrangement in this sense. I.e. the layer scanning direction arrangements of the layers can be regarded as identical in the sense of the invention, since such changes would generally not lead to a significant change in the “intralayer scanning direction distribution” (which is substantially determined by the layer scanning direction arrangement) and thus also not to a significant change in the property values of the segment. A typical example of a “layered scanning direction arrangement” therefore comprises the previously explained hatching direction arrangement or hatching strategy or can be defined thereby.

In the optimization process, the scanning direction distribution is thus advantageously an optimization variable. Preferably, this is a steady, particularly preferably continuous, optimization variable in the optimization process. A scanning direction distribution can also preferably be defined as “quasi-continuous”, e.g. by a sufficient number of discrete values. For example, a “quasi-continuous” definition of a segment scanning direction distribution in a plane can be provided by a sufficient number of discrete, closely spaced values, such as 360 sampling points over an angular range of 360°.

Preferably, as will be explained in greater detail later, further optimized process variable values can also be determined in the optimization process, such as optimum parameter sets for the component, in particular optimum parameter sets for the various segments of a component. Such a “parameter set” includes, for example, the following in each case: a defined group of process parameter values, i.e. a tuple of individual process parameter values with which the machine is later controlled or is to be optimally controlled to build at least one layer of the relevant segment.

The optimized or optimum process variable values determined in the optimization process, for example the optimized scanning direction distribution(s), in particular segment scanning direction distributions, and optionally the optimum parameter sets, are lastly provided in order to generate optimized control data based on them, for example, which can be used to control a production device during the build process. The provision of the optimized process variable values can include, for example, storage for later use and/or transfer to another calculation unit and/or transfer to the production device.

The method according to the invention for generating or determining the optimized process variable values enables, depending on the specific embodiment, a very general optimization of the property profile of additively manufactured components and is advantageously not limited to optimization with regard to a single component characteristic, such as mechanical strength. Rather, it represents an option for solving boundary value problems of any thermophysical and manufacturing technology nature. In addition to taking into account a requirement profile (based on the requirement data), the most cost-effective way of achieving the specified requirements in terms of production technology can also be determined as part of the proposed process, depending on the design. This can be achieved, for example, by maximizing the volume construction rate, as will be explained in greater detail later.

Examples of suitable optimization processes, which also work, for example, with segment scanning direction distributions as optimization variables and a selection of optimum parameter sets, are already described in detail in patent application DE 10 2022 117 935, to which reference can be made here or the content of which is hereby incorporated in full. In this respect, the present invention can, among other things, build on the methods mentioned therein or further improve the methods mentioned therein. In addition to the optimization processes mentioned there, an AI-based optimization unit is now used according to the invention in order to find at least one optimized scanning direction distribution, for example the segment scanning direction distribution(s), for at least one region of the manufacturing product. This enables a considerable acceleration of the method as a whole, as will be described later with reference to an exemplary method sequence. In particular, the AI-based optimization unit can be used in this way to make a kind of preselection of optimum process variable values, in particular scanning direction distribution(s), within one stage of the complete optimization process, which simplifies and accelerates the further procedure.

The optimized process variable values obtained in this way can then be used to generate control data according to the invention for a production device for additive manufacturing of at least one manufacturing product.

A corresponding method according to the invention for generating control data for a production device for additive manufacturing of at least one manufacturing product from a plurality of layers of a construction material has at least the following method steps:
In a first stage, optimized process variable values are provided, which were generated for the additive manufacturing process according to the method according to the invention characterized above, e.g. by directly adopting these optimized process variable values or retrieving them from a memory.
In a second stage, the control data for the production device is then generated in such a way that the optimized process variable values are sufficiently achieved in the additive manufacturing process in accordance with a predefined evaluation criterion and can preferably also be maintained during the production process. Depending on the current technical possibilities, it is possible that the optimized process variable values cannot be precisely adhered to or can only be adhered to with extreme effort. The specified evaluation criterion should therefore preferably be defined in such a way that the optimized process variable values are achieved or approximated in the production process as well as possible (exactly would be optimal) or are at least within a specified tolerance range around the respective optimized process variable value and are maintained during the production process. The tolerance range can also depend on the respective optimized process variable value.

Preferably, this data is control data for a production device (i.e. the production device is then also designed suitably for this), with which, as described at the outset, construction material, preferably powder, is built up and selectively solidified in a, preferably powder-bed-based, beam melting process, wherein the construction material is irradiated with at least one energy beam for solidification on a construction field, wherein an impact surface of the energy beam is moved along predetermined scan tracks on the construction field in order to melt the construction material in a target region in and around the impact surface. A “movement” of the energy beam or the impact surface of the energy beam can be understood to mean the usual deflection of the energy beam, e.g. by galvanometer mirrors, but also a movement of the complete beam delivery unit, e.g. in the form of a diode bank, in particular a laser diode bank, or by a moved beam shaping. A “target region” is understood here to mean on the one hand the impact region, i.e. the region at which the energy beam strikes the surface, but also the region below it, i.e. into the depth of the material or the layer, and possibly also an environment around this impact region in which the energy beam still acts, e.g. through thermal conduction in the construction material. For the sake of completeness, it should be mentioned once again that the energy beam can be both particle radiation and electromagnetic radiation, such as light or preferably laser radiation.

Accordingly, the control data can preferably be exposure control data, such as scan data that defines or specifies the movement of the energy beam on the surface, control data for setting the level of energy or laser intensity, control data about the “shape” of the beam or the beam profile and/or the focus or the extent of the beam perpendicular to the beam direction. Furthermore, as will be explained later, this control data can also include other control information, such as coating control data that specifies how thick a current layer is, or information for controlling pre- or post-heating with other energy input means, for injecting inert gas, etc.

It should also be mentioned at this juncture that the control data can be used for “simple” open-loop control of the process on the one hand, but also for closed-loop control of the process, for example by the control data specifying target data for advanced closed-loop control of the process. In other words, the method according to the invention can also be used to derive the required variables for a controller, which receives actual data for feedback, for example, which is determined using melt pool monitoring or time-resolved temporal and/or spatially resolved imaging for monitoring the built-up layer, such as thermally by means of optical tomography. Such methods are known to a person skilled in the art. Disturbances occurring in the manufacturing process are corrected in order to remain as close as possible to the target process control specified by the control data.

In a method according to the invention for controlling a production device for additive manufacturing of a manufacturing product, control data is first generated in the above-mentioned manner according to the invention and then used to control the device with the control data. The control data can be generated in advance and transmitted as a complete package or a type of “control protocol” to the device, which then carries out the production process. In principle, however, it would also be possible to determine control data during the ongoing process for subsequent process steps, for example while a layer or segment is being solidified to determine the control data for the next layer or the next segment.

According to the invention, at least one AI-based optimization unit is used in the optimization process. Such an AI-based optimization unit should generally be created to match the optimization process.

Thus, at least one AI-based optimization unit preferably comprises at least one optimization unit based on reinforcement learning and/or a neural network (in particular a deep learning network). If it is a neural network, this must first be trained in a suitable manner, for example. Only the trained neural network then forms the AI-based optimization unit suitable for the method.

A method according to the invention for creating an AI-based optimization unit (i.e. for building and training a neural network, for example), which can be used in one of the optimization processes described above in order to determine optimized process variable values for a plurality of different types of requirement data (in particular requirements or requirement parameters such as mechanical stress requirements and heat treatment requirements), comprises at least the following method steps:
On the one hand, at least one first AI-based optimization unit is determined (e.g. a first neural network is trained), which determines optimized process variable values of a first type of process variable (e.g. an optimum parameter set) based on a first type of requirement data (e.g. mechanical stress requirements).
On the other hand, at least one second AI-based optimization unit is determined (e.g. a second neural network is trained), which determines optimized process variable values of a second type of process variable (e.g. scanning direction distributions) based on the first type of requirement data (e.g. the aforementioned mechanical stress requirements) or which determines optimized process variable values of the first type of process variable (e.g. an optimum parameter set) or of the second type of process variable (e.g. the scanning direction distributions) based on a second type of requirement data (e.g. heat treatment requirements).
An AI-based combination optimization unit (e.g. a combined neural network) is then created using a training method in which at least the first and second AI-based optimization units are coupled together to monitor the training of the AI-based combination optimization unit.

In this way, AI-based (combination) optimization units can be created with less computational effort and time (compared to training with the help of more purely ‘classical’ (i.e. non-AI-based) optimization processes, which are also possible in principle, as will be shown later using examples), which can quickly determine optimum values for different types or combinations of types of different process variables based on any different types of requirement data.

It should be pointed out once again that the above-mentioned requirement data or process variables are only to be seen as examples of the method according to the invention for creating an AI-based optimization unit, even if these are preferably used data or variables in the specific case in the context of the desired optimization.

A device according to the invention for generating or determining optimized process variable values for an additive manufacturing process of a manufacturing product has (for carrying out the method according to the invention described above) at least the following units:
A requirement interface unit, designed to provide requirement data of the manufacturing product, which includes for example geometric data of the manufacturing product. This can be, for example, an interface for transferring the data and/or a memory in which this data is stored.
An optimization unit designed to perform the optimization process described above in order to determine the optimized process variable while taking into consideration the requirement data, comprising at least one AI-based optimization unit for determining as an optimized process variable value at least one optimized scanning direction distribution for at least one region of the manufacturing product.
A process variable value interface unit designed to provide the optimized process variable values, including the scanning direction distribution(s), for example the optimum segment scanning direction distribution(s) and the optimum parameter sets. This can be, for example, an interface for transferring the data and/or a memory in which this data is stored. In principle, the requirement and process variable value interface unit can also be realized as a common unit, or at least use common components such as a common memory.

A control data generation device according to the invention for generating control data for a production device for additive manufacturing of a manufacturing product in an additive manufacturing process, preferably in a beam melting process as mentioned above, comprises at least the following units:
A device according to the invention described above for generating or determining optimized process variable values for the additive manufacturing process of a manufacturing product and/or an interface to such a device for transferring the optimized process variable values. Such an interface also comprises the possibility of accessing a memory, e.g. with a database, in which the optimized process variable values were previously stored by the device for generating the optimized process variable values.
A data generation unit for generating the control data for the production device in such a way that the optimized process variable values in the additive manufacturing process are sufficiently achieved in accordance with a predetermined evaluation criterion, as already explained above in conjunction with the method for generating control data.

The control data generation device can, for example, be part of a controller of such a production device for additive manufacturing of a manufacturing product. However, it can also be realized independently on another computer in order to then transfer the data to the controller.

Accordingly, a controller according to the invention for a production device for additive manufacturing of a manufacturing process has a control data generation device according to the invention and/or an interface to such a control data generation device for transferring the relevant control data from the control data generation device. Such an interface in turn comprises the possibility of accessing a memory, e.g. with a database, in which the control data was previously stored, e.g. by the control data generation device. The controller is designed to control the production device using this control data, e.g. to irradiate the construction material with the energy beam.

A production device according to the invention for additive manufacturing of manufacturing products in an additive manufacturing process or manufacturing process has at least one such controller in addition to the components that are usual depending on the type of manufacturing process, for example for a (preferred) beam melting process a feed device for introducing construction material—for example in the form of a layer of construction material—into a process chamber and an irradiation device for selectively solidifying the construction material by irradiation by means of an energy beam.

It should be noted at this juncture that the device can also have several irradiation devices, which are then controlled in a coordinated manner with the control data in order to sufficiently achieve the optimized process variable values in accordance with the given evaluation criteria or to maintain them during the production process.

The device according to the invention for generating or determining optimized process variable values and the control data generation device according to the invention can each be implemented largely in the form of a computer unit, also in the form of a shared computer unit, with suitable software. The computer unit may, for example, have one or more co-operating microprocessors or the like for this purpose. In particular, it can be realized in the form of suitable software program parts in the computer unit of a controller of a production apparatus according to the invention. A largely software-based realization has the advantage that previously used computer units, in particular control units of production devices for additive manufacturing, can also be easily retrofitted by means of a software or firmware update in order to work in the manner according to the invention.

In this respect, the object is also achieved by a corresponding computer program product with a computer program which can be loaded directly into a memory device of a computer unit, in particular a device for generating or determining optimized process variable values, a control data generation device or a controller, with program sections in order to execute all steps of the method according to the invention when the program is executed in the computer unit or controller. In principle, the required software components or program sections can also be distributed over several interconnected computer units, which in this sense can also be regarded as a common, only evenly distributed computer unit.

In addition to the computer program, such a computer program product can include additional components such as documentation and/or additional components, including hardware components such as hardware keys (dongles, etc.) for using the software. A computer-readable medium, for example a memory stick, a hard disk or another transportable or permanently installed data carrier, on which the program sections of the computer program that can be read and executed by a computer unit, in particular the controller, are stored, can be used for transport to the computer unit or controller and/or for storage on or in the computer unit or controller.

In particular, the method according to the invention for creating an AI-based optimization unit can also be implemented with the aid of a computer program product, which can be installed on any computer. The AI-based optimization unit (for example a neural network) can itself form a computer program product, which can then be transferred to one of the above-mentioned units, for example, in order to use it within the optimization process according to the invention.

Further, particularly advantageous embodiments and developments of the invention can be found in the dependent claims and the following description, wherein the independent claims of one claim category can also be developed analogously to the dependent claims and exemplary embodiments of another claim category and, in particular, individual features of different exemplary embodiments or variants can also be combined to form new exemplary embodiments or variants.

As explained above, at least one optimum parameter set can also be determined in the optimization process (taking into consideration the requirement data) as at least one further optimized process variable value. Such an optimum parameter set can preferably be selected from a number of “candidate parameter sets”, wherein this selection is preferably also made using an AI-based optimization unit. This can be a separate AI-based optimization unit, which only serves the purpose of finding optimum parameter sets (for example a neural network that has been trained to do precisely this). However, it can also be an AI-based combination optimization unit that has been set up (for example using the method described above) in such a way that it can be used to find several optimized or optimum process variable values at the same time, e.g. to find an optimized pair of scanning direction distribution and parameter set.

A parameter set (which can also be referred to synonymously as a “process parameter set”), and therefore also a candidate parameter set, comprises, as already mentioned, a defined tuple of individual process parameter values with which the machine is later controlled or is to be optimally controlled to build at least one layer of the relevant segment. In particular, the process parameter values can be predetermined, preferably discrete (i.e. not continuous) optimization variables.

Preferably, the parameter set comprises one or more of the following process parameters:
Power of the energy beam (e.g. the laser power in a laser melting process).
Scanning speed of the energy beam.
Hatching distance.
Energy beam diameter (e.g. focus expansion and shape).
Intensity distribution or intensity profile of the energy beam.
For laser as energy beam: continuous or pulsed operating mode.
Power curves of the energy beam.
Thickness of the layers.

Several candidate parameter sets can be available for different types of construction material, for example different types of powder, preferably types of metal powder. Different types of powder can be distinguished here in particular according to
a) material, wherein there is also a difference between pure material or alloys,
b) other powder parameters, such as particle size distribution, sphericity of the particles, chemical properties, etc.

Since different powder batches of the same material can already have different combinations of the aforementioned parameters, each powder batch could also be regarded as a separate powder type, if this is desired and appropriate.

However, a parameter set or a candidate parameter set can also include the type of the associated construction material itself as a further “process parameter value”, i.e. with the selection of a candidate parameter set, the material type is then determined by this process parameter value (discrete value). This is ultimately a question of the organizational or structural design of a database for the candidate parameter sets.

In practice, only a few candidate parameter sets, e.g. 4 to 20 candidate parameter sets, may initially be available for a particular material. In principle, however, the number of candidate parameter sets is only limited by the technical possibilities for the size of the database, i.e. how much storage space and how much computing time is available (in advance) to create the database. When determining the number of candidate parameter sets, the required computing time can also be taken into account, as limiting the number can reduce the computing time in an optimization process. The use of candidate parameter sets is particularly advantageous in order to save computing power.

As already mentioned, the manufacturing product is preferably (e.g. at the start of the optimization process or beforehand) virtually divided into several segments using requirement data, in particular geometric data, and the optimization process is then carried out in such a way that optimized process variable values, preferably an optimized segment scanning direction distribution and an optimum parameter set per segment, are determined for each of the individual segments. The optimized segment scanning direction distributions determined can then together result in an optimum scanning direction distribution in the entire component.

Preferably, a so-called “area” (which could also be referred to as a “calculation area” or “design space”) is firstly defined, encompassing the manufacturing product, i.e. the manufacturing product is completely included in the area.

This entire area is then divided (virtually) into so-called “segments”, wherein the manufacturing product comprises at least one such “segment”. Generally speaking, a segment is then a region in the area, usually in the component.

The area, however, can also include so-called “powder segments”, i.e. segments that are not solidified or are to be solidified. These can be regions in the “area” but outside the contours of the component (but within the build space or in the manufacturing volume of the AM machine or in the design space), or cavities or hollows in the manufacturing product. As will be explained later, the final contour of the component can be defined only by the boundaries between the segments to be solidified and the powder segments.

If, for example, the area were a cuboid enclosing the manufacturing product with a distance between the manufacturing product and all the side surfaces of the cuboid, two segments in the area would be sufficient in the simplest case, namely a solidified segment or a segment to be solidified (which encompasses the entire manufacturing product) and a powder segment (which encompasses the entire region outside the manufacturing product). In principle, however, the boundaries of the area could also correspond completely with the boundaries or contours of the manufacturing product, in which case there need not be any powder segments at all, for example, unless there are cavities in the manufacturing product within the area.

The segmentation of the component or of the entire area can take place automatically or according to a user's specifications with the help of a user interface, wherein semi-automatic processes are also possible, i.e. partly automatically and partly according to user specifications. Segmentation is preferably carried out using the requirement data, in particular the geometric data. For example, the component can also be divided according to certain functionally essential construction sections (i.e. which function the construction sections primarily have), e.g. into strut, pressure plate, flange part, etc.

In a particularly preferred embodiment of the method according to the invention, a defined “target function” is used to carry out an optimization process. Suitable and preferred target functions are also described in detail in DE 10 2022 117 935, for example, which is why explicit reference is once again made to this document. For example, using the target function and the requirement data for at least one segment of the manufacturing product in the defined area, at least one optimum “parameter set” can be selected from a number of “candidate parameter sets” and an optimized or optimum segment scanning direction distribution (which ultimately matches the optimum parameter set) can be determined.

In the optimization process, a target function assigned to the relevant segment can preferably be selected in such a way that—possibly in compliance with certain boundary conditions (e.g. maximum permissible Mises (equivalent) stress or minimum safety factor for a given external load)—predefined target macro properties (e.g. quality requirement data, in particular load data on loads that the component must withstand, such as high stiffness with the highest possible construction rate while complying with a certain defined safety factor of 1.65, for example) are achieved as well as possible in the segment if the optimum process variable values obtained by minimizing the target function (or at least a sub-function matching the target macro properties) are subsequently maintained as well as possible or approximated as well as possible in the additive manufacturing process. In addition to the geometric data, the quality requirement data can also be part of the aforementioned requirement data.

The requirement data can also preferably be taken into account (directly or indirectly) at least in part in the defined target function.

However, requirement data, in particular geometric data, can also be taken into account in the area definition. For example, certain conditions can be defined via the outer shape of the area, e.g. by ensuring that the manufacturing product fits into the area and, for example, extends to certain outer surfaces of the area. A boundary condition in the target function could then be that material must be solidified in certain regions of the area.

In the optimization process, it is particularly preferable to select exactly one optimum parameter set from the candidate parameter sets for a segment, i.e. for all layers in the segment, as this is considerably less computationally intensive than if several optimum parameter sets are searched for, which are assigned to different layers of the segment. Likewise, there can also preferably be only one optimized segment scanning direction distribution per segment. In other words, a segment can also preferably be defined in such a way that exactly one optimum parameter set and one optimized segment scanning direction distribution applies within the boundaries of the segment. The optimum parameter set and/or the optimized segment scanning direction distribution then changes at the boundaries of the segment to another segment.

Particularly preferably, optimized process variable values for several segments of the defined area can also be determined in parallel (i.e. coupled) within the optimization process using a common target function.

It is very particularly preferable for all segments of the component or even all segments of the area to be optimized in a coupled optimization process. The solution of the optimization process, i.e. the optimum parameter sets obtained with the optimum segment scanning direction distributions for the segments, can then also be a Pareto optimum for the entire manufacturing product, if there is a conflict of objectives between the requirements for the respective segments or for the entire component. In this respect, an optimized scanning direction distribution (or component scanning direction distribution) is also sought and found for the entire component.

A parallel, i.e. simultaneous, determination of optimized process variables for several segments by means of a “common target function” can also be understood as the use of a number of mathematically coupled segment target functions, wherein the individual segment target functions are each assigned to one of the segments. This coupling can ultimately be used to determine an optimum parameter set and an associated optimized segment scanning direction distribution with a common target function (which is defined by the segment target functions) for the entire defined area, i.e. all segments defined therein. In other words, the joint target function is then effectively the sum of the segment target functions across all segments involved in the joint optimization.

It is very particularly preferable for the target function to include a minimization of a parameter set change within the entire manufacturing product as further requirement data. The consideration of this further objective is synonymous with a reduction of the segment boundaries, insofar as this is possible, i.e. the manufacturing product is divided into as few (virtual) segments as possible. In other words, this can also be achieved by formulating the target function in such a way that the segment boundaries are minimized.

In particular, the segment boundaries can preferably be taken into account as a further optimization variable within the optimization process and can then be provided as further optimized process variable values at the end of the optimization process, i.e. after optimization has been completed. In other words, the boundaries of the segments can also be shifted as part of the optimization process. In extreme cases, it is possible to change the segment boundaries up to the complete disappearance of a segment. New segments could also be created by shifting the segment boundaries. In this respect, the number of segments in the area is not necessarily fixed in this preferred variant, but can also be optimized in the optimization process. In particular, the number of areas can also be minimized in this way in order to achieve the goal of having to change the optimum parameter set as seldom as possible in a component.

In particular, the shifting of the segment boundaries also affects the outer boundaries of the manufacturing product, insofar as these are defined as segment boundaries between a component segment and a powder segment in the area. In this way, the topology of the component can also be advantageously changed in the optimization process, i.e. certain regions can be shaped differently than originally specified in a starting specification if, for example, the requirements for the component are better achieved with the changed topology or are at least sufficiently well achieved with less effort. In this respect, geometric data of the manufacturing product initially specified as requirement data can also be changed or optimized, especially if it defines the shape of the manufacturing product more precisely.

As a result of this preferred development of the optimization process, the following optimized process variable values are then preferably obtained for a segment:
1. an optimum parameter set (as the first optimized process parameter value), which in turn comprises tuples of individual process parameter values.
2. an optimized segment scanning direction distribution (as a second optimized process variable value).
3. optimized segment boundaries (as the third optimized process variable value).

In order to realize a shift of the segment boundaries in the optimization process, a phase field method, in particular a multi-phase field method, can preferably be used, as described in DE 10 2022 117 935 and DE 10 2022 117 936. This method will be explained in detail later. A multi-phase field method is particularly suitable for dealing with different segment boundaries. Reference is therefore also made to these publications in particular with regard to the phase field method. A multi-phase field method is particularly suitable for dealing with variable segment boundaries.

Particularly preferably, the parameter sets assigned to the segments can be assigned proportionally at least at the locations that lie in an “interface region” between a number of adjacent segments (at least two different, but possibly also more than two, adjacent segments).

Preferably, the parameter sets present at a location can also be generally represented by their “proportions” in the optimization process. The value of the proportion can preferably be between 0 and 1 in this case, wherein a value of 1 for a parameter set means that this parameter set is present at the location and a value of 0 means that it is not present. Locations in an interface region between two segments can thus be characterized in the optimization simply by a proportion of a first parameter set that applies in a first segment and a proportion of a second parameter set that applies in a second segment. In an interface region in which more than two segments meet, there may also be proportions of more than two parameter sets at one location. Preferably, the sum of the proportions of all parameter sets present at each location is equal to 1.

Preferably, the width of the “interface region” (which is then generally assumed in the process) can be defined or specified by a user in the optimization process.

In the optimization process, one of the process parameter values of the (optimum) parameter set for an individual layer of the segment comprises at least one layer scanning direction arrangement, i.e. the scanning directions that are or were specified in each case within the relevant layer in the manufacturing process. In particular, this layer scanning direction arrangement can include the hatching direction arrangement (hatching strategy) in the layer. There is therefore, as mentioned, an “intralayer scanning direction distribution” in each layer, which is determined by the layer scanning direction arrangement.

A layer scanning direction arrangement that can apply to all layers of the segment is particularly preferably selected in the optimization process, apart from a possible rotation of the overall orientation of the layer scanning direction arrangement between different layers. The segment scanning direction distribution then results as a combination of the rotations of the layer scanning direction arrangement between the layers in the segment. To optimize the segment scanning direction distribution, the relative orientations of the layer scanning direction arrangements of different layers of the segment to one another can then preferably simply be optimized, wherein the rotations of the layer scanning direction arrangement between the layers in the segment can be defined by suitable control commands with which the production device can be controlled during the construction of the component. An AI-based optimization unit is particularly suitable for this (partial) optimization problem.

Preferably, at least one process parameter value of the parameter set also comprises a track width between two solidification paths, i.e., for example, which hatching (line) distance is selected. This track width can be defined in the parameter set independently of the layer scanning direction arrangement.

Preferably, within the optimization process, e.g. in the target function, an orientation of the manufacturing product in relation to a main build direction (i.e. a relative orientation in the construction space) is taken into account as a further optimization variable. In the case of a layer-by-layer construction, the main build direction is generally considered to be the direction perpendicular to the layers in which the layers are gradually built up on top of each other. In a beam melting process, in particular laser melting processes, a Cartesian coordinate system x, y, z is generally defined as the reference system, wherein the x-direction and the y-direction run parallel to the layer planes or span the plane of the construction field and the z-direction points vertically upwards from the construction field, i.e. corresponds to the main build direction.

At the end of the optimization process, i.e. after optimization has been completed, the optimized orientation found can be made available as a further optimized process variable value. This can be advantageous because the orientation in the build space influences the position of the segment boundaries in the space. By taking the orientation into account, it is possible that the optimization can also aim to reduce or even minimize overhangs and/or support structures, for example.

Various requirement data can be taken into account in the optimization process, for example in the target function or in some other way. The requirement data can preferably comprise one or more items of “target production data” and/or “target property data” and/or “constraints”.

Particularly preferably, one or more of the following target production data can be taken into account:
construction rate in the additive manufacturing process,
material type of the construction material (this can specify not only the material, but also the consistency, e.g. whether it is a powder and if so, with what parameters),
construction technology (i.e. the type of construction method, such as laser melting, electron beam melting, etc.),
machine type (i.e. the type of production device used).

Equally preferably, one or more of the following items of target property data can be taken into account:
Target load data (This can include, for example, information about external loads that the component must withstand. However, it can also include the stress states determined from these external loads, for example as part of a simulation, i.e. the “internal load”, in the respective region of the component and/or in the component as a whole.).
Stiffness (i.e. resistance to elastic deformation of the finished product in the region of the respective segment.).
Strength (i.e. resistance to plastic deformation of the finished product in the region of the respective segment.).
Mass and/or mass distribution of the manufacturing product (in many cases, the aim here is to achieve the lowest possible mass, i.e. a mass reduction, so that the manufacturing product is as light as possible and/or to save material costs. However, depending on the component, the greatest possible mass could also be deliberately required, at least locally, e.g. for flywheel masses or the like.).
Surface accessibility (for example, certain requirement data relating to surface accessibility can be used to ensure or facilitate reworking of the component. For example, good removability of support structures usually requires good accessibility. Accessibility can also preferably be checked in the optimization process using a suitable method, e.g. a ray tracing method or as described in M. Inui, S. Nagano and N. Umezu, Fast computation of accessibility cones for assisting 3+2 axis milling; COMPUTER-AIDED DESIGN & APPLICATIONS, 2018, VOL. 15, NO. 5, 667-676, in a separate method step or process step.).
Support properties (the properties that any support structures should have can be taken into account here, e.g. whether they should be used for support and/or heat dissipation. It should be noted here that a support structure for heat dissipation does not necessarily have to be solidly connected to the component; there could also be a powder layer between the support structure and the component, which corresponds to at least one (real) layer thickness. (In addition, overhangs of a component can be designed in such a way that it is possible to manage without “assisting supports”).

Preferably, one or more of the following constraints can also be taken into account:
chemical properties (e.g. that the material for the component should be non-corrosive),
geometric data (e.g. specific dimensions to be adhered to exactly or maximum dimensions/minimum dimensions of the component, as already explained at the outset).

In addition, a variety of other requirement data can be taken into account, depending on the type of manufacturing product (component). Incidentally, some requirement data can also be seen or declared both as “target production data” and as “target property data” or as “constraints”. Similarly, some of the data, in particular the target property data relating to the load-bearing capacity of the component or the chemical properties or chemical resistance, can also be regarded as quality requirement data, as already mentioned above.

Particularly preferably, the requirement data can be taken into account in the optimization process with a predefinable weighting, i.e. it is possible to set which requirement data is more important and which is less important relative thereto, for example.

Preferably, as in DE 10 2022 117 935, the target function can comprise a number of sub-functions, each of which is assigned specific requirement data, i.e. each of the sub-functions then stands for a specific requirement. Consideration of the requirement data in the optimization process with a predefinable weighting can then be implemented in a particularly preferred way here too simply by the target function comprising a sum of weighted sub-functions, wherein the sub-functions are assigned to specific requirement data.

Preferably, within the scope of the invention an optimization process is used which comprises a plurality of iteration steps. In particular individual sub-functions can be optimized in separate iteration loops from other sub-functions or optimization parameters in an iterative optimization process. Depending on the specific configuration, the computational effort can be reduced in this way.

It is particularly preferred that at least one AI-based optimization unit is used in at least one iteration step of the iterative optimization process.

The entire optimization process can therefore preferably also mix AI-based and “classic” (non-AI-based) optimization processes as a type of “hybrid process”, wherein individual classic optimization steps, which in turn can also contain iteration loops, can be replaced by an AI-based optimization unit.

Preferably, at least one start process variable value (for example a start parameter set and/or a start scanning direction distribution, in particular a start segment scanning direction distribution) is first specified in the optimization process. Preferably, a “start configuration” is determined, which comprises a combination of a plurality of start process variable values. For example, at least start segments can be defined or specified to determine a start configuration and a start parameter set can be selected from the number of candidate parameter sets for each start segment and a start segment scanning direction distribution can be determined. The start configuration can, for example, be selected in a first step of the optimization process immediately after the area has been defined.

In a preferred variant, the candidate parameter set that leads to the highest construction rate in the segment can be selected as the start parameter set for a segment. However, the start parameter sets can also be selected differently, e.g. simply stochastically.

Particularly preferably, at least one start process variable value can first be determined in the optimization process using an AI-based optimization unit. This means that the AI-based optimization unit(s) selects suitable start values or ‘pre-optimized values’, for example, so that the subsequent, e.g. predominantly classical, optimization process “converges” more quickly, i.e. reaches the target more quickly. In particular, at least one AI-based optimization unit can be used to determine a start configuration (wherein, as mentioned, at least start segments are defined and for each start segment a start parameter set is selected from the number of candidate parameter sets and a start segment scanning direction distribution is determined).

It should be noted at this juncture that, for the above-mentioned “powder segments” (i.e. segments in the region that are not to be solidified), for example, the energy beam or laser power can simply be set to 0 in the start parameter set, i.e. no energy is introduced in these segments. This value is then permanently retained for this powder segment, i.e. it is not changed during the optimization process or iteration. On the other hand, the boundaries of the powder segment can certainly shift to adjacent segments if the component topology is also to be optimized in the optimization process.

In principle, various criteria and/or procedures can be used for the determination of an optimized scanning direction distribution and/or selection of an optimized or optimum parameter set from the available candidate parameter sets.

In a preferred approach, at least one parameter set suitability value is determined for at least a region of the manufacturing product (for example for a segment; i.e. segment-wise) for at least a number of possible (candidate) scanning direction distributions (or candidate segment scanning direction distributions) and/or at least some of the candidate parameter sets.

A parameter set suitability value can be a scalar value, preferably between 0 and 1, which indicates a measure of the suitability that the candidate parameter set in question fulfils certain requirement data. It is also referred to below as the “parameter set score” (or “PS score” for short). To this end as well, reference is made quite particularly to DE 10 2022 117 935.

The value of the PS score of a candidate parameter set in comparison to the PS scores of the other possible candidate parameter sets can then be used, for example, to determine whether this particular candidate parameter set (with a specific scanning direction distribution) is the most suitable candidate parameter set to fulfil certain defined requirement data, or the PS score can be viewed as a measure of the probability of the candidate parameter set (with a specific scanning direction distribution) being the best. For example, a candidate parameter set with a PS score of almost 1 could also be almost one hundred percent suitable for fulfilling the requirement.

An optimized scanning direction distribution (or segment scanning direction distribution for a segment) is then determined and/or an optimum parameter set is selected from the candidate parameter sets using the parameter set suitability values.

It is particularly preferable to determine parameter set suitability values for different pairs of segment scanning direction distributions and candidate parameter sets. This means that for each segment for which an optimum parameter set and an optimized segment scanning direction distribution are sought, parameter set suitability values are calculated with regard to which the optimization is performed. For example, the pair of parameter set and segment scanning direction distribution for which the best parameter set suitability value can be determined can ultimately be selected for a segment.

Preferably, for at least some of the (segment) scanning direction distributions and/or candidate parameter sets (in particular each pair of parameter set and segment scanning direction distribution), several requirement-specific parameter set suitability values (i.e. requirement-specific PS scores) are determined for different requirement data.

This means that the requirement-specific PS score can be used as a comparative measure to clarify which of the available candidate parameter sets (possibly in combination with a specific scanning direction distribution or segment scanning direction distribution) is the best for the precisely defined specific request date, e.g. the required construction rate and/or strength. Examples for determining possible (requirement-specific) PS scores will be given later.

Particularly preferably, the requirement-specific parameter set suitability values for a scanning direction distribution and/or a candidate parameter set (especially each pair) can each be combined to form an overall parameter set suitability value (for the respective segment).

Since it is generally necessary in the optimization process to select an optimum parameter set and/or a (segment) scanning direction distribution even in the case of several different, sometimes even conflicting, requirements, it makes sense to work with such overall parameter set suitability values. The selection of an optimum parameter set from the candidate parameter sets can then be made using the overall parameter set suitability values of the candidate parameter sets.

Examples of suitable combinations of possible (requirement-specific) PS scores are also given later and are also described in DE 10 2022 117 935. The type of combination can also depend on the requirements.

Preferably, the combination process can comprise a multiplication of the requirement-specific parameter set suitability values. In particular, an overall parameter set suitability value can be obtained by simple multiplication of all requirement-specific parameter set suitability values of the candidate parameter set in question.

It is very particularly preferred that optimized process variable values for the manufacturing product can be determined within the optimization process in such a way that optimized process variable values (preferably an optimum parameter set and an optimized segment scanning direction distribution) are determined for the individual segments, which are optimized on the one hand with regard to an overall parameter set suitability value in the respective segment and on the other hand also overall with regard to a “total parameter set suitability value” in the manufacturing product. Such a total parameter set suitability value can be formed, for example, by totaling the total parameter set suitability values of the individual segments across all segments of the manufacturing product.

In this preferred approach, the optimization is therefore also carried out for all segments in parallel using a common target function, wherein the sum parameter set suitability value, which is to be maximized, for example, preferably serves as at least a significant part of the target function

The determination of the segment scanning direction distributions and/or the selection of an optimum parameter set from the candidate parameter sets for a segment (in particular the selection of the pairs of scanning direction distribution and candidate parameter set) can preferably be carried out within the scope of the invention using an AI-based optimization unit.

Preferably, at least one AI-based optimization unit is used, during the generation of which the AI-based optimization unit (in particular the neural networks) was trained using parameter set suitability values, in particular using overall parameter set suitability values.

If AI-based optimization units (e.g. neural networks) trained for optimum overall parameter set suitability values are used at segment level, in particular the selection of the pairs of scanning direction distribution and candidate parameter set with the “best” (e.g. largest) overall parameter set suitability value can be significantly accelerated.

This means that by training AI-based optimization units with the aid of parameter set suitability values (in particular requirement-specific parameter set suitability values) and/or total parameter set suitability values and/or total parameter set suitability values and the subsequent use of at least one AI-based optimization unit trained in this way, the optimization itself is ultimately also carried out (albeit quasi “indirectly”) using the relevant suitability values, only usually faster.

A determination of the process variable values optimized overall with regard to a sum parameter set suitability value in the manufacturing product is preferably carried out using a (iterative) combinatorial optimization process, particularly preferably a heuristic approximation method, further particularly preferably a simulated annealing method and/or a quantum annealing method.

Simulated annealing methods or quantum annealing methods can be used in particular to find an approximate solution to optimization problems which, due to their high complexity, rule out the complete testing of all possibilities and mathematical optimization processes.

Such methods can therefore be used particularly well in the context of the present invention, even if a large number of possibilities have to be tried out, since the different variants can be determined relatively quickly and “computationally cheaply” using the AI-based optimization units, such as neural networks. In combination with the AI-based optimization process, the simulated annealing method can therefore contribute particularly well to solving the combinatorial problem of swapping parameters.

As already mentioned, the optimization process can preferably comprise several iteration steps, i.e. at least one part of the method that can be iteratively run through several times. In one or more steps, for example, a (preliminary) determination of (possibly starting) scanning direction distributions and the selection of optimum (possibly starting) parameter sets, e.g. using the (total) PS scores, can be performed, and in one or more other steps, the optimized segment scanning direction distribution and the optimized segment limits can be determined, e.g. using the target function or partial functions, and possibly in other steps still further optimized process variable values (with or without the target function) can be determined, wherein changes to the scanning direction distributions and parameter sets are also possible, as will be explained later using examples. As mentioned, AI-based optimization units can also be useful in all of these steps, e.g. in order to complete partial steps within “classic” optimization steps, or AI-based optimization units are trained using the “classic” optimization steps (or by using the results of these optimization steps as training data) in such a way that they can later replace these optimization steps.

An iteration loop made up of several steps can then be run through several times until a predetermined cancellation criterion is met. This cancellation criterion can preferably be fulfilled if the process variable values found in the current iteration loop are optimal, i.e. if no significantly better values are found in a new run, and/or if all requirements according to predefined evaluation criteria are sufficiently fulfilled and/or if, for example, a certain number of runs has been reached. Other cancellation criteria are also conceivable.

The optimization process preferably comprises at least one state determination step in which a “state description” is determined for a manufacturing product that would be built from the desired construction material using the current process variable values. In an iterative process, the “current process variable values” are the process variable values that apply in the current run of the iteration loop. In the first run, the current process variable values are the process variable values of the above-mentioned start configuration.

To determine the state description in the state determination step, the state of the current system, i.e. of the component with the current segments and the parameters sets currently assigned to the segments, can preferably be simulated (i.e. how the relevant segment of the—still virtual—manufacturing product for which the optimum process variable values are currently being sought would behave, e.g. under a certain load, if it were to be produced with the current process variable values). The state determination step could therefore also be referred to as the “state simulation step”. Particularly preferred simulation methods include, for example, a finite element method or finite volume simulation. For example, a load simulation or a vibration simulation can be carried out with the (virtual) component and the result is then the possible load or the natural frequency of the system or component, assuming the current configuration of the process variable values. In particular, the above-mentioned expected stress states in the component can be determined, which can be used as input data in the AI-based optimization unit (in particular a neural network), for example, in order to obtain optimized scanning direction distributions or optimum parameter sets correspondingly for these load requirements.

Preferably, the state description is compared with predefined quality requirements for the manufacturing product. This can be used to check whether the manufacturing product fulfils the predefined quality requirements. The state simulation step can be performed as a (quality) requirement simulation for this purpose, i.e. using quality requirement data that specify how the component may or should behave under certain loads or the effects of certain forces. In particular, the state simulation step can be carried out using at least part of the requirement data, which can also include suitable quality requirement data. The requirement data can therefore be used when selecting the optimum parameter set and in the target function.

If the state description does not fulfil the predefined quality requirements, the current process variable values can preferably be (further) changed. Such a further change can take place in further separate optimization process steps or method steps, as described later, and can also be integrated in various steps in the further process.

Optionally, after a further change in the process variable values, a state determination step and a comparison of the state description with the predefined requirements can be carried out again. In other words, this check can also take place in an iteration loop. A cancellation criterion for this iteration loop can be, for example, a success (the state description fulfils the predefined requirements), but also the reaching of a maximum number of iterations. If necessary, it is then also possible to start all over again with a different start configuration (e.g. with a different material).

The optimization process can then include various other optimization process steps—e.g. also in individual iterative loops, as also described for example in DE 10 2022 117 935. All the steps mentioned there can in principle also be used to advantage here (wherein they can be supported or replaced by the use of AI-based optimization units if this is advantageous).

At the end of the sequence of steps of the iterative method, improved segments with improved current parameter sets and improved segment scanning direction distributions are then preferably available, i.e. an improved configuration or improved current process variable values are then available.

In a particularly preferred development of the method according to the invention, a property database of a property database system is used as part of the optimization process (e.g. in one of the aforementioned steps) to determine or select a modified (updated) segment scanning direction distribution for a segment. In such a property database system, properties of the manufacturing product to be constructed or, more precisely, of individual layers and/or of segments of the manufacturing product formed therefrom can be stored as a function of the respective process parameter set of the layer or segment in question and, if applicable, as a function of the segment scanning direction distribution.

There are various options for realizing such a property database system. In particular, the property database system can also comprise several property databases, e.g. with different properties and/or parameter assignments.

Preferably, the property database system comprises a so-called “basic property database”. In this database, “basic properties” of individual layers can be stored depending on the process parameter sets to be used or used to build up the layers (including the layer scanning direction arrangement or hatching direction arrangement or the type of construction material, which are also a process parameter of the respective process parameter set). In such a database, the individual parameter sets are therefore each assigned at least one basic property value, preferably a group of basic property values, which a layer of the segment or component would have if the respective layer were manufactured using the assigned parameter set.

Methods for setting up and for utilizing such a basic property database are described in detail in DE 10 2022 117 935 and, in particular, DE 10 2022 117 936, the content of which is also fully incorporated here in this respect. As explained there, in a suitable test method using previously manufactured test specimens, at least one basic property value and/or one microstructure can be determined for each of these test specimens, which can be stored or saved as an entry in the basic property database in conjunction with the parameter set that was used to manufacture the test specimen and which can preferably include, in particular, the type of construction material and a layer scanning direction arrangement or hatching direction arrangement/hatching strategy.

In particular, these basic properties of the layers can then be used to determine macro properties or “macro property values” of a segment or even an entire component formed from the layers.

Such a “macro property value” describes a property value on a macroscopic level or from a macroscopic perspective, i.e. which property the complete segment has, such as thermal conductivity, breaking strength, etc. Preferably, several macro property values of the segment or several segments of the component are determined as part of the process. A macro property value can comprise a tensorial value, such as an elasticity tensor, but also a categorical value, such as corrosion resistance or not, the nature of a lattice structure, e.g. face-centred cubic (fcc), body-centred cubic (bcc) or hexagonal close-packed (hcp). Various macro property values will be explained hereinafter.

If the properties of the individual segments of the component are known on a macroscopic level, i.e. the “macro property values”, this can also provide information on the component properties and the quality of the component as a whole, in particular whether it fulfils certain quality requirements. The macro property values of the segments can therefore also be used in the above-mentioned state determination step to determine a description of the state of the manufacturing product.

Preferably, the basic property database for a plurality of different parameter sets can each comprise a “texture” of a layer as a basic property value, which was produced using the respective parameter set (i.e. also using a specific construction material) in an additive manufacturing process. The term “texture” refers to the entirety of the orientations of the crystallites within a structure, i.e. it is a crystallographic texture that should not be confused with a surface texture, such as the roughness of a surface. The texture is particularly preferably described in the form of the so-called “orientation distribution function” (ODF). The texture or ODF can be determined, for example, in a measurement under a scanning electron microscope using an EBSD method (EBSD=Electron Backscatter Diffraction) or other methods.

Alternatively or particularly preferably additionally, the basic property database can also comprise further basic property values, which can also be determined, for example, on the basis of the texture, in particular the orientation distribution function, of the layer for the parameter set. The other basic properties can be calculated from the texture or ODF using the known properties of the single crystals of the construction material (e.g. by averaging or a homogenization method, as is also explained in detail in DE 10 2022 117 936). For example, such basic properties may be the yield point, tensile strength in any direction, etc., to name but a few. Conversely, the texture could also be derived from other basic property values or macro property values, such as the elasticity tensor.

Preferably, the basic property database can in each case comprise basic property values for a reference orientation of the respective layer scanning direction arrangement, in particular hatching direction arrangement. The reference orientation or reference alignment can be selected arbitrarily here.

A basic property value can then be determined or calculated from the corresponding basic property value stored for the reference orientation for a layer of which the layer scanning direction arrangement, and thus also its “intralayer scanning direction distribution”, is rotated by at least one rotation angle (in any direction around the main build direction, i.e. around the direction perpendicular to the layer planes) compared to the reference orientation, using the rotation angle. This is possible using simple angle conversions. Rotation of the layer scanning direction arrangement, in particular the hatching direction arrangement, from layer to layer is common in beam melting processes, for example. A 67° rotation angle from layer to layer would be typical here, for example.

There are various options for determining a macro property value of a segment.

In a preferred approach, as mentioned above, a macro property value of a segment with several superimposed layers is determined or combined from the basic property values of the individual layers. This is preferably done using a mathematical “homogenization process”. A corresponding method is, as stated, explained in detail in DE 10 2022 117 936, and therefore reference can be made to that document.

In order to save further computing time, for example in the case of recurring configurations within segments, at least one macro property value of at least one segment can preferably be determined, as mentioned, using a basic property database provided. Alternatively or additionally, the property database system specifically preferably comprises a so-called “macro property database”. At least one macro property value, preferably in each case a group of macro property values, of segments (consisting of several layers) can be stored in this database for various combinations of segment scanning direction distributions and parameter sets (also depending on the construction material), which would be or have been created with the segment scanning direction distribution and the assigned parameter set assigned in the database.

For the determination or selection of a modified segment scanning direction distribution for a segment, it is then preferable to consider whether a macro property value has already been entered in the macro property database for a specific combination (i.e. a “candidate combination”) of possible segment scanning direction distribution and (e.g. within the optimization process) current parameter set (including the construction material) that may be provided in the next step.

If this is the case, a decision can be made as to whether this already stored segment scanning direction distribution (and thus in particular also the hatching direction arrangement in the individual layers or “standard” hatching strategy) should be used for the segment to be produced, which may be much more favourable in terms of computing technology and time, but may be slower to set up, for example, or whether a strategy that has not yet been stored is used with an individual hatching direction arrangement, which may be faster and/or have other advantages, but requires a more complex calculation from individual basic property values.

If, on the other hand, no “standard” construction strategy, in particular a “standard” hatching strategy, can be used, a more complex calculation from basic property values must be carried out anyway.

On the one hand, determining macro property values for complete segments by querying a macro property database is much easier and faster than determining the macro property values for the segment from the basic properties of the individual layers. On the other hand, the creation and storage of a large number of macro property values cost considerable computing time and memory space.

The macro property database therefore preferably contains at least macro property values, preferably groups of macro property values, for the most frequently used construction strategies, in particular “standard exposure strategies” or so-called “standard hatching strategies”, which are regularly used in the beam melting process. Typical standard hatching strategies in the beam melting process are so-called 67° hatching or x-y hatching (=90° hatching). In these processes, the orientation of the hatching strategy is rotated by 67° or 90° from layer to layer, wherein the hatching strategy remains substantially unchanged.

If certain queries occur more than once, it makes sense to include them in the entries of the “standard” hatching strategies of the macro property database. A database system could therefore preferably be created in such a way that it registers which combinations of segment scanning direction distributions and parameter sets are used particularly frequently and then creates new entries in the macro property database accordingly, i.e. the database system “learns”, so to speak.

As mentioned, in addition to the texture or ODF, there are a number of other property values (especially basic or macro property values) that may be of interest. These can usually be calculated from the texture or ODF using the known properties of the single crystals of the construction material (e.g. by averaging).

Particularly preferably, at least one of the property values, especially the basic or macro property values, comprises at least one value of one of the following material parameters:
Elasticity tensor.
“Tensile strength tensor” (this specifies the mechanical stress at which a specific yield criterion exists at a location in the workpiece; a definition of the entries of the tensor variables for the respective yield criterion can be found, for example, in J. Betten, Kontinuumsmechanik, 1993, Springer-Verlag).
Yield point distribution (for example in the form of the Hill tensor, as can also be found in the book by J. Betten).
Solidification coefficient.
Thermal conductivity
Break resistance.

Preferably, such a property value for at least one material parameter can comprise several direction-dependent partial values, i.e. the property values can also be anisotropic. In general, a property value can therefore be defined as a tensor, e.g. as a vector (1st level tensor) or a matrix (2nd level tensor) in order to take three dimensions or directions into account, or also as a 4th level tensor in order to take properties in the crystal system into account.

An example of this would be the 4th level elasticity tensor, wherein the elasticity tensor entries of the various crystal space directions contain values for a general three-dimensional stress state, from which the Young's-Moduli can be calculated by conversion, for example in a layer in the x-direction and in the y-direction.

A similar anisotropic behaviour can also be present, for example, in the yield point distribution or the tensile strength tensor. Without limiting the generality, other common forms of visualization can also be used, such as Voigt notation.

Preferably, the optimization process comprises at least one “cavity check step”. This can be used to check whether any cavities present in the manufacturing product after the construction, which may be filled with unsolidified powder, are connected to a surface of the manufacturing product. This serves to check whether the powder can later be removed from the cavities of the component and, if so, how well. Therefore this cavity check step can also be referred to as the “depowdering test step”. For the exact procedure, reference can be made again to DE 10 2022 117 935.

If it turns out in the cavity check step that not all cavities can be depowdered as desired, the geometry of the component is changed again, if necessary. For example, the optimization process can then start again from the beginning, in particular with a different set of start parameters.

Furthermore, the optimization process can preferably include at least one heat conduction test step, in which it is checked whether a planned heat treatment would be possible with the manufacturing product with regard to specified quality criteria, i.e. heat treatment requirements on the component are checked. In particular, it can be checked whether the heat treatment can be carried out in a reasonable time with sufficient final quality. If this is not the case, the optimization process could also start again from the beginning, in particular with a different set of start parameters. In a particularly preferred variant of the invention, however, the heat treatment requirements can also already be taken into account when determining optimized scanning direction distributions or optimum parameter sets in an AI-based optimization unit (in particular a neural network), in that the input data for the AI-based optimization unit also includes a time-temperature profile corresponding to the load requirements, as will be explained later using an example.

As mentioned above, the control data for the production device for additive manufacturing of a or the manufacturing product can then be generated based on the optimized process variable values so that the optimized process variable values are sufficiently achieved in the layer-by-layer additive manufacturing process in accordance with a predefined evaluation criterion.

Preferably, an optimum orientation of the layer scanning direction arrangement, i.e. in particular the direction of the hatching direction arrangement or hatching strategy of the individual layers, can be selected for individual layers in a segment in such a way that the optimum segment scanning direction distribution is achieved or approximated as well as possible across all layers in the segment. In other words, the initially continuous optimization variable “scanning direction distribution” (in particular “segment scanning direction distribution”) is discretized in relation to the control parameters in order to take into account in the layer-by-layer structure that only one predefined layer scanning direction arrangement or hatching strategy is present in each layer, and preferably the same layer scanning direction arrangement in each layer, only rotated relative to each other.

As mentioned, the method described above allows a general optimization of the property profile of additively manufactured components. It takes into account the correlation between the selected manufacturing strategy, in particular the selected manufacturing variables (e.g. the process parameters in the parameter set), and the resulting component properties.

The main process variables that influence the microstructure, which in turn substantially determine the component properties at macro level or the quality of the component, for example the machine configuration, the exposure strategy and/or post-processing, can be taken into account with different weightings.

As mentioned, the method is not limited to optimization with regard to a single criterion, but also represents a possibility for solving boundary value problems of any thermophysical and manufacturing technology nature. Not only can compliance with the necessary requirement profile (in particular the quality requirements) be ensured, but the most cost-effective way of achieving the specified requirements in terms of production technology can also be found.

Furthermore, the method presented here differs from a conventional optimization process, such as those offered by topology optimization programs already in use, in that it has several options for fulfilling the requirement of a local property. For example, the need for locally increased material stiffness can be met by adding material, but also by adapting the scanning strategy to create a desired texture or by changing the material. From these possibilities, the optimization process presented here always finds a solution on the Pareto front defined by the boundary value problem.

Many of the statements made above relate to observations and phenomena that apply to metallic materials—such as the derivation of properties from the crystallographic texture. The method is therefore particularly suitable for metallic materials and is preferably used for this purpose. In principle, however, a correlation between selected production parameters and resulting component properties can also be established in the same or a similar way for ceramic or polymeric materials, e.g. semi-crystalline polymers, and the method can therefore also be extended to these material classes through appropriate adaptations.

The invention is explained in greater detail below with reference to the appended figures using exemplary embodiments. In the various figures, identical components are provided with identical reference numerals. In the figures:

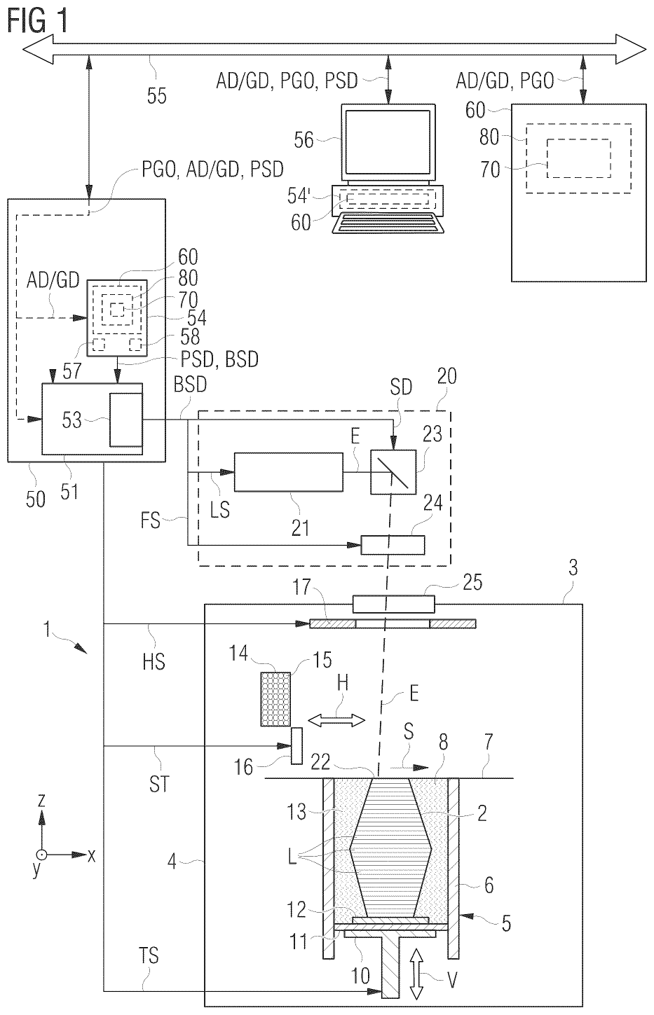

FIG. 1 shows a schematic view, partially shown in section, of an exemplary embodiment of an additive manufacturing device for realizing the invention with a control data generation device and a device for generating optimized process variable values as well as with a testing device and a device for determining property values,

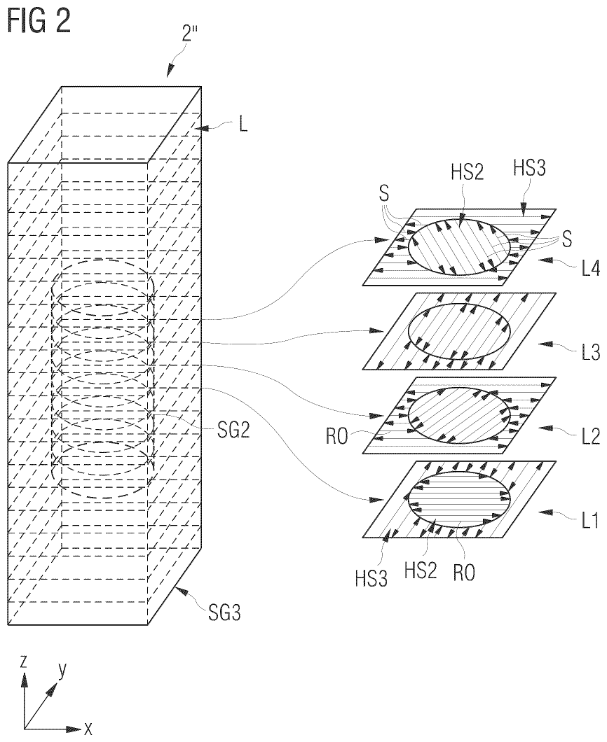

FIG. 2 shows a schematic representation of a rod-shaped sample component with two segments and a schematic representation of possible layer scanning direction arrangements and their orientations in different layers,

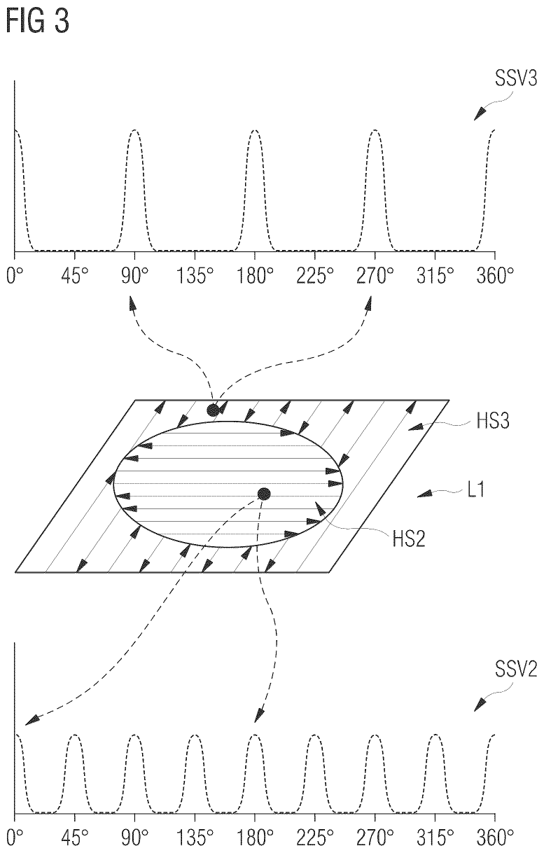

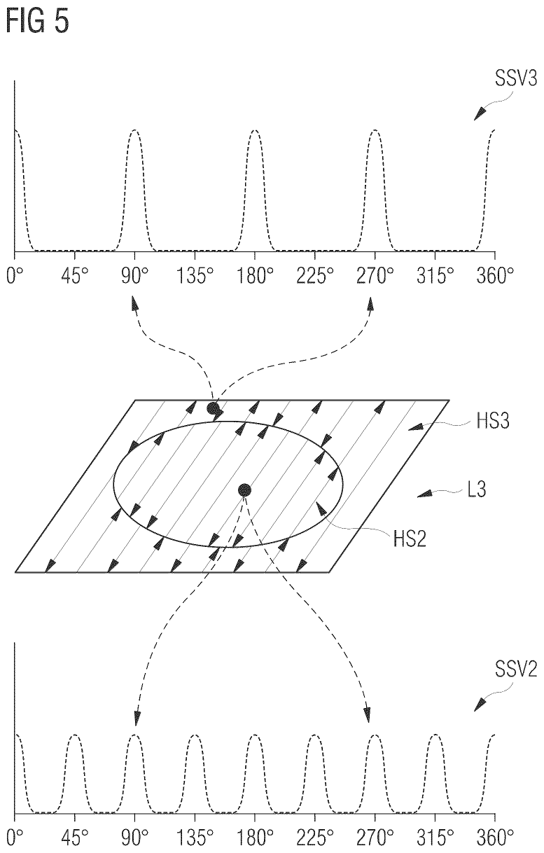

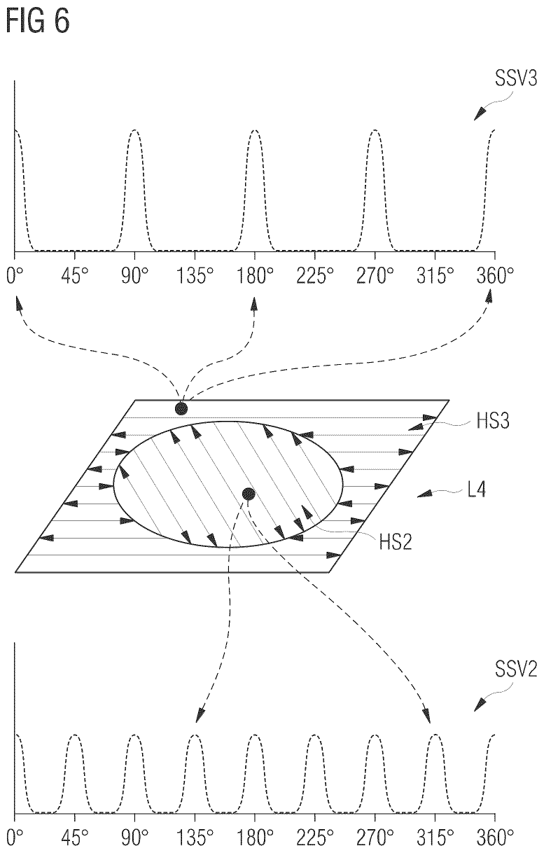

FIGS. 3 to 6 show schematic illustrations to explain how the layer scanning direction arrangements and their orientations of the different layers of the sample component from FIG. 2 can lead to different segment scanning direction distributions of the two segments,

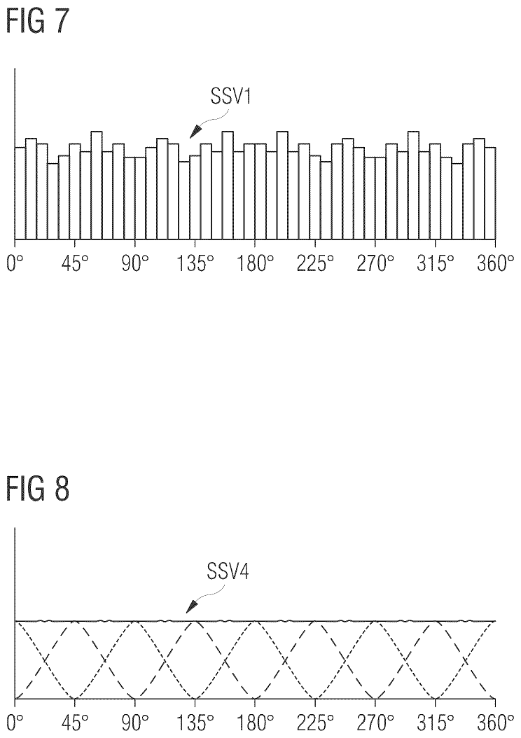

FIG. 7 shows a schematic representation of a further example of a segment scanning direction distribution, which describes a nearly uniform distribution,

FIG. 8 shows a schematic representation of a further example of a segment scanning direction distribution, which describes an approximated uniform distribution,

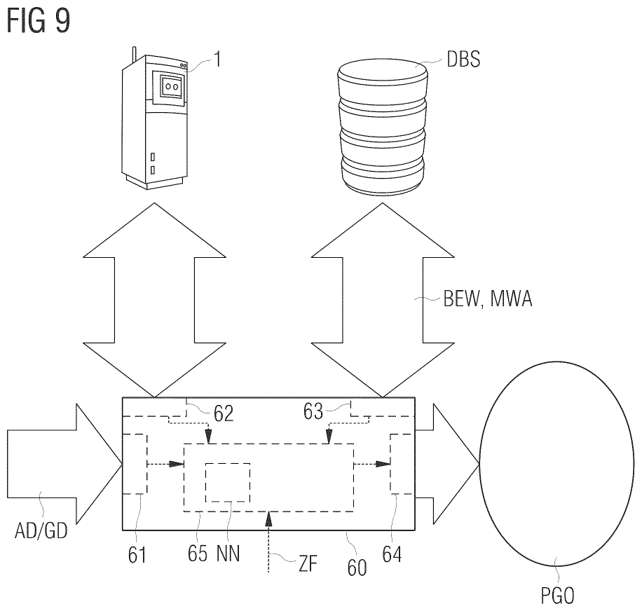

FIG. 9 shows a schematic diagram of an exemplary embodiment of a device for generating optimized process variable values,

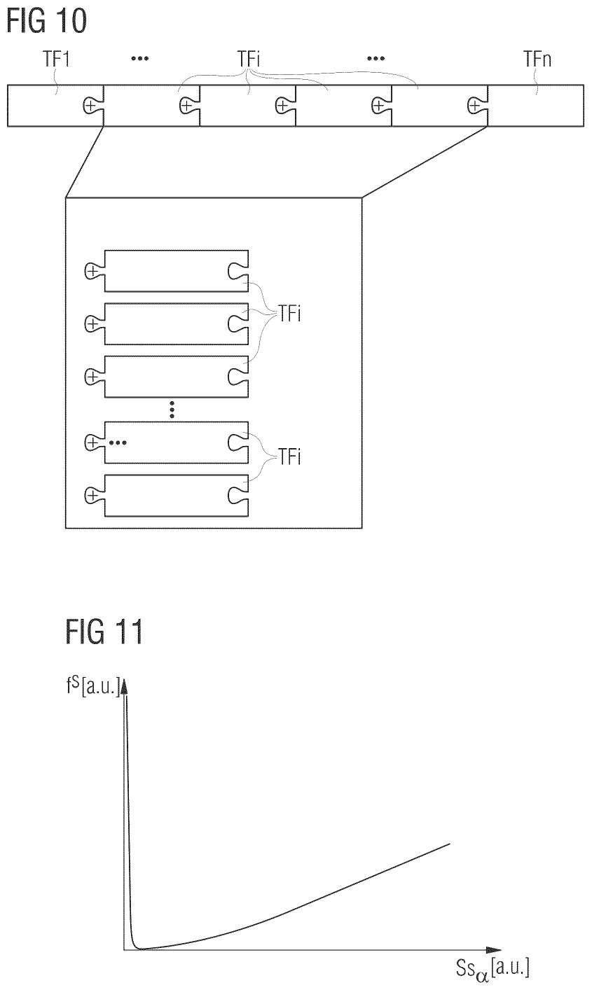

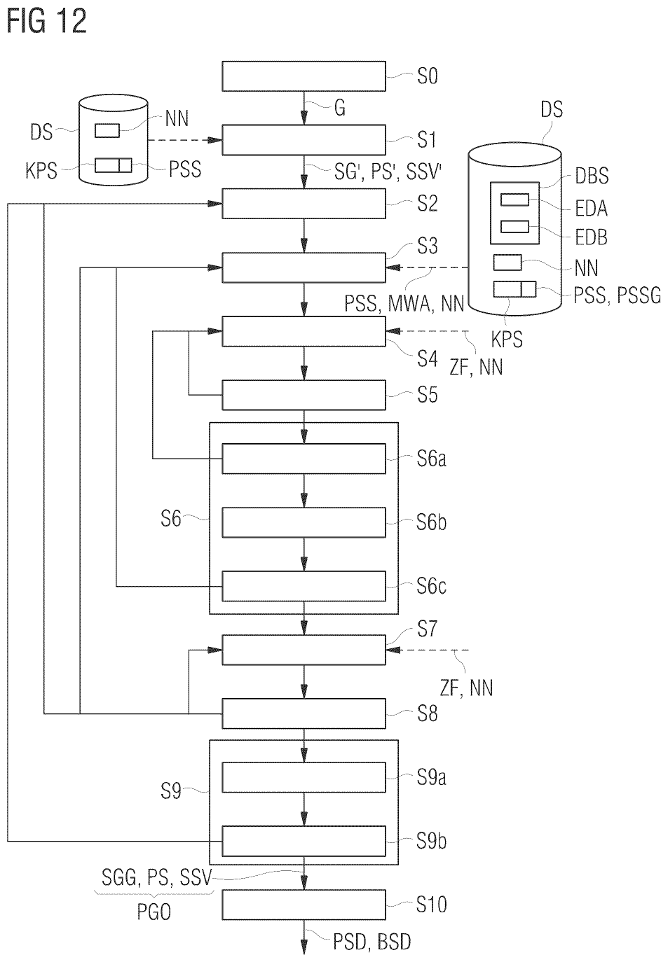

FIG. 10 shows a block diagram for setting up a possible target function for an optimization process, e.g. according to FIG. 12,

FIG. 11 shows a diagram for the progression of a sub-function fs in order to take a safety factor into account in a possible target function for an optimization process, e.g. according to FIG. 12.

FIG. 12 shows a flow diagram of a possible process sequence of an optimization process of an exemplary embodiment of a method for generating optimized process variable values,

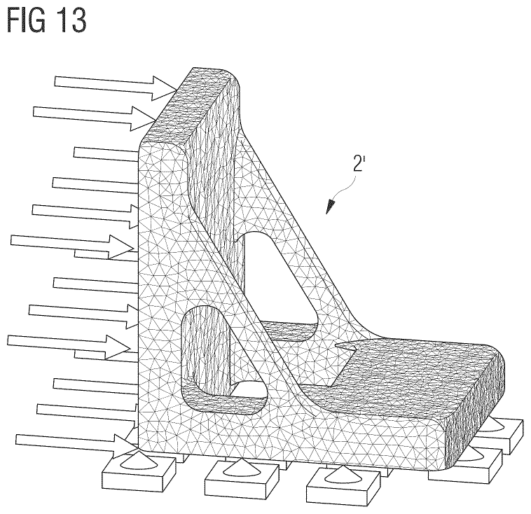

FIG. 13 shows a perspective view of an example of a component to be manufactured with a schematic representation of possible forces acting on the component,

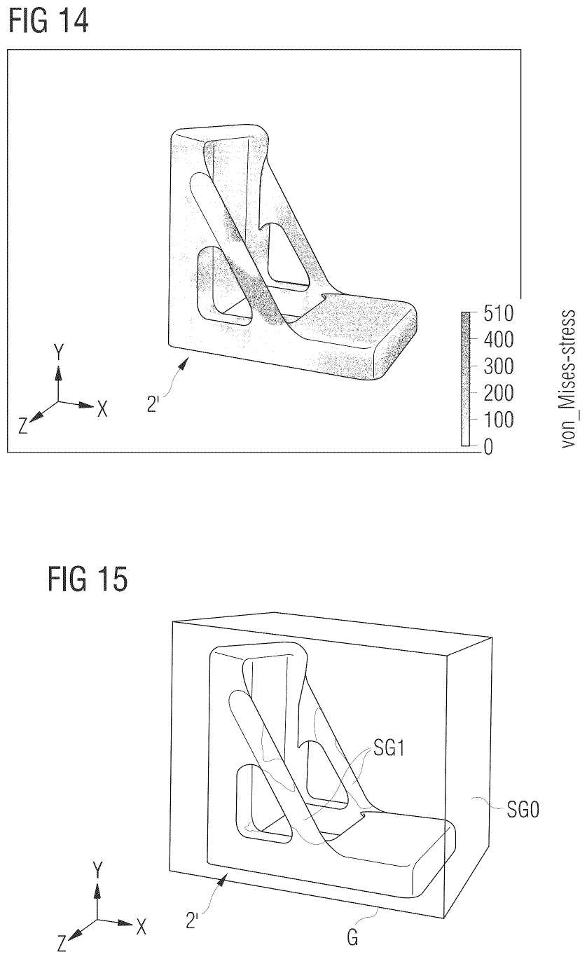

FIG. 14 shows the component according to FIG. 13 with a grey-scale representation of the loads acting on the component in the individual sections due to the external forces,

FIG. 15 shows the component according to FIGS. 15 and 14 with a representation of a possible (virtual) segmentation of the component and a possible definition of an area enclosing the component for the optimization process according to FIG. 12,

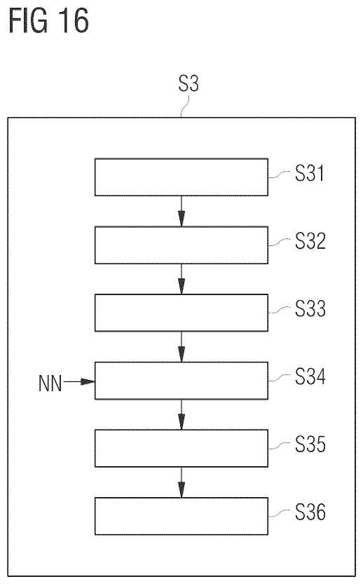

FIG. 16 shows a flow diagram of a possible method sequence within method step 3 of the optimization process according to FIG. 12,

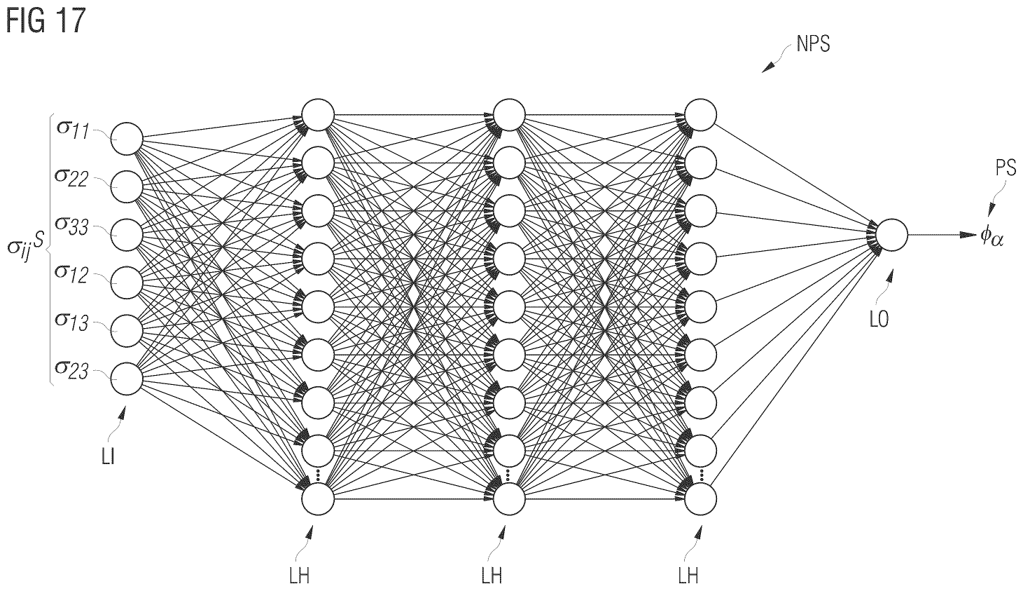

FIG. 17 shows a schematic representation of a first exemplary embodiment for a neural network,

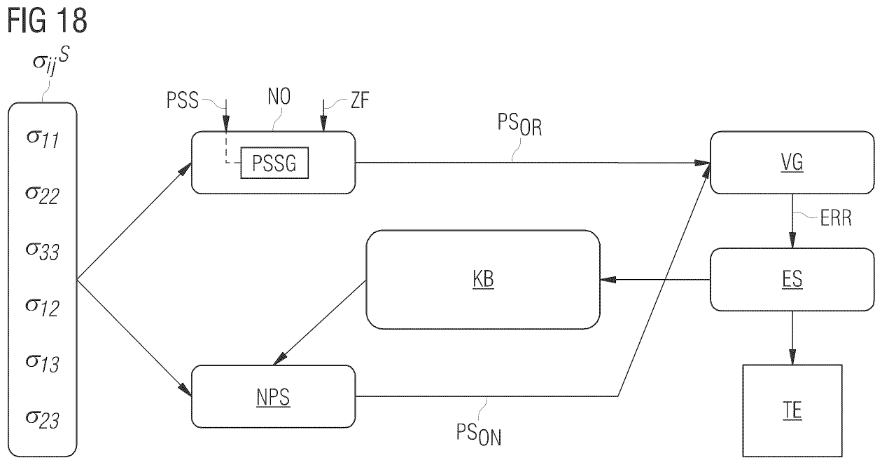

FIG. 18 shows a simplified flow diagram of a possible method for training a neural network as in FIG. 17,

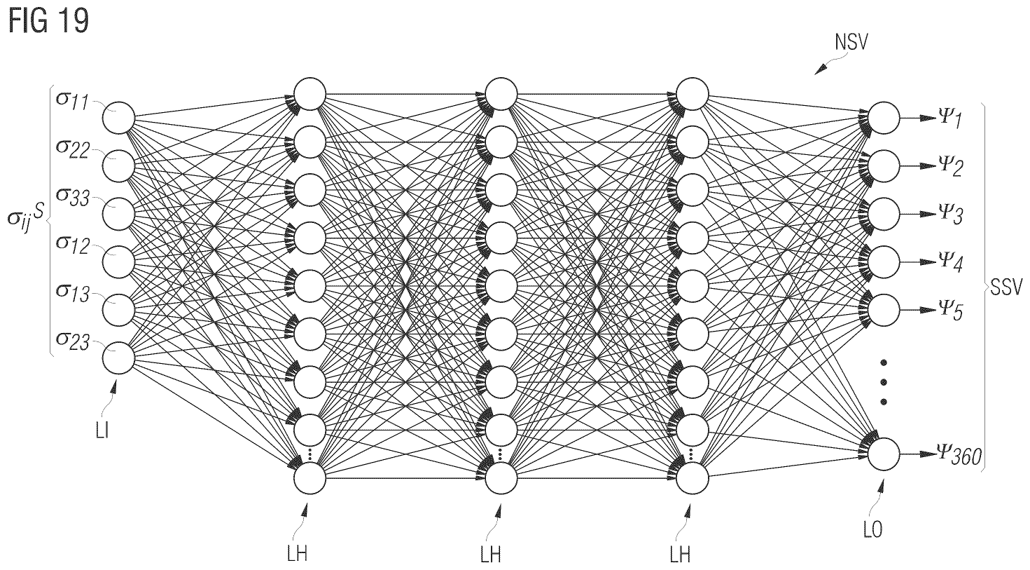

FIG. 19 shows a schematic representation of a second exemplary embodiment for a neural network,

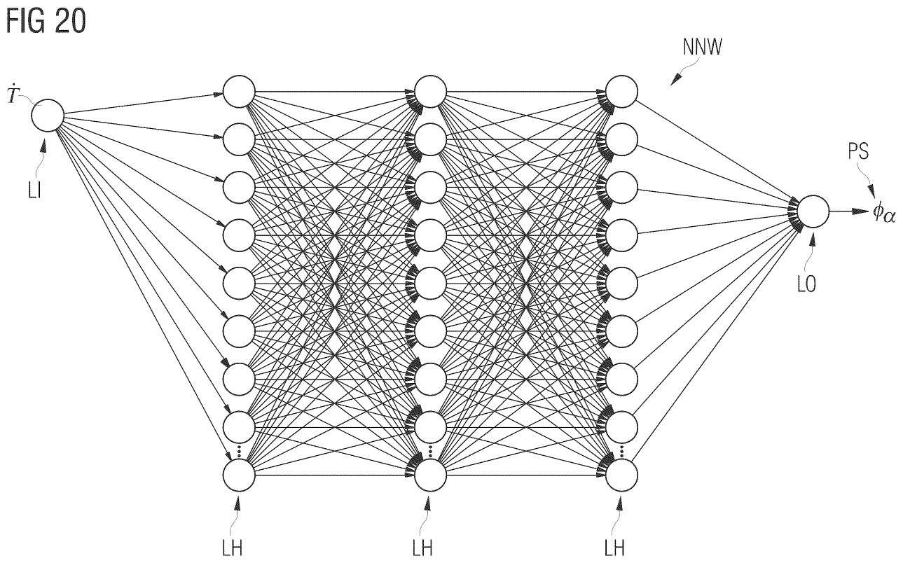

FIG. 20 shows a schematic representation of a third exemplary embodiment for a neural network,

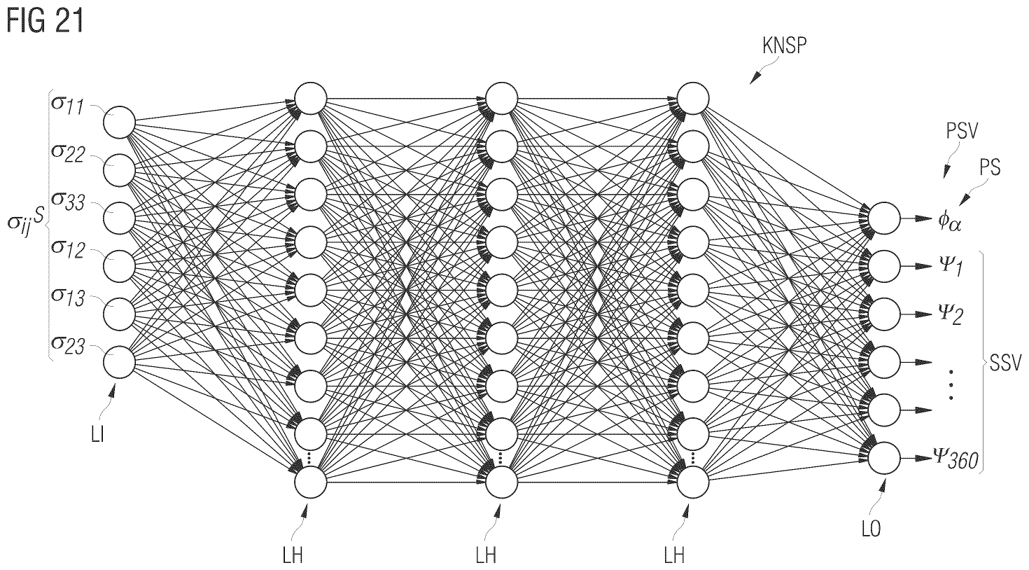

FIG. 21 shows a schematic representation of a fourth exemplary embodiment for a neural network,

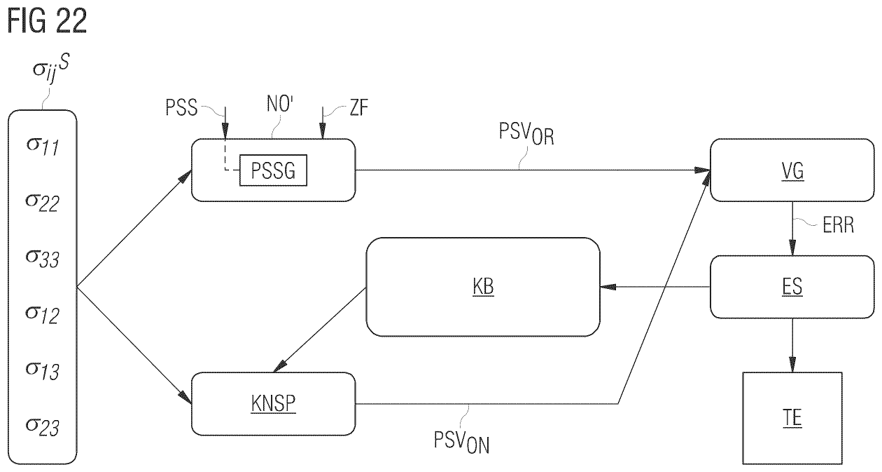

FIG. 22 shows a simplified flow diagram of a possible method for training a neural network as in FIG. 21,

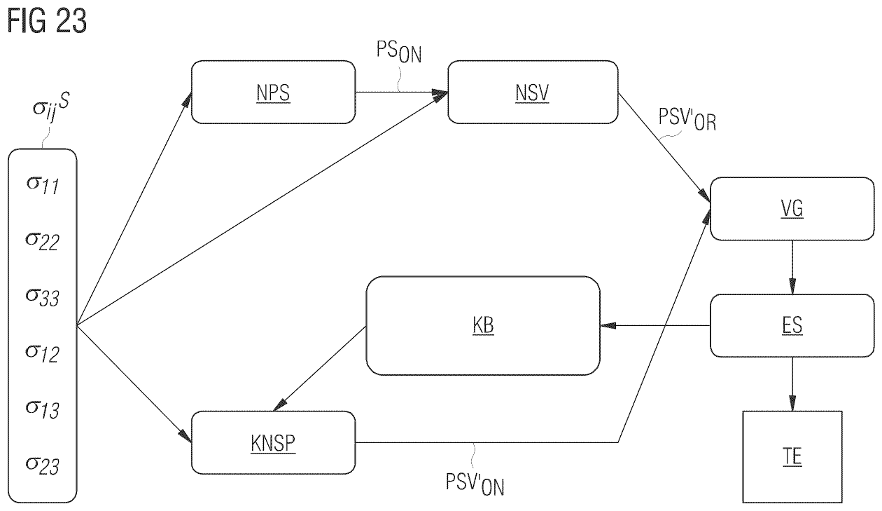

FIG. 23 shows a simplified flow diagram of an alternative method for training a neural network as in FIG. 21,

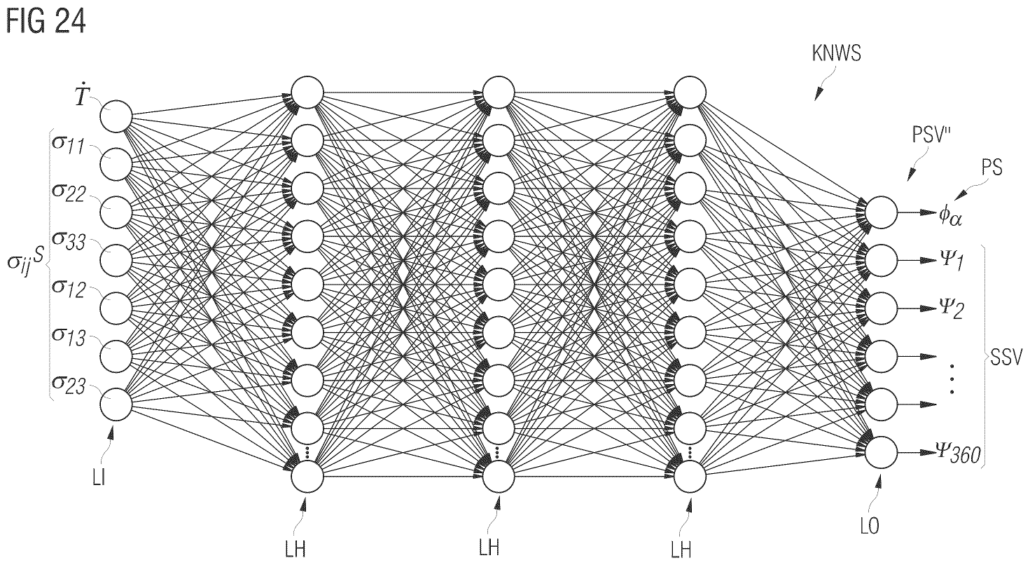

FIG. 24 shows a schematic representation of a fifth exemplary embodiment for a neural network,

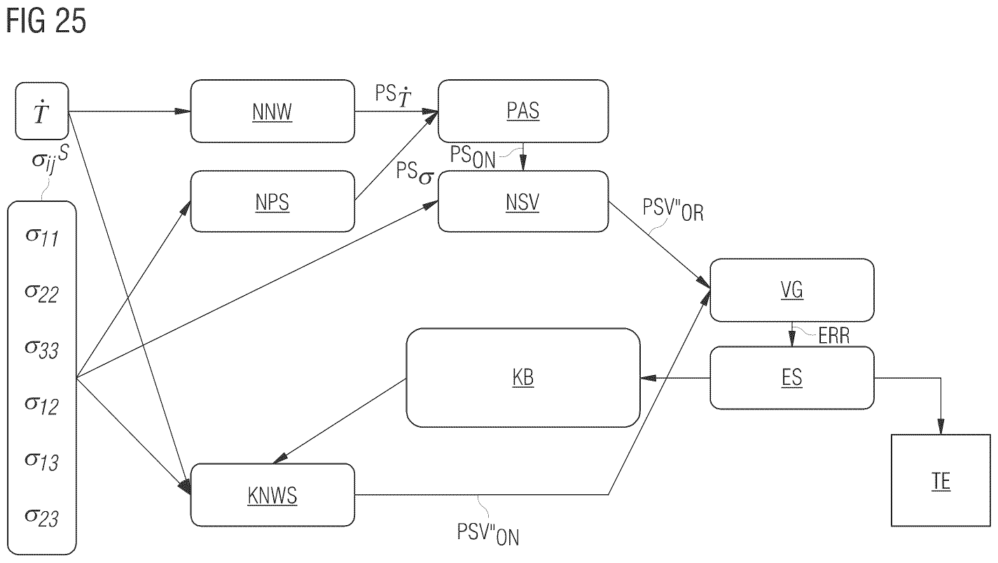

FIG. 25 shows a simplified flow diagram of a possible method for training a neural network as in FIG. 25,

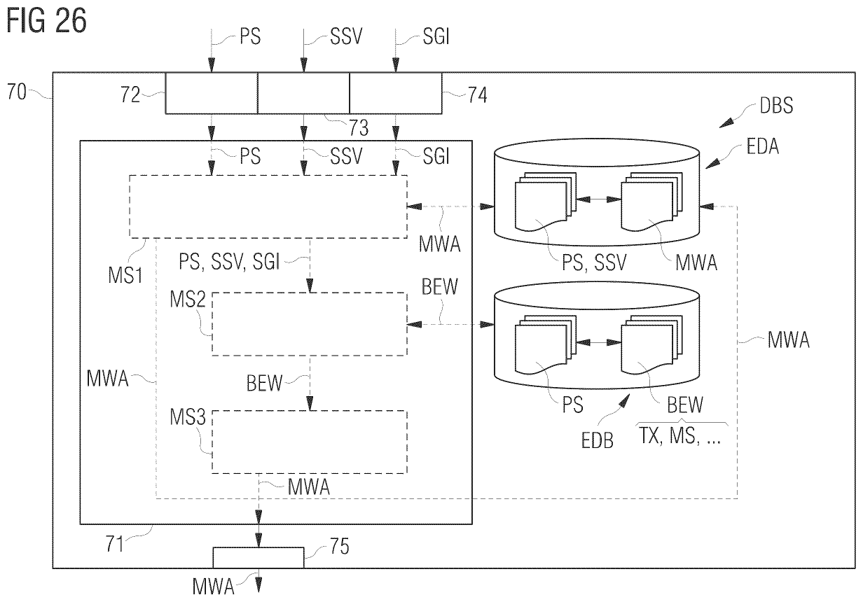

FIG. 26 shows a block diagram of an exemplary embodiment of a device for determining property values of a segment.

The following exemplary embodiments are described with reference to a production device 1 for additive manufacturing of manufacturing products in the form of a laser sintering or laser melting device 1, wherein it is explicitly pointed out once again that the invention is not limited to laser sintering or laser melting devices. The production device 1 is therefore also referred to in the following—without limiting the generality—as “laser melting device” 1.

Such a laser melting device 1 is shown schematically in FIG. 1. The device has a process chamber 3 or a process space 3 with a chamber wall 4, in which the manufacturing process fundamentally takes place. In the process chamber 3 there is an upwardly open container 5 with a container wall 6. The upper opening of the container 5 forms the current working plane 7. The region of this working plane 7 inside the opening of the container 5 can be used to construct the object 2 and is therefore referred to as the construction field 8.

The container 5 has a base plate 11 that moves in a vertical direction V and is arranged on a carrier 10. This base plate 11 closes the container 5 at the bottom and thus forms its base. The base plate 11 can be formed integrally with the carrier 10, but it can also be a plate formed separately from the carrier 10 and attached to the carrier 10 or simply mounted on it. Depending on the type of specific construction material, for example the powder used, and the manufacturing process, a construction platform 12 can be attached to the base plate 11 as a construction substrate on which the object 2 is constructed. In principle, however, the object 2 can also be built on the base plate 11 itself, which then forms the construction substrate.

The basic construction of the object 2 is carried out by first applying a layer of construction material 13 to the construction platform 12, then—as explained later—selectively solidifying the construction material 13 with an energy beam E at the points which are to form parts of the object 2 to be manufactured, then lowering the base plate 11, thus the construction platform 12, with the aid of the carrier 10 and applying a new layer of construction material 13 and selectively solidifying it, and so on. In FIG. 1, the object 2 built up in the container on the construction platform 12 is shown below the working plane 7 in an intermediate state. It already has several solidified layers, surrounded by unsolidified construction material 13. Various materials can be used as construction material 13, preferably powders, in particular metal powder, plastic powder, ceramic powder, sand, filled or mixed powders or even pasty materials.

Incidentally, the working plane 7 here defines the x/y plane of a Cartesian reference coordinate system. The z direction points vertically upwards from this x/y plane and forms the main build direction, as the layers L (layers) of the component 2 are gradually built up on top of each other in this direction as the base plate 11 is successively lowered.

Fresh construction material 15 is located in a storage container 14 of the laser melting device 1. The construction material can be applied in the working plane 7 or within the construction field 8 in the form of a thin layer with the aid of a coater 16 movable in a horizontal direction H.

Optionally, there is an additional radiant heater 17 in the process chamber 3, which can be used to heat the applied construction material 13 so that the irradiation device used for selective solidification does not have to introduce too much energy. This means, for example, that a quantity of basic energy can already be introduced into the construction material 13 with the aid of the radiant heater 17, which is of course still below the energy required for the construction material 13 to melt or sinter. For example, an infrared radiator can be used as the radiant heater 17.

For selective solidification, the laser melting device 1 has an irradiation device 20 or specifically an exposure device 20 with a laser 21. This laser 21 generates a laser beam E (as an energy beam E for melting the construction material in the construction field 8). The energy beam E is then deflected by a subsequent deflection device 23 (scanner 23) in order to scan the exposure paths or tracks in the layer to be selectively solidified in accordance with the exposure strategy and to selectively introduce the energy. In other words, the scanner 23 is used to move the impact surface 22 of the energy beam E on the construction field 8, wherein the current movement vector or the direction of movement S (or scanning direction S) of the impact surface 22 on the construction field 8 can change frequently and rapidly. This laser beam E is suitably focused on the working plane 7 by a focusing device 24. The irradiation device 20 is preferably located here outside the process chamber 3, and the laser beam E is guided into the process chamber 3 via a coupling window 25 attached to the top of the process chamber 3 in the chamber wall 4.

The irradiation device 20 can, for example, comprise not just one but several lasers. Preferably, these can be gas or solid-state lasers or any other type of laser such as laser diodes, in particular VCSEL (Vertical Cavity Surface Emitting Laser) or VECSEL (Vertical External Cavity Surface Emitting Laser) or a row of these lasers.

The laser melting device 1 may further comprise devices etc. (not shown, known to a person skilled in the art) in order to apply methods such as melt pool monitoring or the like in order to compensate for any disturbances occurring in the manufacturing process in order to remain as close as possible to the target process control specified by the control data created in accordance with the invention.

The controller 50 here has a control unit 51, which controls the components of the irradiation device 20 via an irradiation control interface 53, namely transmits laser control data LS to the laser 21, scan control data SD to the deflection device 23, and focus control data FS to the focusing device 24.

The control unit 51 also controls the radiant heater 17 using suitable heating control data HS, the coater 16 using coating control data ST, and the movement of the carrier 10 using carrier control data TSD, thus controlling the coating thickness.

The controller 50 is coupled, here for example via a bus 55 or another data connection, to a terminal 56 with a display or the like. Via this terminal 56, an operator can control the controller 50 and thus the entire laser melting device 1, for example by transmitting process control data PSD.

In order to optimize the production process, the process control data PSD, in particular the exposure control data BSD of the process control data PSD, (both also abbreviated synonymously simply as “control data”) are generated or modified by means of a control data generation device 54, 54′ in the manner according to the invention in such a way that the control of the production device 1 takes place in such a way that, during the additive manufacturing process, certain optimized process variable values PGO are sufficiently achieved in accordance with a predetermined evaluation criterion and are maintained accordingly, as already mentioned above. For this purpose, the control data generation device 54 may also comprise a suitable device 60 for generating the optimized process variable values PGO—in particular in the form of suitable software or the like. This can, in turn, have as sub-units (e.g. software modules, routines, objects, etc.) a testing device 80 for checking the (probable) compliance with property requirements by a component which was constructed using certain process variable values, and a device 70 for determining property values of segments of such a component. Preferred approaches for determining optimized process variable values PGO and preferred exemplary embodiments of suitable devices will be explained later with reference to FIG. 2 ff.

The control data generation device 54 can, for example, be part of the controller 50 and can be realized there, for example, in the form of software components. Such a control data generation device 54 integrated in the controller 50 can, for example, accept requirement data AD (including geometric data GD) for the component to be manufactured and, on this basis, can generate the optimized process variable values PGO and, based thereon, the appropriate control data PSD and can transmit them to the control unit 51. In particular, the control data PSD comprises exposure control data BSD, but possibly also other control data, such as coating control data ST or carrier control data TSD, in order to select a suitable layer thickness.

However, it would also be possible for the control data generation device 54′ to be realized on an external computer unit, for example the terminal 56 in this case, and to generate, in advance, optimized process variable values PGO and the corresponding process control data PSD (in particular exposure control data BSD) for the component to be manufactured based on requirement data AD (including the geometric data GD), which are then transferred to the controller 50. In this case, the internal control data generation device 54 present in the controller 50 could also be dispensed with.

A variant is also possible in which, based on the requirement data AD (including the geometric data GD) for the component to be manufactured, the optimized process variable values PGO are determined in a separate device 60 (e.g. on a separate computer unit connected to the bus 55) and are then made available to the respective control data generation device 54, 54′, for example, so that the latter only has to determine the appropriate control data PSD, BSD for this purpose. The control data generation device 54, 54′ then no longer requires a device 60 for generating the optimized process variable values PGO (or a testing device 80 or a device 70 for determining property values of segments of a component).

Several of the above-mentioned possibilities for arranging the various devices 54, 54′, 60, 70, 80 in a suitable topology of computing units and the controller 50 are shown as alternatives in FIG. 1. In addition, further variants can also be realized, for example in order to distribute the tasks for carrying out the invention to different computer units or the like

The process control data PSD, in particular exposure control data BSD, generated by the control data generation device 54, 54′ can also be regarded as set values, which are then used in the control unit 51 for a control process.

It is also pointed out once again at this juncture that the present invention is not limited to such a laser melting device 1. It can be applied to any other method for generatively or additively producing a three-dimensional object by applying and selectively solidifying a construction material, in particular layer by layer. Accordingly, the irradiation device can also comprise not only a laser, as described here, but any device could be used with which energy can be selectively applied to or into the construction material as wave or particle radiation. For example, another light source, an electron beam, etc. could be used instead of a laser.

Even if only a single object 2 is shown in FIG. 1, it is possible and generally also common to produce several objects in parallel in the process chamber 3 or in the container 5.

For additive manufacturing techniques, as mentioned at the outset, there is a correlation between certain process variables, such as the scanning speed, laser power and scanning strategies in a laser melting process in particular, and the resulting microstructure within the component.

In crystalline or semi-crystalline solids, such as metallic components that have been additively manufactured using a laser melting process, for example, the crystallographic texture amongst other things has a considerable influence on the component properties. The texture is defined as the totality of crystal orientations. It can be described, for example, by the “orientation density function” (ODF for short). DE 10 2022 117 935 and DE 10 2022 117 936 describe such microstructures as the texture and the influence of the texture by the process variables during component production (production variables) in greater detail, so that reference is also made thereto. However, a correlation between the selected production variables and the resulting properties of the component can also be determined for polymer or ceramic materials, so that the invention can in principle also be used for other materials or any construction materials.

The cooling conditions during solidification are an important point for the development of a texture within a component. Critical influencing variables here are the temperature gradient that occurs and the feed rate of the solidification front. In laser-based additive manufacturing, where a three-dimensional melt pool is always present locally, which gradually moves in the scanning direction, both the scanning speed and the laser power density have an influence on the texture, as they are also the main factors influencing the shape and size of the melt pool that forms. For example, at very low scanning speeds, an approximately spherical melt pool is formed, resulting in a heat dissipation inclined by approximately 45° to the construction direction. If the scanning speed is increased while the power remains the same, the length of the melt pool increases, while the width and depth (in the z-direction) decrease, which is why the heat dissipation is oriented in a good approximation along the construction direction (i.e. in the z-direction; see for example FIG. 3 in DE 10 2022 117 935 with the associated description).

Here, the texture in a component does not only depend on the exposure strategy within the respective layers, i.e. the layer scanning direction arrangement already mentioned above.

The layer scanning direction arrangement initially only significantly (co-)determines an “intralayer scanning direction distribution” in a single layer. However, since a segment of the component or the entire component is made up of several layers, the relative position of the intralayer scanning direction distributions of the individual layers to each other also plays a significant role for the overall resulting texture of the segment or in a component, since a different orientation of the layer scanning direction arrangements or intralayer scanning direction distribution would also lead to a different segment scanning direction distribution, which defines a frequency of occurrence of the respective scanning directions in the segment or component as a whole.

FIGS. 2 to 6 are used as examples to illustrate how different segment scanning direction distributions SSV2, SSV3 result for two different segments SG2, SG3 of a very simple component 2″ created from several layers L, wherein a different layer scanning direction arrangement HS2, HS3 (hatching strategy) was used in each of the segments SG2, SG3. The layer scanning direction arrangements HS2, HS3 remain the same across all layers of the respective segment SG2, SG3 and are only rotated by a defined angle (which is different here in the segments SG2, SG3) from layer to layer.

The component 2″ is a simple square bar 2″ and the build direction z runs in the longitudinal direction of the square bar 2″, i.e. the individual layers L are each oriented in the x/y plane. In the centre region within this square bar 2″ there is an elongate round bar-shaped segment SG2. The entire outer region of the square bar 2″ apart from this round bar-shaped segment SG2 in the centre (which forms a kind of core of the square bar 2″) is a second segment SG3. This is shown on the left-hand side in FIG. 2.

On the right-hand side in FIG. 2, the hatching directions in four arbitrarily selected layers L1, L2, L3, L4 (also called layers) of this component 2″ are shown to illustrate that different layer scanning direction arrangements HS2, HS3 are used in the respective segments SG1, SG2. In the present case, the layer scanning direction arrangements HS2, HS3 correspond to very simple hatching strategies HS2, HS3, which are used to scan or fill the entire surface of the respective segment SG2, SG3. Normally, components are divided into different regions, wherein the core region, for example, is travelled along wide tracks, each of which has a specific hatching pattern transverse to the track direction, i.e. the hatching strategies are considerably more complicated. In addition, in regions at the edges of the component, regardless of whether these are outer edges or cavities in the component, a contour mode is usually used in which an energy beam is continuously moved along the contour so that no hatching pattern is visible on the surface of the finished component. However, the simplified hatching strategies HS2, HS3 in FIG. 2 are better for clarifying the overall principle.

As shown here using the lowest layer L1 (the layers shown separately at the side), the inner segment SG2 has a hatching strategy HS2 in which two tracks are always travelled in parallel in one direction and then two adjacent tracks are travelled in parallel in the opposite direction and so on. In contrast, the hatching strategy HS3 in the outer segment SG3 is selected in such a way that one track always runs alternately in the forward direction and a second track in the reverse direction and so on. This means that the tracks run in a meandering form.

In addition, as mentioned above, different strategies of the re-orientation or rotation about the z-axis (main build direction) of the hatching strategy HS2, HS3 are followed from layer to layer for the two segments SG2, SG3. In the inner segment SG2, for example, the orientation of the layer scanning direction arrangement HS2, HS3 is always rotated by 45° from layer to layer. By contrast, the outer segment SG3 is always rotated by 90°. If a segment SG2, SG3 is then made up of several such superimposed layers, a different segment scanning direction distribution SSV2, SSV3 results for the segment SG2, SG3 as a whole, as shown in FIGS. 3 to 6.

In these figures, a diagram of the segment scanning direction distribution SSV3 for the outer segment SG3 is shown at the top and a diagram of the segment scanning direction distribution SSV2 for the inner segment SG2 is shown at the bottom. In these and all other diagrams for the segment scanning direction distributions SSV1, SSV2, SSV3, SSV4, a frequency of occurrence of the scanning direction at the relevant angle is plotted over an angle of 0 to 360°. The reference angle (e.g. where the angle 0° lies in the layer plane) can be chosen arbitrarily, as this is only a distribution. For example, the orientation of the hatching directions that run in the x-direction could always be selected as the reference orientation RO for the segment. If the component—as is usually the case—comprises several segments, the same reference orientation should be selected for all segments of the component, i.e. a reference orientation is defined for the component. In addition, the frequency of the occurrence of the scanning direction can be plotted in arbitrary units.

Since the individual scan paths according to the defined layer scanning direction arrangements HS2, HS3 are adhered to relatively precisely here, relatively narrow Gaussian lines also result in the segment scanning direction distributions SSV2, SSV3 at the corresponding degrees of the orientation of the layer scanning direction arrangement HS2, HS3.

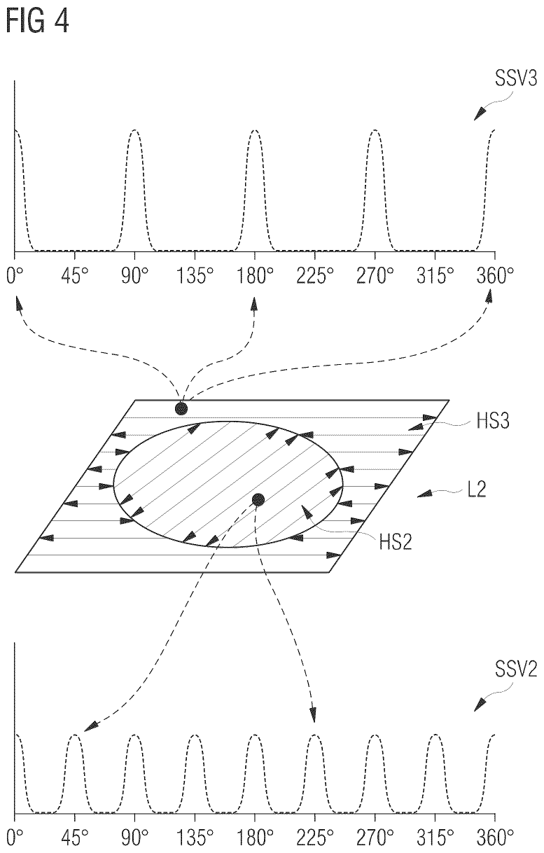

Between the upper segment scanning direction distribution SSV3 for the outer segment SG3 and the lower segment scanning direction distribution SSV2 for the inner segment SG2, the respective layer (in FIG. 3 the lowest layer L1) is shown again in each of FIGS. 3 to 6, and arrows mark how the individual scanning directions of the hatching strategy HS3 in the outer segment SG3 of the lowermost layer L1 contribute to the peaks in the upper segment scanning direction distribution SSV3 and how the individual scanning directions of the hatching strategy HS2 in the inner segment SG2 of the lowermost layer L1 contribute to the peaks in the lower segment scanning direction distribution SSV2. For example, the first layer L1 for the outer segment SG2 leads to a peak at 90° and another peak at 270°. By contrast, the hatching strategy HS2 for the inner segment SG2 in the first layer L1 leads to a peak at 0° and a further peak at 180°. FIGS. 4, 5 and 6 then show how the overlying layers L2, L3 and L4 contribute to further peaks in the segment scanning direction distributions SSV2, SSV3 for the outer segment (see the upper curve in each case) and the inner segment (see the lower curve in each case). It can be clearly seen here that not only are the hatching strategies HS2 and HS3 responsible for the segment scanning direction distribution SSV, but in particular also the strategy for the orientation of the respective hatching strategies from layer to layer. For example, the segment scanning direction distribution SSV3 for the outer segment SG3 only has peaks at 0°, 90°, 180°, 270° and 360°, whereas the segment scanning direction distribution SSV2 for the inner segment SG2 covers considerably more angles.

In principle, however, it would also be possible and in reality also preferable to use considerably more complicated or smoother segment scanning direction distributions in which the scanning directions do not run within such narrowly defined angles as is the case in the simple exemplary embodiment presented above.

FIG. 7 shows an example of a nearly uniformly distributed segment scanning direction distribution SSV3, wherein the distribution function is approximated by the probabilities achieved in each individual degree direction. Since most machines can usually resolve 1° exactly, the distribution function could be approximated by 360 individual steps.

Such a uniform distribution can be achieved in the construction of the product if a segment consists of many layers and the same layer scanning direction arrangement (hatching strategy) is used in each layer of the segment, but from layer to layer the orientation of the layer scanning direction arrangement is always rotated by an angle (e.g. the frequently used angle of 67°) that is not a divisor of 360°. In this case, virtually all angles occur in the segment scanning direction distribution.

FIG. 8 also shows a segment scanning direction distribution SSV4 with an almost equally distributed angle. Such a segment scanning direction distribution SSV4 can also be approximated from basis functions, e.g. radial basis functions, as shown. This has the advantage that the entire segment scanning direction distribution can be parameterized, i.e. it can be described by a relatively limited number of free angular distribution parameters, which can reduce the computational effort involved in finding the optimum segment scanning direction distribution.

It is therefore always possible to change the segment scanning direction distribution, for example by selecting other layer scanning direction arrangements (i.e. a correspondingly modified parameter set, as the layer scanning direction arrangement—unlike the segment scanning direction distribution—is also specified as part of the parameter set), in particular other hatching strategies, and/or by modifying the orientation or rotation of the layer scanning direction arrangements in consecutive successive layers, for example by rotating them by 45° instead of 90°, etc. Just like the choice of other process parameters during production, this has an influence on the texture and therefore also on other properties of a component.

The invention can utilize all of these above-mentioned relationships in that at least one macro property value of the relevant segment can be determined or approximated on the basis of a known parameter set which was or is to be used to build up a layer of a segment of a component, as well as a segment scanning direction distribution which results over the entire segment composed of several layers. In addition, based on the relationships between the process parameter values and the segment scanning direction distribution on the one hand and the desired properties of the manufacturing product created on the other, optimized process variable values, in particular an optimized segment scanning direction distribution and an optimum parameter set in the respective segment (and thus also an optimum scanning direction distribution for the component as a whole), can be determined for the individual segments of the manufacturing product so that the component ultimately fulfils certain (quality) requirement data particularly well.

A simplified diagram of a suitable device for generating optimized process variables is shown in FIG. 9. At the heart of this device 60 is an optimization unit 65 (“optimizer” for short), for example in the form of software. Among other things, the optimizer 65 here contains at least one AI-based optimization unit NN, here specifically a neural network NN, as a subunit, e.g. in the form of a software module. However, several AI-based optimization units NN can also be used in the optimizer 65. Examples of AI-based optimization units in the form of (trained) neural networks and training methods will be explained in greater detail later.

This optimizer 65 can be supplied with requirement data AD of the desired manufacturing product via a requirement interface unit 61, for example by a user. The requirement data AD comprises at least geometric data GD of the manufacturing product, wherein this geometric data GD can, for example, in the most general case also comprise only permitted maximum dimensions for the component, or only maximum or minimum dimensions in certain directions, but on the other hand also very specific dimensions over certain exact lengths or even the CAD data defining the complete contours of the component.

The optimizer 65 is also supplied via an interface 62 with data regarding the hardware properties of the machine used (i.e. the production device 1), in particular regarding the possible process parameters with which the production device 1 can be controlled at all.

Via an interface 63, the optimizer 65 can access a property database system DBS (hereinafter also referred to as “database system” for short), which will be explained in greater detail later: In the database system DBS, certain parameter sets, with which the production device 1 can be controlled during the manufacturing process of a layer (in particular the scanning speeds, the laser power density, etc.), are assigned property values of the respective layer or segment depending on various information about the scanning directions, for example the layer scanning direction arrangements within a layer and/or the segment scanning direction distribution within a segment consisting of several layers. This can include basic property values BEW of the individual layers, such as the texture as a mathematical description by means of ODF in the respective layer or its elasticity tensor, but also macro property values MWA, which describe the texture or ODF from a macroscopic perspective in the entire segment, for example, and/or macro property values MWA derived therefrom, such as stiffness or strength, to name just a few examples.

The optimizer 65 can then determine optimized process variable values PGO from all of this data, e.g. in the approach explained below with reference to FIG. 12, and can make them available for further purposes via an interface 64.

The entire device 60, i.e. not only the optimizer 65, but also all interfaces 61, 62, 63, 64 can be implemented in the form of software on a suitable computer unit. The database system DBS can also be part of the device 60 and can also be realized on the relevant computer unit. In principle, the interfaces (i.e. the requirement interface 61, the other interfaces 62, 63 and the process variable value interface unit 64) can also be designed as a common interface unit in order to accept data, process it in the optimizer 65 and output it again.

The optimized process variable values PGO can be provided, for example, by storing them in a suitable memory or by sending them to another unit, which then generates the optimized control data for the production device based on them, for example in one of the control data generation devices 54, 54′, as shown schematically in FIG. 1.

For the optimization process, the optimizer 65 also receives information about a desired target function ZF, wherein this target function ZF can also result at least in part from the requirement data and/or can be adopted from another program and/or can be specified or configured by means of a user interface.

Such a target function ZF can have a large number of sub-functions TF1, . . . , TFi, . . . , TFn (also called “sub-functionals”), each of which serves to take different requirements into account. This is shown graphically in FIG. 10.

Reference is also made in particular to DE 10 2022 117 935 with regard to the establishment and utilization of the target function ZF and its possible sub-functions. The functionalities there are also usable within the scope of the present invention and are only supplemented by the invention.

Preferably, a sub-function TF1 can, for example, basically comprise the maximization of the construction rate and preferably there is also a sub-function TFn, which is aimed at minimizing the changes of the parameter set within the overall structure of the component. This means that the component should contain as few different segments as possible, as the individual segments are defined in such a way that the same parameter set is used within the segment to build up the layers of the segment in question. This can be realized, for example, by a sub-function for minimizing the number of segment boundaries. In addition, there are a large number of other optional sub-functions TFi that can take a wide variety of criteria into account, such as minimizing the use of materials, optimizing a safety indicator factor (see equation (8)), minimizing the entropy of the segment scanning direction distribution (see equation (18), i.e. that the dead load of the component or the mass is reduced as far as possible, a depowderability etc. of the component and/or other arbitrary criteria.

In FIG. 10, the target function ZF is shown as a chain with a (preferably obligatory) first chain link representing the sub-function TF1 for maximizing the construction rate, and with a last chain link (preferably obligatory for the preferred optimization process with moving segment boundaries explained later) representing the sub-function TFn for minimizing the number of segments and thus changing the parameter set (if—as preferred—exactly one optimum parameter set is selected for each segment). Some optional sub-functions TFi are shown in between. However, this only serves to illustrate the various possibilities. In fact, the sub-functions TF1, . . . , TFi, . . . , TFn can be concatenated in any suitable order and manner in a target function. In order to prioritize the individual criteria, the various sub-functions TF1, . . . , TFi, . . . , TFn can also each be considered with a weighting factor in the target function ZF. The choice of optional sub-functions depends on the user and their optimization problem and can be extended as required. Through a sequential coupling with the boundary value problems or mechanical loads or property requirements the shape of the component is optimized in an area selected by the user for specified applications.

A target function F that can be used as part of the optimization process (which can also be referred to as a “quality functional” or “functional” for short), with which the optimum parameter sets and optimized layer scanning direction arrangements of the segments of a previously defined area Ω can be determined, can be mathematically defined as follows, for example:

$$F = \int {F}_{Seg} d Ω \qquad ( 1 )$$

F_{Seg} are the segment target functions of the individual segments in the area Ω. The integration corresponds here to a summation of the segment target functions in the area Ω.

These segment target functions can be defined as follows:

$${F}_{Seg} = {\sum }_{i} {W}_{i} {f}_{i}^{U} \qquad ( 2 )$$

The segment target functions F_{seg} can thus be described, without limiting the generality, as a weighted sum of sub-functionals

$${f}_{i}^{U}$$

(the sub-functions), each of which is multiplied by a weighting factor Wᵢ. Here, i is a running index for numbering the sub-functions and the U in ƒ^{U} is only a placeholder for a specific name of the sub-function, for example U=build for the sub-function (the sub-functional) ƒ^{build} to minimize the construction time or maximize the construction rate.

In principle, all sub-functionals ƒ^{U} (and thus also the segment target functions F_{seg} and ultimately the target function F) are in some way dependent on a selected parameter set φ_{α}(x)

$${f}^{U} ( {ϕ}_{α} ( x ) ) \qquad ( 3 )$$

x represents here the spatial coordinates in the area Ω, in which optimization takes place (i.e. in the component and in the powder segments). This means that each location in the area Ω is assigned a specific parameter set φ_{α}(x), wherein this corresponds to the parameter set currently valid for the segment in which the point is located for the construction of the layers of the segment in question. As part of the optimization process, a suitable parameter set is selected for each point or segment (besides the search for the optimum segment scanning direction distribution) from a number of candidate parameter sets, as mentioned above. α is here—and in the following—an index variable that denotes the various parameter sets φ_{α}(x) of the candidate parameter sets.

For example, the sub-function ƒ^{build} for minimizing the construction time can be defined as follows:

$${f}^{build} = - {B}_{α} ( {ϕ}_{α} ( x ) ) \qquad ( 4 )$$

This sub-function ƒ^{build} of the target function can be used to consider the contribution of the individual parameter sets φ_{α}(x) on the construction speed. The sub-functional ƒ^{build} is intended to ensure that under all possible configurations of parameter sets φ_{α}(x), depending on the location x, those with the highest volume construction rate are taken into account. Accordingly, B_{α} denotes the “volume construction rate” that can be achieved at the respective location x by the process parameter set φ_{α}(x). Other definitions of the sub-function ƒ^{build} to minimize the construction time are also possible, as will be shown later.

In addition, many sub-functionals ƒ^{U} still depend on the segment scanning direction distribution Ψ(x):

$${f}^{U} ( {ϕ}_{α} ( x ) , Ψ ( x ) ) \qquad ( 5 )$$

The segment scanning direction distribution Ψ(x) is dependent on the location x insofar as it depends on the segment in which the current location under consideration is located.

A concrete example of a sub-function dependent on the segment scanning direction distribution Ψ(x) is a sub-function which serves to adapt the location-dependent stiffness as well as possible to the stiffness requirements. An example of this can be found in DE 10 2022 117 935.

As shown in equation (2), a user can use a higher weighting factor Wᵢ to emphasize certain requirements within their multiphysical requirement profile and thus ensure that this aspect is given greater consideration when finding a Pareto optimum. In principle, the weighting factors can be any number greater than 0. A sensible option would be to always choose numbers between 0 and 1, wherein the sum of the weighting factors can also be normalized to 1. If, for example, three sub-functions are to be taken into account in the target function, namely one for the safety factor, one for the construction rate and one for the number of segment boundaries, wherein the safety factor is to have a higher importance, the sub-function for the safety factor could be weighted with 0.5 and the other two sub-functions with 0.25 each.

The target function to be finally minimized in the optimization process can therefore be defined by combining equations (1) and (2) as follows:

$$arg {min}_{{ϕ}_{α}^{Opt} ( x ) ∈ {ϕ}_{α} ( x )} ( {min}_{Ψ ( x )} ( F ) ) with F = \int {\sum }_{i} {W}_{i} {f}_{i}^{U} d Ω \qquad ( 6 )$$

The functional F has integral form here and always assumes a scalar value for the entire area Ω. A higher value of the quality functional F therefore describes a less desirable state in relation to the stated requirement profile and a lower value a more desirable state. By minimizing this function (6), the optimum can therefore be found, i.e. the optimum parameter set

$${ϕ}_{α}^{Opt} ( x )$$

is determined from the available (candidate) parameter sets φ_{α}(x) for the respective optimum segment scanning direction distribution Ψ(x).

Various optimization processes can be used for this purpose, wherein two basic cases can be distinguished:
a) Optimization with fixed segment boundaries.
b) Optimization with movable segment boundaries, i.e. the shape of the segments (and therefore also of the component) can be varied.

In both cases, the optimization can preferably be carried out in an iterative, sequential process, wherein all method steps can also be run through several times in iteration loops (in particular in nested loops) in order to take into account the influence of the optimizations in the respective steps on the other steps. In principle, it is also possible to perform an optimization with fixed segment boundaries in individual steps and then iteratively run through these steps several times, wherein segment boundaries can also be changed between the runs in other steps of the loop. This means that each time this optimization step with fixed segment boundaries is run through, an optimization is carried out with any changed segment boundaries. A more detailed example of this specific preferred approach will be explained later with reference to FIG. 12.

First, however, the following section provides an overview of optimization processes that can be used in principle with fixed segment boundaries or with movable segment boundaries:

a) Optimization with Fixed Segment Boundaries:

On the one hand a variety of classic, in particular numerical, methods for linear and non-linear local or global optimization with and without constraints can be used for this purpose, wherein, depending on the form of the target function F, methods that are derivative-free (e.g. interval bisection methods, downhill simplex methods, etc.), that require the first derivative (such as secant methods, gradient methods and conjugate-gradient methods, quasi-Newton methods, etc.) or that require the second derivative (such as Newton methods or Newton-Raphson methods) are particularly suitable. Depending on the method selected, the sub-functionals must then be formulated in such a way that they are optimized with regard to the variables to be optimized (i.e. the process parameter sets φ_{α}(x) and/or the segment scanning direction distributions Ψ(x)) are continuous, once continuously differentiable or even twice differentiable. Preferably, methods with high convergence are used, i.e. those that require the highest possible derivative, as such methods are faster.

Examples of the technical implementation of suitable optimization processes can be found in basic works such as C. Richter, Optimierung in C++: Grundlagen und Algorithmen, 2016, Wiley-VCH, Berlin, wherein the proposed work uses the quality functional with ƒ(x) instead of F and the variables to be optimized are denoted by x.

On the other hand, the use of at least one AI-based optimization unit (as will be shown later) is particularly suitable for such optimization steps with fixed segment boundaries, although AI-based optimization units can in principle also be used for optimization with moving segment boundaries. The aforementioned conventional methods can then be used, for example, to train the AI-based optimization units or neural networks.

b) Optimization with Variable Segment Boundaries:

There are also various methods for realizing optimization with movable segment boundaries. As mentioned, it is possible to simultaneously optimize the shape, i.e. the geometry, of the segments (and thus the component) and the segment scanning direction distributions, wherein the parameter sets applicable at the individual locations can inevitably also be varied by shifting the boundaries of the segments, as the location in question may be assigned to another segment by the boundary shift, in which a different parameter set applies. In principle, without limiting the generality, all methods that are used for topology optimization can be used to minimize the target function F. These methods include, inter alia:
discrete topology optimization, Michell A. G. M. The limits of economy of material in frame structures. Philosophical Magazine 8(47):589-597, 1904
Shape derivatives topology optimization, P. Gangl, Sensitivity-based topology and shape optimization with application to electrical machines, University of Linz, Dissertation 2016
Level set, S. Kambampati, C. Jauregui, K. Museth & H. A. Kim, Large-scale level set topology optimization for elasticity and heat conduction, Structural and Multidisciplinary Optimization volume 61:9-38, 2020
Evolutionary structural optimization, P. Tanskane, The evolutionary structural optimization method: theoretical aspects, Computer Methods in Applied Mechanics and Engineering, 191(47-48): 5485-5498, 2002
Phase field, J. Kato, S. Ogawa, T. Ichibangase & T. Takaki, Multi-phase field topology optimization of polycrystalline microstructure for maximizing heat conductivity, Structural and Multidisciplinary Optimization volume 57: 1937-1954, 2018

For this purpose, a so-called “interface dynamic” must be derived from the target function F, wherein a numerically solvable differential equation is created, in which the target function F is derived according to the parameters to be optimized. These approaches are generally known to a person skilled in the art.

A so-called “multi-phase field method”, as explained in DE 10 2022 117 935 (with the evidence therefore for the basic procedure) can be used particularly preferably in conjunction with the invention. However, the invention should not necessarily be limited to this preferred method.

The multi-phase field method (as a phase field method) is actually a method for the numerical simulation of processes in which two or more phases and the interfaces between them, the phase boundaries, are to be described. The phase field method can be used to determine how structures and the course of the interfaces change over time. This principle (as explained in DE 10 2022 117 935) can be advantageously used within the scope of the invention to describe the shifting of the interfaces between adjacent segments in which different process parameter sets φ_{α}(x) and/or segment scanning direction distributions Ψ(x) should apply. The different process parameter sets φ_{α}(x) and/or segment scanning direction distributions Ψ(x) therefore correspond to the different “phases” in the present case. Otherwise, the approach can be largely adopted in principle.

In order to carry out an optimization with moving segment boundaries using such a multi-phase field method, usually non-linear, partial differential equations are derived from the target function F (as described in greater detail in DE 10 2022 117 935), each of which describes the movement of the segment interface positions (i.e. the positions of the individual points or locations x of the segment boundaries).

Since, at a boundary between two adjacent segments on the one hand, there is a change from one parameter set φ_{α}(x) to another parameter set φ_{β}(x) (β is simply another index variable here, not equal to α), but on the other hand no sharp transitions (interfaces) or jumps are permitted when using the required differential equations, the parameter sets φ_{α}(x) at the location x are, to this end, each represented by their “proportions” φ̅_{α}(x) in the technical realization of the optimization algorithm. The value of the proportion can be between 0 and 1, wherein φ̅_{α}(x)=1 means that the parameter set φ_{α}(x) is present at a location x and a proportion of φ_{α}(x)=0 means that it is not present. This means that locations x in a boundary region (hereinafter also referred to as “interface region”, the width of which can be defined by a user) between two segments in the optimization can simply represent a proportion φ̅_{α}(x) of a first parameter set φ_{α}(x) that applies in the first segment and a proportion φ̅_{β}(x) of a second parameter set φ_{β}(x) that applies in the adjacent second segment. If more than two segments meet in an interface region, then at one location x there may also be proportions of more than two parameter sets. In any case, the sum of the proportions of all parameter sets present at each location must equal 1. In order to cover the entire area Ω with proportions φ̅_{α}(x) of parameter sets φ_{α}(x), for all locations x in a centre region of a segment, i.e. outside a boundary region to another segment, the proportion φ̅_{α}(x) of the parameter set φ_{α}(x) valid in the segment is simply set to 1 in the optimization.

The target function F or the individual sub-functionals ƒ^{U} must then be adapted accordingly for the phase field method, so that it mathematically considers the proportions \hat{φ}_{α}(x) of the parameter sets φ_{α}(x). This is done individually for the various sub-functionals and is described for various sub-functionals in DE 10 2022 117 935, so that reference can be made thereto. Reference is likewise made to that document in respect of the definitions and explanations of the above-mentioned differential equations.

As explained in greater detail in DE 10 2022 117 935, the segment scanning direction distributions ω(x) can also be optimized as part of the multi-phase field method by optimizing according to the free angular distribution parameters \tilde{Ψ}ᵢ(x), which can be used to define the segment scanning direction distributions Ψ(x) in each case.

For example, the free angular distribution parameters \tilde{Ψ}ᵢ(x) for a non-parametric description of the segment scanning direction distribution Ψ(x) can be the proportions of the individual discrete scanning direction angles in the respective segment scanning direction distribution Ψ(x). The segment scanning direction distribution Ψ(x), for example, can thus be broken down into 360 discrete scanning direction angles of one degree each. A free angular distribution parameter \tilde{Ψ}ᵢ(x) is then the proportion of exactly the i-th scanning direction angle in the segment scanning direction distribution Ψ(x). The value of the segment scanning direction angle components \tilde{Ψ}ᵢ(x) is between 0 and 1, wherein a value between 0 and 1 does not indicate a segment boundary, but only describes a proportion of the scanning direction angle in the segment scanning direction distributions Ψ(x). The rule here is that at each location x the sum of all segment scanning direction angle components \tilde{Ψ}ᵢ(x) must be equal to 1.

If the segment scanning direction distribution Ψ(x) can be defined parametrically, e.g. as a Gaussian distribution, the free angular distribution parameters \tilde{Ψ}ᵢ(x) can alternatively also be the individual parameters of the segment scanning direction distribution Ψ(x) according to which optimization is to take place, wherein i and j stand for the individual parameters (e.g. i for the mean value and j for the standard deviation).

In practice, with use of this phase field method, an existing program or program parts can simply be used to solve such tasks numerically for the optimization. For example, such programs are available in the software packages OpenPhase, OpenFoam or deal.II, etc.

Since the segment boundaries are defined by diffuse interface regions in the case of an optimization with variable segment boundaries, it is determined after optimization in which voxels in the interface region which process parameter set and which segment scanning direction distribution is ultimately to be used.

Among other things, this can also depend on what the data obtained in the optimization process is specifically intended to be used for.

If it is to be used directly to control the production device, use can also be made, in the interface regions, of the fact that the parameter set proportions φ̅_{α}(x) of different parameter sets φ_{α}(x) which are assigned to the various adjacent segments are known for the voxels there. In this case, for example, the data for the process parameter sets together with their proportions can also be transferred voxel by voxel to the controller of the production device, and, during the production method, the process parameter sets are applied several times in an overlap region between two segments according to their proportions. In a laser powderbed fusion process, for example, the laser can expose several times in the overlap region, each time with different process parameter sets.

By contrast, to reconstruct sharp segment boundaries again in order to visualize the component as a CAD model, this can be done using a suitable method, for example in the form of isosurfaces. Isosurfaces are surfaces that connect voxels that are adjacent in space and that have the same characteristics or values of a certain size, such as parameter set proportions or free angular distribution parameters. Since, as already mentioned, a segment is preferably also defined by the fact that the same process parameter set φ_{α} applies in the segment (in addition to the same segment scanning direction distribution) (and in this sense it could also be described as a “process parameter region”), the isosurfaces determined here are to be equated with the segment boundaries. In the voxels in which different parameter sets φ_{α}(x) with their respective parameter set proportions φ̅_{α}(x) are present, a decision must be made as to which parameter set should apply there. Preferably, for example, this can be the parameter set with the largest proportion.

One method for generating isosurfaces is, for example, the Marching Cubes method, as described in C. D. Hansen, C. R. Johnson Visualization Handbook, Elsevier Science, 2005, among others. Other methods from this textbook could also be used.

A corresponding assignment of the voxels in the interface region to a segment scanning direction distribution is not absolutely necessary, as it is not only possible to define the process parameter set with the assignment to a segment, but also to assign the associated layer scanning direction arrangement to the respective segment in which the process parameter set is to be applied. This automatically results in the segment scanning direction distribution of the segment, which is to be standardized for the entire segment.

In the following, some further sub-functions (=sub-functionals) are cited as examples in order to set up the target function according to equations (1) and (2).
a) Sub-functional for minimizing segment interfaces.
b) Sub-functional to ensure that the component can be depowdered (only with movable segment boundaries).
c) Sub-functional to ensure correct heat treatment.
e) Sub-functional to reduce the material use.
f) Sub-functional to optimally ensure a safety factor.
g) Sub-functional for maximizing the variation of the scanning direction angles.
h) Sub-functional for avoiding a divergence of segment scanning direction distributions Ψ(x) within a segment.

Since DE 10 2022 117 935 explains the above-mentioned sub-functionals in more detail, reference can again be made here for the sake of simplicity to the explanations of these sub-functionals given there. In principle, the sub-functionals can also be used in this way in the context of the present invention.

In the following, however, the preferred example of an optimum guarantee of a safety factor is also used for the improvements of the optimization strategies in the context of the present invention. Therefore, further explanations are given on the sub-functional for optimally ensuring the safety factor (which, however, largely coincide with the explanations in DE 10 2022 117 935).

In practice, structures are designed taking into account a “safety factor” with regard to their load. A safety factor is specified by means of a numerical value and indicates the factor by which the failure limit of a material state or of an entire component is designed to be higher than it should be based on theoretical determination. The safety factor is usually determined on the one hand from the state of the material of the component and the resulting theoretical state variables, e.g. strength, and on the other hand from the states of the field variables acting in the component, e.g. the mechanical stresses.

In order to depict this situation in a development of the method according to the invention, a safety indicator factor is preferably introduced, which describes the difference between the specified safety factor and the current state of the component or its segments from the simulation. The difference is preferably represented here by a number. This representation can be arbitrary, but should preferably represent at least three states:
i) the sought safety factor is undershot,
ii) the sought safety factor is exactly fulfilled
iii) the sought safety factor is exceeded.

For this purpose, a definition can preferably be made in such a way that the value 0 of the safety indicator factor expresses that the desired safety factor S is exactly fulfilled, that a value less than 0 expresses that this safety factor is undershot, and that a value greater than 0 expresses that this safety factor is exceeded. The value of the safety factor S is generally always greater than or equal to 1, otherwise the component would very probably fail under the planned load. It usually depends on the field of application and, if applicable, its standards. Typical values for the safety factor S are, for example, 1.5 or 2 in the automotive industry and 1.5 to 6 in the aviation industry, depending on the safety relevance of the component.

A safety indicator factor Ss_{α}(φ_{α}(x)) for a parameter set φ_{α}(x) at the location x can be defined as follows, for example:

$${Ss}_{α} ( {ϕ}_{α} ( x ) ) = \frac{1}{S} - g ( {σ}_{ij} , {ϕ}_{α} ( x ) ) \qquad ( 7 )$$

g(σᵢⱼ, φ_{α}(x)) herein represents a material-specific yield function which is to be scaled in such a way that g(σᵢⱼ, φ_{α}(x))=1 applies when the mechanical stress σᵢⱼ reaches the yield point of the material, i.e. the component begins to deform plastically. If the value of g(σᵢⱼ, φ_{α}(x)) is less than 1, the component is deformed purely elastically. The safety indicator factor Ss_{α}(φ_{α}(x)) is therefore only greater than or equal to 0 in the “permissible” range if a parameter set φ_{α}(x) is selected during optimization so that the resulting value of the material-specific yield function g(σᵢⱼ, φ_{α}(x)) is below the reciprocal value of the safety factor S.

There are various possibilities for defining suitable material-specific yield functions, which are known to a person skilled in the art. Some variants are presented, for example, in J. Betten, Kontinuumsmechanik, 1993, Springer-Verlag.

In principle, a suitable material-specific yield function or its parameters can also be defined, particularly in the isotropic case, with the aid of experiments on suitable samples, e.g. via tensile tests or the like.

A suitable sub-functional ƒ^{S} with use of this “safety indicator factor” Ss_{α}(φ_{α}(x)) according to equation (7) can be designed in such a way that, for an optimum parameter set φ_{α}(x) at the location x, particularly preferably the value for the safety indicator factor Ss_{α}(φ_{α}(x)) equal to 0 is sought. It is very particularly preferable to ensure that exceeding the safety factor is penalized more than undershooting it, i.e. that the safety factor S is certainly fulfilled, but the effort required for this is nevertheless minimized.

An execution of such a sub-function ƒ^{S} for an optimization with fixed segment boundaries can look like this:

$${f}^{s} = - exp ( - {Ss}_{α} ( {ϕ}_{α} ( x ) ) + \frac{1 {0}^{12}}{{( {Ss}_{α} ( {ϕ}_{α} ( x ) ) + A )}^{6}} \qquad ( 8 )$$

The sub-function described here was selected in the form of the Leonard-Jones (exp, 6) potential. This function should show a minimum if the safety indicator factor Ss_{α}(φ_{α}(x)) is equal to or close to 0. For a value less than zero, the sub-function should quickly assume a large value.

The value of the variable A in equation (8) can be used to shift the value for the safety indicator factor Ss_{α}(φ_{α}(x)) on the abscissa at which the sub-function ƒ^{S} has its minimum value. The sub-function ƒ^{S} in equation (8) is structured in such a way that, for the value A=0, this minimum value of the sub-function ƒ^{S} within the scope of the computational accuracy is Ss_{α}(φ_{α}(x))=0.025. A realization of the sub-function ƒ^{S} by means of equation (8) and A=0 is often the preferred variant, since in practice a value for the safety indicator factor Ss_{α}(φ_{α}(x)) of 0 can almost never be achieved anyway, but it can be ensured that the value comes very close to the value 0 from the safe side, i.e. greater than 0. However, this can also be realized in a similar way with other potential functions instead of equation (8).

In the case of a requirement that, for example, also allows the safety factor to be undershot in a certain region, but requires the component volume to be as low as possible, it can still make sense to achieve a safety indicator factor of 0 as well as possible, even if it is slightly undershot. If, for example, with the sub-function ƒ^{S} according to equation (8), with a value A=0, a safety factor S of 2 were sought, this could not be achieved, but the value for the safety factor would be at least 2.1. Due to a value A<0, this circumstance can be taken into account, however, which on the other hand means that the safety factor in the optimization can also be slightly undershot.

In such cases, however, it would also be possible to correct the safety factor beforehand, e.g. in accordance with

$${S}_{Korr} = \frac{S}{1 + 0025 S} \qquad ( 9 )$$

wherein simply the changed safety factor S_{Korr} instead of the safety factor S is used in equation (7).

Incidentally, in the context of a numerical realization of the optimization, a negative value may occur for the sub-function ƒ^{S} because the term Ss_{α}(φ_{α}(x))+A in equation (8) becomes negative. In this case, for example, when realizing the optimization with equation (8), the value of the sub-function ƒ^{S} can simply be set to 10⁹ so that the optimization process is forced to select the values differently and thus “correct” the invalid state.

An example of a suitable sub-function ƒ^{S}, in this case the function according to equation (8), is shown graphically in FIG. 11. Here, the value of the sub-function ƒ^{S} (in arbitrary units; a. u.=arbitrary units) is plotted against the safety indicator factor Ss_{α} (in arbitrary units). It can be clearly seen that the value of the sub-function, starting at the minimum of the sub-function ƒ^{S}, increases slowly with increasing safety indicator factor Ss_{α} (to the right), i.e. in the case of overdimensioning. However, at the minimum of the sub-function fs with falling safety indicator factor Ss_{α} (to the left), the values of the sub-function fs increase sharply.

As mentioned, to build the target function, at least a minimum configuration function is preferably required, which (as explained in DE 10 2022 117 935) is particularly preferably composed of a sub-functional for minimizing the construction time or maximizing the construction speed and—if an optimization with moving segment boundaries is carried out—a sub-functional for minimizing segment boundaries (process parameter interfaces), i.e. for minimizing the segments in the component. In addition, the target function may contain a number of other optional sub-functionals, such as the other sub-functionals mentioned above.

In the examples above, the simplest form of the sub-functionals is shown, which can be modified to include further constraints, provided that the constraint in question is not to be added to the optimization problem in the form of a separate sub-functional. Whether an optimization criterion is linked to another sub-functional, in particular one of the obligatory sub-functionals, or whether separate sub-functionals are defined depends on the complexity of the optimization problem.

An example of the coupling of an optimization criterion to an obligatory sub-functional is shown below using the coupling of the safety factor to the sub-functional for minimizing the construction time or maximizing the volume construction rate. This sub-functional for minimizing the construction time has already been presented above using equation (4) (without a shift in the segment boundaries). In both cases, the sub-functional can now be extended by a safety factor to obtain a sub-functional ƒ^{build-S} with construction rate-safety factor coupling:

$${f}^{build - S} = - {B}_{α} ( {ϕ}_{α} ( x ) ) sign ( {Ss}_{α} ) \qquad ( {4}^{′} )$$

Ss_{α} here again denotes the safety factor indicator, as can be defined above for example using equation (7). sign is the signum function, which only takes the sign into account and assigns a positive sign to the value 0. So, if a parameter set (φ_{α}(x)) would result in the safety factor being undershot (i.e. the safety factor indicator Ss_{α} would be negative), the volume construction rate would automatically no longer be subtracted from the target function, but added to it, because the sign in the sub-functional ƒ^{build-S} changes. This means that undershooting the safety factor is inevitably penalized.

If a sub-functional is used in which the safety factor is already integrated, it is not necessary to use, in addition, a separate sub-functional to maintain the safety factor.

A target function ZF defined in the manner described above can now be used (for example by the optimizer 65 according to FIG. 9) in an optimization process. An example of a possible optimization process is explained below with reference to FIG. 12. This is an iterative process. The target function can be used repeatedly in some of the method steps, wherein (only) certain sub-functions of the target function may also be used in various steps in order to initially process or optimize the optimization objectives underlying the sub-functions separately from one another. For example, the effect of certain sub-functions could be reduced or even deactivated in one step by setting certain parameters in this sub-function accordingly, or certain optimization parameters could initially be regarded as constant in certain steps.

In the example in FIG. 12, a target function is used as an example, which contains the sub-functions for minimizing the construction time, for minimizing the segment interfaces, for taking a safety factor into account, for a possible depowdering of the component, for enabling a heat treatment, for maximizing the variation of the scan angles, and for avoiding a divergence of the segment scanning direction distributions. However, it is expressly pointed out once again at this juncture that the target function can also be structured in a different way, as explained above. The optimum target function depends on the range of requirements, the available computing power and the time available.

In step S0, an area G (the calculation area or design space) is first defined, which includes the component to be produced. If the outer dimensions of the component to be produced are not to change, i.e. the shape is to remain unchanged, the outer contour of the component itself could form the area, for example. However, it would also be possible to draw a box around the component in any way, i.e. the unsolidified regions around the component or on certain sides of the component are also included in the area. This area is then subsequently divided into several segments (in the further steps, see below), wherein some of the segments may belong to the component, but there may also be segments (e.g. powder segments) that lie outside the component, provided that the area is larger than the component, as mentioned above.

In step S1, start values are then set for the subsequent optimization, which runs iteratively here, namely specific start segments SG′, as well as start parameter sets PS′ and start segment scanning direction distributions SSV′ associated with the start segments SG′.

FIGS. 13, 14 and 15 illustrate how an area G can be defined for a specific component 2′, in this case a buffer stop 2′, and how segments SG0, SG1, e.g. as start segments, can be defined in area G.

In FIG. 13, the component is shown as a triangular mesh to visualize that the data is virtually available to carry out a finite element simulation for the buffer stop 2′ for a load case in which external forces, which are shown as arrows in FIG. 13, act on the buffer stop 2′. Based on the simulation, a 3D load map can be created, which is visually represented in grey scale (or normally in colour) on the buffer stop 2′ in FIG. 14. This representation shows, for example, that only a small part of the volume, namely less than 3% by volume of the entire buffer stop 2′, is exposed to a load level above 200 MPa, with these higher-loaded regions being located primarily in the region of the cross struts of the buffer stop 2′.

Knowing the exact load information (which can also be requirement data, especially quality requirement data), such as information about the more heavily and less stressed regions, the component can then be advantageously divided virtually into individual segments.

In this case, the buffer stop 2′ can be divided into individual segments based on the load information in such a way that the particularly loaded regions in the cross struts are regarded as separate segments SG1 and the remaining region of the buffer stop 2′ can form a further segment. This is shown in FIG. 15. These segments can then, for example, initially be used as start segments SG′ in the optimization process.

FIG. 15 also shows how the entire component 2′ can be enclosed by a larger area G, for example, and the entire outer region around the component 2′ forms a further segment SG0, wherein this is a “powder segment” or “empty segment” in which the powder is not solidified in the manufacturing process. For such powder segments SG0, the start parameter set in the optimization process can simply be set so that the laser power here is 0. This start parameter set then no longer needs to be changed for the powder segment SG0.

For all other start segments SG′, a suitable start parameter set PS′ (for constructing the layers of the relevant start segment SG′) and a start segment scanning direction distribution SSV′ can then be selected in step S1, for example from a data memory DS, in which, among other things, various candidate parameter sets KPS can be stored, which are available for a construction with the production device 1 to be used. As a rule, a relatively limited number of candidate parameter sets KPS are involved here, although the number is of course limited only by the available memory space and by the computing time available for testing various candidate parameter sets KPS with regard to their effect on the property values of the manufactured component.

As a high level of efficiency of the component production is also an important criterion in many cases, it makes sense to select the start parameter set PS′ and the start segment scanning direction distribution SSV′ with which the highest construction rate can be achieved. In principle, however, another selection criterion can also be used. In particular, a start parameter set could also be selected already with use of a suitable AI-based optimization unit NN. For example, a suitably trained neural network NN (possibly after appropriate selection from a database) can be loaded from the data store DS, as will be described later with reference to step S3 or, more precisely, sub-steps S33 and S34.

It should be pointed out at this juncture that it would also be possible to choose the virtual division of the area G or the component 2′ into the start segments SG′ according to how the highest construction rate can be achieved and not to use a load simulation at this point, as shown in FIGS. 13 to 15. This applies in particular if the component is not to be subjected to high loads at all or if the load is more of a secondary consideration.

In the subsequent step S2, a requirement simulation is then first carried out for the (still virtual) component to be manufactured, assuming that the start configuration defined in step S1, i.e. the start segments SG′, the start parameter sets PS′ and start segment scanning direction distribution SSV′, were used during manufacture. As mentioned, macro property values of the individual segments, such as the texture (in particular in the form of the orientation density function ODF) and/or other macro property values, such as an elasticity sensor, a yield point distribution, a solidification coefficient, a thermal conductivity, a breaking strength, etc., can be determined for a known configuration or combination of segments SG and associated parameter sets PS and segment scanning direction distributions SSV.

As part of such a requirement simulation, a load simulation can then be carried out, for example, using the macro property values (of the segments or the component formed therefrom), similarly to what was previously visualized for the buffer stop 2′ with reference to FIG. 14, or a vibration simulation or the like. Such simulations are possible using standard numerical simulation methods such as finite element methods or finite volume methods. The result of this requirement simulation is then a state description with various state values of the current system or component with the individual segments, in particular what load these segments can withstand, the frequency of the entire system (component), specifically in each case for the current configuration in which the calculation is carried out in step S2.

As will be explained later, this step S2 is called up several times during the iterative process to check the current configuration. The first time it is called up, i.e. at the start of the optimization process, these state values or the state description for the start configuration from step S1 apply.

In the subsequent step S3, the state description or the state values etc. can then be compared with external specifications, in particular the requirement data for the component. These external specifications could also include, for example, load recordings that have been provided in advance as (quality) requirement data for the component, such as the load recordings from FIG. 14 for the example with the buffer stop 2′.

If, exceptionally, all the required variables are optimally fulfilled, it would be possible to construct the component with the start configuration, especially if this start configuration has already been selected so that the highest possible construction rate can be achieved. The start configuration would then be the optimum configuration and the optimized process variable values would already have been found. However, this case is very unlikely.

Normally, if not all requirements are met, the process variable values, namely the segments or their exact segment boundaries, as well as the parameter sets and the segment scanning direction distributions for the individual segments are further optimized in the subsequent process.

The objective is to assign to each segment the process parameters, i.e. the complete set of process parameters φ_{α} and the segment scanning direction distribution, which offer the highest optimization potential if, for example, the geometry is to be further optimized, i.e. the mass is to be further reduced, and/or the construction rate is to be maximised.

For this purpose, in step S3, new current parameter sets can be selected from the candidate parameter sets KPS for the current segments SG′, if necessary and also new current segment scanning direction distributions can be determined as appropriate. As mentioned, this selection can be made particularly preferably taking into account so-called “parameter set suitability values” PSS (referred to as PS scores PSS for short).

Different “requirement-specific PS scores” can be assigned to the candidate parameter sets KPS and/or segment scanning direction distributions (or pairs of candidate parameter sets KPS and/or segment scanning direction distributions) with regard to certain requirements, i.e. for each optimization criterion, for example with regard to strength, rigidity, construction rate, etc.

These parameter set suitability values PSS always depend on the process parameter set φ_{α}.

The parameter set suitability values for the installation rate and for compliance with the safety factor are shown here as examples.

The parameter set suitability value PSS can be defined as follows for the construction rate. It is only important here that the value of the parameter set suitability value is a maximum of 1 (=maximum construction rate) for the embodiment proposed here and that the value is greater than 0 for all suitable variants of the parameter set suitability values.

$${PSS}_{α}^{build} ( {ϕ}_{α} ) = \frac{{B}_{α} ( {ϕ}_{α} )}{{max}_{{ϕ}^{Opt} α ∈ {ϕ}_{α}} ( {B}_{α} ( {ϕ}_{α} ) )} \qquad ( 10 )$$

Here, the construction rate of a process parameter set B_{α}(φ_{α}) is standardised by the maximum construction rate of all process parameters available for optimization

$${max}_{{ϕ}^{Opt} α ∈ {ϕ}_{α}} ( {B}_{α} ( {ϕ}_{α} ) ) . \qquad ( 11 )$$

Other parameter set suitability values PSS can depend not only on the process parameter set φ_{α}, but also on the segment scanning direction distribution Ψ and also on a current state of the system in the respective segment, such as the above-explained homogenised mechanical stress

$${σ}_{ij}^{S}$$

in the segment. An example of this is the parameter set suitability value for ensuring a safety factor.

The parameter set suitability value for ensuring a safety factor can be as follows:

$${PSS}_{α}^{Sicherheit} ( {ϕ}_{α} , Ψ , {σ}_{ij}^{S} , … ) = 1 - exp ( - {Ss}_{α} ( {ϕ}_{α} , Ψ , {σ}_{ij}^{S} , … ) ) + ε {Ss}_{α} ( {ϕ}_{α} , Ψ , {σ}_{ij}^{S} , … ) \qquad ( 12 )$$

denotes the safety indicator factor already described above, except that the dependency on the segment scanning direction distribution Ψ and the homogenised mechanical stress

$${σ}_{ij}^{S}$$

in the segment is also displayed here. ε denotes the smallest number that can be displayed by the computer. As already mentioned, the safety indicator factor is 0 if the parameter fulfils the current safety condition exactly, a negative number if the desired safety factor is not met and a positive number if the desired safety factor is exceeded. The exponential function in equation (12) limits the maximum value according to the requirement to 1.

The requirement-specific PS scores PSS can be partially stored in the data memory DS or can be recalculated for the current configuration. This depends on the specific requirement to which the requirement-specific PS score relates. For requirements that only depend on the selected parameter set, such as the construction rate, these requirement-specific PS scores can be stored together with the parameter set. For requirements that also depend on external field variables, in particular mechanical forces, on the other hand, the PS scores are preferably recalculated each time the loop runs through step S3. An easy-to-understand example of this would be the mechanical stress in a component under a given load. These stresses depend, for example, on the geometry of the component and therefore also on the current configuration of the segments. If the boundaries of the segments are changed during the optimization process, the stresses in the component will inevitably also change. Consequently, it is better to adapt the PS scores with regard to such stresses to the current configuration in each case.

Firstly, a new parameter set and a new segment scanning direction distribution for the various segments are searched for in step S3 itself. A preferred possible procedure for the method sequence carried out in step S3 is explained in more detail below using the flow diagram in FIG. 16.

In the requirement simulations (which can also be referred to as “state simulations”) in step 2, the states for the individual (volume) elements (e.g. voxels) were determined using the numerical method, if it is a finite volume or finite element method, for example. A segment usually comprises a certain number of such elements. In the first sub-step S31 of the optimization process in step S3, a homogenised state of the field variables of the individual elements of the segment occurring in the segment can therefore be calculated for each segment in a particularly preferred manner. In the discrete case, the “homogenised state” is calculated by averaging the field variables of all elements in each segment. In general, this operation can be expressed by an integral and implemented in the specific numerical method by means of the corresponding discretisation.

A preferred homogenised field variable for a segment is, for example, the homogenised mechanical stress explained above (under the specific requirements to be achieved for the component or “target conditions”, for example a pressure of 5 MPa from the side onto the bumper). The following integral, for example, can be used to determine a homogenised mechanical stress:

$${σ}_{ij}^{S} = \frac{1}{V} {\int }_{V} {σ}_{ij} ( x ) dV \qquad ( 13 )$$

For the homogenised mechanical stress

$${σ}_{ij}^{S} ,$$

for example, this means that a mechanical stress distribution in a segment is compressed to one value (scalar, vector, matrix or tensor).

Thanks to homogenisation, the optimization does not have to be carried out for n finite volumes or finite elements, but only for k segments, where k<=n and in the best case k<<n applies. This can significantly reduce the computational effort.

As shown, the homogenised mechanical stress

$${σ}_{ij}^{S}$$

can be represented by a stress tensor, wherein it is sufficient to use a six-dimensional stress state vector for representation (e.g. as an input variable for a neural network), it is sufficient to use a six-dimensional stress state vector (which contains the matrix elements characterising the stress tensor in vector form, namely the diagonal elements σ₁₁, σ₂₂, σ₃₃ for the compression in the three spatial directions x, y, z and the elements σ₁₂, σ₁₃, σ₂₃ for the thrust in these directions).

Another preferred input variable (or input parameter) is, for example, a function T for the temperature-time behaviour or temperature curve function (i.e., for example, an expected subsequent cooling rate of the manufactured component and/or a special heat treatment), wherein the function can be a simple scalar, such as a cooling rate of 300K/s, or could again be represented by a vector that contains the temperature values for different points in time.

In a subsequent step S32, a database query is first performed for particularly suitable parameter sets for “fixed” criteria or requirement parameters, i.e. for those requirement parameters for which their fulfilment does not depend on the segment scanning direction distribution. One such requirement parameter is, for example, the construction rate. For example, a requirement-specific PS score could be calculated for this requirement parameter and this PS score could then be used to preselect or rank the best candidate parameter sets for subsequent selection as part of further optimization. This can speed up the process of finding the overall optimum parameter set. It is also possible to use these steps as part of the training of the AI-based optimization unit or neural network used, for example. It may then be possible to dispense with them during subsequent optimization, i.e. here in step S32, as the AI-based optimization unit takes this point into account indirectly.

Subsequently, in step S33, a database (e.g. in the data storage DS) is searched for suitable operational, i.e. already trained, neural networks NN (as AI-based optimization units) for the corresponding field variables, i.e. a search is made for neural networks NN which are trained in such a way that said field variables can be adopted as input variables for the neural network NN.

The preferred search is for neural networks that are able to utilise a combination of different types of requirement data as input variables and/or generate a combination of different types of process variables as output data. An example of such a combined neural network is a neural network that provides a pair of optimum segment scanning direction distributions and an associated optimum parameter set for the respective segment based on an input mechanical stress state. On the input side, a combination could look like this: a vector can be entered into the neural network as an input variable, which includes the stress state on the one hand and the temperature-time curve on the other (possibly as a scalar in a single vector element).

The basic structure of neural networks and training methods are sufficiently known to a person skilled in the art, so that in the following only a very rough, exemplary brief overview of a possible basic principle of neural networks that can be used in the context of the invention and possible training methods for this is given.

In principle, the neural networks NN can be constructed in the form of all previously known variants of artificial neural networks. A simple, typical schematic representation of a first neural network NPS is shown in FIG. 17. This neural network NPS is particularly simple in that only one input value, in this case the above-mentioned six-dimensional vector with the homogenised stress state

$${σ}_{ij}^{S} ,$$

leads to only one output value, in this case an optimum parameter set PS (which is represented by a scalar φ_{α}, but which stands for a fixed tuple of individual parameter values).

The input vector is usually entered into the neural network NPS (this network NPS is also representative of other neural networks in the following explanations) at a so-called “input layer” LI, which is linked to an “output layer” LH via any number of so-called “hidden layers” LH, at which the output value is ultimately output. Each of these layers contains a number of nodes or neurons and, as a rule, each neuron of a previous layer is linked to all neurons of a subsequent layer, wherein the links are associated with different weights. In order to introduce non-linearity into a neural network (as not all tasks of neural networks can be mapped with linear functions), the individual neurons or nodes can forward their result depending on a, usually sigmodal, “activation function” assigned to the respective neuron.

In a trained network, the aforementioned weights and the parameters for the activation function (“activation function parameters”) are fixed. The number of nodes in the input layer LI depends on the input variable, for example how many digits a vector to be entered has. Similarly, the number of nodes in the output layer LO depends on the output variable. The number of nodes in the intermediate hidden layer LH, as well as the number of hidden layers, is at the discretion of a person skilled in the art, who defines the network for the respective purpose before training.

When training the network, training data is used to determine the best values in the neural network, such as the weights for the links between the nodes and the activation function parameters, for example, from which the correct or optimum output variables are already known. These “correct” output variables for the input variables can be determined in advance and assigned to them, i.e. so-called “labelled” training data is used. Alternatively or additionally, the “correct” output variables for the input variables can also be determined by a parallel determination process, e.g. in a “classic” optimization process. Examples of this are given in FIGS. 18, 22, 23 and 24.

In training, an error can then be determined for each of the output variables and, with the help of error feedback and an optimization procedure, the weights can then be adjusted layer by layer and the activation function parameters adjusted in each case in order to optimize the network in turn.

A very simplified flowchart for a typical example of such training of the neural network in FIG. 17 is shown in FIG. 18. Accordingly, for an input value, here again the six-dimensional vector for the homogenised stress state

$${σ}_{ij}^{S} ,$$

an optimum parameter set PS_{OR} is sought as a comparison value or reference output variable (hereinafter also referred to as “reference value”) in a classic optimization process NO. In the classic optimization process NO, a suitable target function ZF (as explained above, for example) and/or PS scores PSS can be used for this purpose. To ensure that the optimization is not only carried out with regard to one requirement, but that all requirements can be taken into account, several or all requirement-specific PS scores PSS can preferably be taken into account in the process. In particular, the individual PS scores PSS can also be combined to form an overall parameter set suitability value PSSG (overall PS score). The transfer of the requirement-specific PS scores PSS and determination of an overall PS score PSSG by the optimizer NO is shown schematically in FIG. 18. However, a possible combination of the individual PS scores PSS to form an overall PS score PSSG in the individual segments and, if necessary, the formation of a total parameter set suitability value across all segments of the component (which can also be used sensibly here) will be explained in more detail later in conjunction with FIG. 22.

Secondly, the neural network NPS to be trained is used to search for an optimum parameter set as a “predicted value” PS_{ON}. These two optimum parameter sets PS_{OR} and PS_{ON}, which were found in different ways, are compared in a step VG to determine a suitable error value ERR. The error value ERR could, for example, be determined as a mean square error (formed, for example, on the basis of a distance between the two vectors representing the parameter sets PS_{OR}, PS_{ON} in a space which is dimensioned by the number of elements of the vectors).

In a subsequent step ES, a decision is then made as to whether this error value ERR is small enough. If this is not the case, a so-called “backpropagation” is used to correct the weights and activation function parameters in the neural network NPS to be trained, which is symbolised by step KB in FIG. 18. If the error value ERR is sufficiently small enough, the method is completed in step TE and the neural network NPS is considered sufficiently trained. In principle, however, any other suitable training method can also be used.

In the same way, a neural network NSV could be set up and trained, which finds an optimum segment scanning direction distribution SSV based on an input value, such as the six-dimensional vector

$${σ}_{ij}^{S}$$

with the stress state. A schematic representation of this is shown in FIG. 19. In the example shown there, the output value is a 360-dimensional vector with the values ψ₁, ψ₂, . . . , ψ₃₆₀, which represents the segment scanning direction distribution SSV by specifying the probabilities of occurrence of the respective angles in 360° steps in a plane, as already explained above with reference to FIG. 7. A pre-selected parameter set PS could also be used here as an additional input variable, wherein the input vector can simply be supplemented by a further vector element in the form of a scalar φ_{α}. A network NSV trained in this way could in turn be used in training for a combined neural network KNSP, KNWS (see, for example, the later explanations for FIGS. 23 and 25).

A neural network NNW could also be set up and trained in this way, which searches for an optimum parameter set PS (or an optimum segment scanning direction distribution SSV) on the basis of a different input value, such as the function T for the temperature-time behaviour. A schematic representation of a neural network for searching for an optimum parameter set PS (represented by the scalar φ_{α}) is shown in FIG. 20.

FIG. 21 shows a first example of a combined neural network KNSP. Here, an optimum combination of different output parameters is sought based on an input variable. In the example in FIG. 21, the input variable is again the six-dimensional vector σᵢⱼ with the stress state. The neural network KNSP is structured and trained in such a way that it finds an optimum combination PSV (i.e. an optimum pair) of segment scanning direction distribution SSV (again, represented by the 360-dimensional vector with the values ψ₁, ψ₂, . . . , ψ₃₆₀, wherein other step sizes and a different number of angles are also possible, i.e. the vector can have any length) and an associated parameter set PS (again represented by a scalar φ_{α}) for the respective segment.

Such a combined neural network KNSP can also be set up and trained using a procedure similar to that outlined in FIG. 18. A corresponding flow chart is shown in FIG. 22. For this purpose, it is only necessary to select or set up the classic optimization process NO′ (or the “optimizer”) in such a way that, starting from the input variable, an optimum pair of segment scanning direction distribution SSV and parameter set PS as the reference output variable or reference value PSV_{OR} is output in order to compare this with a corresponding output variable or a predicted value PSV_{ON} of the neural network KNSP to be trained in the comparator VG in the manner described above, to determine an error ERR and then to further modify the network accordingly if necessary.

For this purpose, a suitable target function ZF (as explained above, for example) and/or the parameter set suitability values or PS scores PSS described above, which are preferably requirement-specific, can be used in the classic optimization process NO′ in order to ensure that segment scanning direction distributions and parameter sets are selected which best meet the desired requirements.

As already shown schematically in FIG. 18, several or all requirement-specific PS scores PSS can also preferably be taken into account in the method, in particular also by combining the individual requirement-specific PS scores PSS to form a total parameter set suitability value PSSG (overall PS score) (the transfer of the PS score PSS and determination of the overall PS score PSSG by the optimizer NO′ is again shown schematically in FIG. 22).

If, for example, the individual requirement-specific PS score values are between 0 and 1, i.e. indicate a kind of probability of how well the specific requirement is fulfilled with the respective candidate parameter set, these requirement-specific PS scores could simply be multiplied together to determine an overall PS score. For example, if a first candidate parameter set had a PS score of 0.8 for a first requirement and a PS score of 0.2 for a second requirement, whereas another candidate parameter set had a PS score of 0.6 for both the first and second requirement, the second candidate parameter set would preferably be selected because it has an overall PS score of 0.36, whereas the first candidate parameter set only has a PS score of 0.16.

However, this presupposes that the two requirements should be weighted equally. In principle, it could also be the case that particular weight should be given to a specific requirement. This could be taken into account by a weighting factor when determining the overall PS score.

In a case where only the above-mentioned PS score

$${PSS}_{α}^{Sicherheit} ( {ϕ}_{α} , Ψ , {σ}_{ij}^{S} , … )$$

for the guarantee of a safety factor and the PS score

$${PSS}_{α}^{build} ( {ϕ}_{α} )$$

for the construction rate are to be taken into account, the following product results, for example:

$${PSSG}_{α} ( {ϕ}_{α} , Ψ , {σ}_{ij}^{S} , … ) = {PSS}_{α}^{Sicherheit} ( {ϕ}_{α} , Ψ , {σ}_{ij}^{S} , … ) \cdot {PSS}_{α}^{build} ( {ϕ}_{α} ) \qquad ( 14 )$$

By maximising the total PS score

$${PSSG}_{α} ( {ϕ}_{α} , Ψ , {σ}_{ij}^{S} , … ) ,$$

an attempt can be made to determine a segment scanning direction distribution in the respective segment for each possible parameter set, which as a pair leads to maximum overfulfilment of all criteria:

$$P S S {G}_{α}^{Opt} = {max}_{Ψ} {PSSG}_{α} ( {ϕ}_{α} , Ψ , {σ}_{ij}^{S} , … ) \qquad ( 15 )$$

This means that the total PS score

$$P S S {G}_{α} ( {ϕ}_{α} , Ψ , {σ}_{ij}^{S} , … )$$

is maximised for a fixed (candidate) parameter set by varying the segment scanning direction distribution for all possible (candidate) parameter sets for the segment. The optimum parameter set φ^{Opt} for the respective segment can then be selected from all (candidate) parameter sets with the respective optimum segment scanning direction distribution:

$${arg max}_{{ϕ}^{Opt} ∈ {ϕ}_{α}} ( {PSSG}_{α}^{Opt} ) \qquad ( 16 )$$

This results in the following formula for nested optimization:

$${arg max}_{{ϕ}^{Opt} ∈ {ϕ}_{α}} ( {max}_{Ψ} {PSSG}_{α} ( {ϕ}_{α} , Ψ , {σ}_{ij}^{S} , … ) ) \qquad ( 17 )$$

The approach described above is limited to one segment.

In order to find an optimum output variable for the entire component (i.e. suitable pairs of parameter sets and segment scanning direction distributions for the individual segments that lead to an optimum component overall), the sum of all total PS scores

$$P S S {G}_{α} ( {ϕ}_{α} , Ψ , {σ}_{ij}^{S} , … )$$

can be formed across all segments (i.e. a “sum parameter set suitability value”). A weighted sum, which must be maximised, is suitable for this purpose:

$$max = {\sum }_{s} {arg max}_{{ϕ}_{s}^{Opt} ∈ {ϕ}_{α}} ( {max}_{{Ψ}_{s}} P S S {G}_{α} ( {ϕ}_{α ; s} , {Ψ}_{s} , {σ}_{ij}^{S} , … ) ) {V}_{s} \qquad ( 18 )$$

Vₛ denotes the volume of the respective segment.

A heuristic approximation method, particularly preferably a simulated annealing method (SA method) or a quantum annealing method (QA method), can be selected as the preferred method for this optimization. For the sake of simplicity, the optimization using the heuristic approximation method, in particular the SA method or QA method, can also be carried out individually in each segment, as the commutative law applies to the sum and the sum of the partial maxima must result in the maximum. These methods are also suitable for training neural networks within the classic optimization processes NO, NO′ (e.g. as shown in FIGS. 18 and 22).

The SA or QA method is used to solve a combinatorial problem. It is used to find an approximate solution to optimization problems which, due to their high complexity, rule out the complete testing of all possibilities and mathematical optimization processes. The aim is to find an optimum from which the greatest optimization potential for a coupled geometry, scan strategy optimization can be carried out. The name of this method comes from a mathematical simulation of a cooling process, such as annealing in metallurgy. After a metal has been heated, the atoms have sufficient time to organise themselves and form stable crystals during slow cooling. This results in a state with as little energy as possible (close to the optimum). Transferred to the SA or QA method, the temperature corresponds to a probability with which an intermediate result of the optimization may also deteriorate. In contrast to a local search algorithm, the method can leave a local optimum again. Less favourable intermediate solutions are accepted because this offers the opportunity to find a better local optimum, specifically in the present case a result with an even better overall PS score.

However, both methods are known in principle (see, for example, typical solutions for the so-called “travelling salesman” problem) and therefore no longer need to be described in detail here. Suitable methods are described, for example, in “An Effective Simulated Annealing Algorithm for Solving the Traveling Salesman Problem” by Wang, Zicheng et al. in Journal of Computational and Theoretical Nanoscience, Volume 6, Number 7, July 2009, pp. 1680-1686(7), for the classic variant and in “Quantum annealing of the travelling-salesman problem” by Roman Martoňék et al. in Phys. Rev. E 70, 057701—10 Nov. 2004, for the QA method.

In order to speed up the process even further, an AI-based method can initially be used for a kind of pre-selection of suitable candidate parameter sets. This reduces the number of selectable parameter sets for which an optimized segment scanning direction distribution must be determined. In practice, the field sizes will be limited anyway. For example, a component will never exist if the permissible mechanical stress is exceeded. This permissible range of values can be described by the yield body in the case of purely elastic loading. In a preceding training session, this permissible space can now be evaluated at discrete points and the optimization carried out for these points. If this procedure is used within the otherwise classic optimization procedure NO, NO′, a hybrid procedure is actually used here to create reference values in order to train a more complex neural network

At the end, a pair consisting of the optimum parameter set and the optimum segment scanning direction distribution is available for each segment of the component as a reference value PSV_{OR} for comparison with the predicted value PSV_{ON}, which is or was found by the neural network KNPS to be trained.

Alternatively, this optimization procedure can also be carried out in advance and the optimum distribution of scan angles (optimum segment scanning direction distributions) is calculated for each segment for all possible (candidate) parameter sets and stored in a look-up table. The values in this table can then be used as labelled training data to train the neural network.

In the training methods described above (in particular in conjunction with FIGS. 18 and 22), in which a more classical and therefore more complex method is used to form the training or reference values, it must be taken into account that the training can also be carried out in such a way that the respective neural networks to be trained are first “pre-trained” using classic methods with less effort (e.g. methods that initially only work segment by segment, i.e. do not use a sum parameter set suitability value, for example) and then used for further training (a type of “fine-tuning” or so-called “transfer training”). For example, methods that initially only work segment by segment, i.e. do not use a sum parameter set suitability value, for example) and then for further training (a kind of “fine tuning” or so-called “transfer learning”) the reference values are created using a more complex method, for example with a sum parameter set suitability value, in order to take into account the optimization in the entire component. If (different) components with similar (standard) segments are repeatedly created, it would also be conceivable to store pre-trained neural networks for these segments in a database, which are then individually “re-trained” for the respective component using a more complex optimization process.

AI-based optimization units or neural networks can also be pre-trained for certain groups of requirements and/or process parameters, which can then be individually retrained for the respective current requirements or process parameters using transfer learning. For example, a neural network that has been trained for a specific type of steel as a construction material could be quickly retrained for other similar types of material.

If the combined neural network KNSP trained with a previously described optimization process or the derived data generated therefrom is later used in the optimization process (for example in step S3 of the method according to FIG. 12), the optimized process variable values for the component are ultimately determined in such a way that optimized process variable values are determined for the individual segments, which are optimized with regard to a total parameter set suitability value in the respective segment and with regard to a total parameter set suitability value in the component as a whole.

FIG. 23 shows a flowchart for a possible method for training such a combined neural network KNSP as quickly as possible, which again provides an optimum combination of segment scanning direction distribution SSV and parameter set PS based on the state Q as the input variable for the respective segment as the output variable.

Similarly to the procedure shown in FIG. 22, the input variable σᵢⱼ^{s} is also fed to the neural network NPS to be trained, which determines an optimum combination of segment scanning direction distribution SSV and parameter set PS. This pair is used as the predicted value PSV′_{ON} for further comparison with the reference value. However, instead of using a more complex, special, classic optimization process to determine the reference value PSV′_{OR} as in FIG. 22, two previously trained, simpler neural networks are used here, namely a network NPS, which determines an optimum parameter set PS_{ON} based on the input value σᵢⱼ^{s}, and on the other hand a previously trained neural network NSV, which searches for an associated optimum segment scanning direction distribution SSV based on the input value σᵢⱼ^{s} and the optimum parameter set PS_{ON} found by the first network NPS, so that an optimum combination of parameter set PS and segment scanning direction distribution SSV is ultimately determined as the reference value PSV′_{OR}. Here too, the two optimum parameter sets PSV′_{OR}, PSV′_{ON} found in different ways are compared in a step VG in order to determine a suitable error value ERR, such as the above-mentioned least mean square. In a subsequent step, a decision is made as to whether this error value ERR is small enough. If this is not the case, the weights and activation function parameters in the neural network are corrected again using a so-called “back propagation”, which is symbolised by step KB in FIG. 23. If the error value ERR is sufficiently small enough, the process is completed in step TE and the neural network is considered sufficiently trained.

The prerequisite for this is, of course, the existence of already trained neural networks NPS, NSC for the individual values. It should be noted here that the NSC network for the determination of the optimum segment scanning direction distribution must be structured and optimized in such a way that it also finds these on the basis of the stress state and an already specified optimized parameter set as input variables. This means that ultimately this is also a combined neural network, except that two different types of input variables are used here to find an output value (the segment scanning direction distribution).

It should also be noted that an optimum parameter set PS_{ON} that has been pre-selected in the first neural network NPS is used to create the reference variable or reference value PSV′_{OR} and the second neural network NSV works with this fixed value and only searches for the appropriate segment scanning direction distribution SSV for this. In other words, in contrast to the method shown in FIG. 22, the method shown in FIG. 23 no longer tries out a large number of possible combinations on the training side by first optimizing the segment scanning direction distribution SSV for all possible parameter sets and then checking which pair forms the best overall PS score. In return, however, this method is considerably faster when training a neural network KNSP and the results of this combined neural network KNSP are perfectly adequate for the entire method, as the output variable found (i.e. the pair of parameter set and segment scanning direction distribution) is only a first approximate solution, which is generally modified in later stages of the method (see FIG. 12). However, the entire process is improved by finding a better starting point for the subsequent method steps. In particular, the process converges more quickly, i.e. the subsequent optimum solution is found more quickly.

FIG. 24 shows a schematic representation of an example of an even more complex combined neural network KNWS and FIG. 25 shows a flow diagram for a possible training procedure.

Like the neural network KNSP shown in FIG. 21, this neural network KNWS is also structured and trained in such a way that it outputs an optimum combination of segment scanning direction distribution SSV (represented by the 360-dimensional vector with the values ψ₁, ψ₂, . . . , ψ₃₆₀) and an associated parameter set PS (again represented by a scalar #y) based on an input variable for the respective segment at the output layer LO as output variable PSV′. In contrast to the neural network KNSP shown in FIG. 21, however, the input variable is now also a combination of two different types of requirement data. In this case, a seven-dimensional vector is used at the input layer LI as the input variable, which comprises the six-dimensional vector with the stress state

$${σ}_{ij}^{S}$$

and also contains a scalar value as a further vector element, which represents the function \dot{T} for the temperature-time behaviour (i.e. here, for example, a simple cooling rate in K/s).

The simplified flow chart shown in FIG. 25 shows that a possible method for training such a combined neural network KNWS as quickly as possible can be structured very similarly to the method shown in FIG. 23. The key point here is again that previously trained simpler neural networks NNW, NPS, NSV are used to determine an optimum combination of parameter set PS and segment scanning direction distribution SSV as the reference value PSV″_{OR}.

Here, too, a trained neural network NPS is used, which determines a mechanical stress-optimized parameter set PS_{σ} based on the input value

$${σ}_{ij}^{S} ,$$

and a trained neural network NSV, which determines an associated optimum segment scanning direction distribution SSV based on the input value

$${σ}_{ij}^{S}$$

and a pre-optimized parameter set PS_{OR}, which was found using the neural network NPS. These neural networks NPS, NSV can therefore in principle be the same networks as those used in the method according to FIG. 23.

In addition, another trained neural network NNW is used to determine a temperature-optimized parameter set PST based on the temperature curve function \dot{T} as an input variable.

The mechanical stress-optimized parameter set PS_{σ} and the temperature-optimized parameter set PST are then initially fed to a parameter set selector PAS as input variables. This is used to decide which parameter set is to be transferred to the neural network NSV as the parameter set input variable PS_{ON} to determine an optimum segment scanning direction distribution SSV. For this selection, the parameter set selector PAS can preferably use a so-called “policy reinforcement learning method”. The neural network NSV can then output the pair of optimum parameter set PS_{ON} and optimum segment scanning direction distribution SSV as the reference value PSV″_{OR}. Suitable “policy reinforcement learning methods” are known to a person skilled in the art and can be found, for example, in “Learning to Optimise” by Ke Li, Jitendra Malik in arXiv:1606.01885, 2016 and International Conference on Learning Representations (ICLR), 2017, or in “Learning to Optimize Neural Nets” by Ke Li, Jitendra Malik in arXiv:1703.00441, 2017.

In parallel, the input variables

$${σ}_{ij}^{S} , \dot{T}$$

are again fed to the neural network KNWS to be trained, which provides an optimum combination of segment scanning direction distribution SSV and parameter set PS as the predicted value PSV″_{ON} for further comparison in step VG with the reference value PSV″_{OR}.

Based on the error value ERR determined here (such as a least mean square as mentioned above), a decision can then be made again (in block ES) as to whether this error value ERR is small enough and the neural network KNWS is considered sufficiently trained (block TE) or whether a further correction of the weights and activation function parameters in the neural network KNWS in block KB makes sense.

In this method according to FIG. 25, it is also the case that a fixed pre-selected optimum parameter set PS_{ON} is included in the creation of the reference output variable or reference value PSV″_{OR} and the second neural network NSV works with this fixed value and only searches for the appropriate segment scanning direction distribution SSV for this. As already mentioned, an output value PSV″ found later by the combined neural network trained in this way is only a first approximate solution, which is usually modified in later stages of the process anyway.

If a suitable neural network NN is found, the data of this neural network NN can be loaded into the database in step S34 (in the method according to FIG. 16) or, specifically, the weights for the links between the nodes of the various layers LI, LH, LO and the activation function parameters of the various nodes of the trained neural network are loaded. It should be mentioned at this point that the reference number NN in the figures can stand for any AI-based optimization unit NN suitable for the respective target, in particular also for the neural networks NPS, NSV, NNW, KNSP, KNWS described above.

With this data of the selected neural network NN or the selected neural networks NN, the respective optimum segment scanning direction distribution and the corresponding best parameter set can then be quickly calculated in step S35 on the basis of the input data.

In the next step S36, an update of the current segment scanning direction distributions and the parameter sets in the relevant segments for further optimization then follows accordingly in the method sequence, and in the method according to FIG. 12, work is carried out with these new segment scanning direction distributions and parameter sets.

At the end of step S3, the same segments SG′ may then still be present, but some of the segments SG′ should preferably be assigned better current parameter sets that better fulfil the requirements.

Following step S3, the target function ZF can then be used in step S4 (see FIG. 12) to optimize the boundaries of the segments, i.e. an attempt is made to achieve an even better result by shifting individual segment boundaries in certain regions. To this end too, KI-based optimization units or neural networks NN can be used in an assisting way. This explicitly includes not only shifting segment boundaries of segments within the component, but also possibly segment boundaries between segments at the edge of the component and outer powder segments in the area. This means that the outer contours of the component may also change under certain circumstances, for example that certain struts are thickened or thinned, depending on what is required for the specific case. In this way, the component geometry can be optimized at the same time.

The optimization options in step S4 are also explained in DE 10 2022 117 935, although not all of the options described there need to be used.

At the end of step S4, improved segments (and optionally already further-improved segment scanning direction distributions and parameter sets) could then be available to match the parameter sets selected in step S3 in terms of their geometry or segment boundaries.

In step S5, the approach from step S2 is repeated, i.e. a new state description (also referred to synonymously as a system description) is determined with the current process variable values, i.e. the current segments, the current parameter sets and the current segment scanning direction distributions, and it is checked whether all requirements, in particular the quality requirements, are sufficiently fulfilled.

If the requirements are not sufficiently fulfilled, the system returns to step S4. This loop between steps S4 and S5 is run through until a cancellation criterion is reached, i.e. until, for example, the changes between two iteration steps with regard to the specified quality criteria become very small. It can then be assumed that almost the best combination for the present load case is available.

In the following step S6, which comprises three sub-steps S6a, S6b and S6c, it is checked whether all regions in which powder is present also have a path out of the component. This is to ensure that no powder remains in the component after unpacking, for example in cavities that are not connected to the outer space, at least in cases where a cavity filled with powder is not deliberately desired in the component.

For this purpose, in step S6a, the powder can be assumed to be a viscous fluid that flows out of the cavities.

By returning to step S4, in which the target function ZF is also used to modify the segment boundaries, the segment boundaries can then be changed so that the regions with powder inclusions can be minimized or completely removed. This can be done in a loop, which attempts for a certain number of iterations to either move the inclusions by changing the geometry of the segments so that they are finally located on the component surface, or the inclusions are filled with molten material, i.e. the powder-filled cavities are removed. Here, for example, the cancellation criterion can again be that no more relevant changes are made in the loop or that a maximum number of iteration steps have been completed.

Subsequently, in the optional step S6b, a so-called Minkowski subtraction can be carried out in those regions where powder inclusions may still be present in order to remove these regions from the computational grid by erosion, similarly to image processing methods.

In a final step S6c, the system then checks whether there are still any powder inclusions. If this is the case, these regions are removed by returning to step S3. There, a new parameter set is selected for the region in question, which leads to the region being solidified, and the complete optimization is then carried out again with the new parameter set, starting from step S3.

However, steps S6a to S6c are explained in more detail in DE 10 2022 117 935, so that reference is also made thereto.

It should be noted that the depowdering step S6 is deliberately carried out separately after the optimization of the other points within the target function in step S4. This is possible by setting the pressure to 0 everywhere during the first run and thus optimizing all other criteria first in the previous run of steps S4 and S5 and not already performing depowdering. With regard to the depowdering criterion, the target function ZF or the corresponding sub-function is initially set to 0 as inactive everywhere in the area due to a skillful choice of parameters. This approach can save computing time if, at the beginning of the optimization in a start configuration, a solution is initially available of which the form is even further away from the optimum form and therefore a large number of passes through the iteration loop between steps S4 and S5 are to be expected.

Steps S7 and S8 are purely optional and can be used to compensate for any errors generated in the previous steps due to the homogenisation of the states of the segments (e.g. the determination of an average state for each segment, even if this varies spatially over the respective segment), since such homogenisation may contain a certain error. However, homogenisation in conjunction with AI-based optimization can in any case achieve at least a very good approximation of the optimum, which is close to the real optimum, so that as a rule only minor “re-optimization” (a “fine tuning”, so to speak) would take place here. In this approach, step S8 corresponds to step S5 or S2, i.e. a state description and check is carried out here to determine the extent to which the system or component would fulfil the requirement with the current segments and the parameter sets currently assigned to the segments, and, if the requirements are not sufficiently fulfilled, a return to step S7 takes place. This loop between steps S7 and S8 is run through again until a cancellation criterion is reached, i.e. until, for example, the changes between two iteration steps become very small with regard to the specified quality criteria. For the exact procedure in steps S7 and S8, reference is again made to DE 10 2022 117 935. In steps S7 and S8, any spatial variation of the state (e.g. of the mechanical stress) within the segments is now also taken into account, so that these steps are naturally more complex than steps S2 and S5, for example. However, since it is already certain that the current state at the start of these steps S7 and S8 is very close to the optimum, only a few iterations are required here.

Lastly, step S9, which is also optional, deals with any planned heat treatment of the subsequently manufactured component (if the heat treatment was not already taken into consideration sufficiently in step S3 with the aid of the neural networks). It comprises two sub-steps S9a and S9b here. In step S9a, a virtual heat treatment is carried out for the (still) virtual component to be manufactured and the characteristic temperature profiles from this simulated heat treatment are stored for each point. In the subsequent step S9b it is then checked whether the simulated temperature profiles are within the permissible boundaries of the necessary heat treatment, for example whether it has become too hot or not hot enough at some points in the component. If the limit values are exceeded, a return to step S2 can take place so that the entire optimization is ultimately carried out again with a new start configuration, wherein the start configuration is then selected in such a way that the heat treatment problem is likely to be eliminated. If, on the other hand, the requirements in the context of the heat treatment are met, the end of the optimization process is finally reached and the desired optimized process variable values PGO are available, namely in the form of optimum segment boundaries SGG, optimum parameter sets PS and optimized segment scanning direction distributions SSV.

The optimization of the segment boundaries SGG can also include an optimized orientation of the object in relation to the main build direction, i.e. the z-direction, in which the layers are stacked on top of each other. The segment boundaries can also be modified with the aim of achieving a reorientation or optimization of the orientation of the component relative to the main build direction. A suitable orientation in the build space can, for example, reduce or minimize overhangs and/or support. In this regard too, refer to further explanations in DE 10 2022 117 935.

Lastly, it should be noted that optimization is preferably carried out simultaneously for all segments of the component as part of the optimization process, i.e. not only are the start segment boundaries determined for all start segments SG′ at the beginning in step S1, for example, but the other start parameter sets PS′ and start segment scanning direction distributions SSV′ are also set and always optimized together in the respective steps. This is particularly useful when using AI-based optimization units in accordance with the invention, as the optimization can be performed considerably faster than with classic optimization.

In the optimization process according to FIG. 12, the current configuration is evaluated in several steps as explained above, for example in steps S2, S5 and S8. This involves checking whether a constriction process in which the segments currently present in the optimization process (i.e. the current segment boundaries) and the current parameter sets and current segment scanning direction distributions SSV associated with the segments are used would result in a component that meets certain requirements. This means that a state description of the virtual component can be determined by means of a state simulation and the state description can be compared with predefined (quality) requirements in a further step, if necessary.

Macro property values of the individual segments can be used for state determination or for determination of the state description. Such macro property values, as mentioned, can be, in particular, the texture in the segment, which can be described by the orientation density function ODF as mentioned above, but also other macro property values derived from this, such as the elasticity sensor, the yield point distribution, solidification coefficients, thermal conductivity, breaking strength, etc.

FIG. 26 is now used to explain how, with a known parameter set PS for the structure of the layers of a segment and a known segment scanning direction distribution SSV of the segment, a macro property value MWA of the relevant segment can be determined in a suitable device 70 or unit for determining macro properties.

It is explicitly pointed out that this device 70 can advantageously also be realized in the form of software on a suitable computer unit. In particular, it can therefore be integrated into the optimization process, for example as a software object or sub-routine. Similarly, all other components of the device 70 now described, such as the interfaces and the database system, can be realized in software. Furthermore, however, it is also possible, for example, to realize interfaces partly from hardware and partly from software and, for example, to realize the entire device 70 distributed on different computer units which are linked to each other in a suitable manner. This applies in particular to the database system DBS used by the device 70, which here comprises, for example, a macro property database EDA and a basic property database EDB, which can also be very easily outsourced to other computer and storage units. The functions and data content of the macro property database EDA and the basic property database EDB and options for setting up such databases EDA, EDB are explained below.

For example, the current parameter set PS can be transferred via a parameter set interface unit 72, and a current segment scanning direction distribution SSV for the segment manufacturing process can be transferred via a scanning direction interface unit 73. Furthermore, the device 70 can have an interface 74 via which segment information SGI can be transferred, i.e. information about the segment, such as the number of layers, the current segment boundaries, etc., can be adopted.

All this information can then be used in a macro property determination unit 71 to determine the macro property value MWA or, better still, a whole group of macro property values for the segment in question, to which the current parameter set PS and the current segment scanning direction distribution SSV as well as the segment information SGI are to be assigned. The mode of operation of this macro property determination unit 71 is shown in FIG. 26 within the macro property determination unit 71 in a very simplified manner in the form of a flowchart.

In a first step MS1, the macro property database EDA can first be queried to determine whether a ready-made macro property value MWA is already stored for a specific combination of parameter set PS and segment scanning direction distribution SSV. If this is the case, then this macro property value MWA is simply adopted and this macro property value MWA can be returned by the macro property determination unit 71 via an interface 75 of the device 70, for example to a higher-level software component, which then continues to work with this macro property value MWA.

Preferably, macro property values MWA are stored in the macro property database EDA for those combinations of parameter sets PS and segment scanning direction distributions SSV that occur particularly frequently, i.e. that are standard combinations that are used repeatedly. Of course, this macro property database EDA can be expanded gradually.

If the query in the macro property database EDA was not successful, a new macro property value MWA must be determined for the current individual case based on the current parameter set PS and the current segment scanning direction distribution SSV. For this purpose, in a further step MS2, a current basic property value BEW for the individual layers is first queried in a basic property database EDB for the current parameter set PS. Such a basic property value BEW can be, for example, the texture and/or a microstructure MS of the layer, but also values derived therefrom that apply to the respective layer. Preferably, however, work continues with the texture TX, which is described by an ODF, and the microstructure MS is also used.

In a third step MS3, the basic property values BEW for the individual layers are then mathematically homogenized, i.e. the basic property values BEW of the individual layers of the segment are combined in a suitable manner in order to approximate the macro property value MWA of the complete segment. The information on the number of layers, the layer scanning direction arrangements in the layers and the rotations of the layers relative to each other, which lead to the current segment scanning direction distribution, is used here.

As part of this homogenization process in step MS3, for example, a mean value of the basic property values of the individual layers can easily be formed, wherein this mean value then forms the desired macro property value MWA. Alternatively, the reciprocal value of the mean values of the basic property values BEW of the individual layers can be determined first and then the reciprocal value of this mean value of the reciprocal values is formed. This reciprocal value of the mean value then forms the macro property value. Which of the two methods is used can depend on what the microstructure MS of the individual layers looks like and what the current load requirements are.

It should be noted at this juncture that, as already mentioned above, the basic property values BEW of the individual layers do not differ significantly, provided they were produced with the same parameter set PS (i.e. also the same hatching strategy), except for the fact that the orientation of the basic property values also changes with the change in orientation relative to the (in principle arbitrarily definable) reference orientation RO between the layers. This naturally leads to a change of orientation in the texture TX. Ultimately, this also has an influence on all property values in the form of direction-dependent material parameters, for example the elasticity tensor or the yield point distribution, for example in the form of the Hill tensor, which can be very different in different directions. However, it is sufficient to know the basic property values for one orientation, preferably the reference orientation. The basic property values for the other orientations can be calculated from this using simple operators, e.g. a simple rotation.

The macro property value MWA determined in step MS3 can then also be output again via the interface 75, e.g. to a higher-level unit, which then continues to work with it.

In addition, this macro property value MWA could also be stored in the macro property database EDA together with the parameter set PS on which the calculation was based and the associated segment scanning direction distribution SSV. If the macro property database EDA has sufficient space, any new macro property value MWA could in principle also be stored in the macro property database EDA. Preferably, however, this is not necessarily done for very rare parameter sets PS or segment scanning direction distributions SSV, for example. In principle, the system can also be designed to learn, i.e. that, for example, a list is used to note which parameter combinations PS, SSV occur particularly frequently, and the macro property database EDA is then gradually expanded for these parameter combinations, or vice versa, each macro property value MWA is initially stored in the macro property database EDA and then deleted again if it is no longer queried for a certain period of time, in order to create memory space for other combinations.

The structure of a basic property database EDB, for example by producing and measuring various test specimens in various test production processes in order to determine the basic property values BEW achieved with the various parameter sets for one or more layers of the test specimen, is explained in greater detail in DE 10 2022 117 935 and in particular also in DE 10 2022 117 936 with reference to several figures, so that reference can be made to them. The content of these documents is therefore also incorporated here.

As explained above, the method and the device for determining property values of a segment or for checking a current state of a segment as to whether it fulfils certain conditions can be used in particular within an optimization process in order to determine suitable process variable values for the production of a product.

In principle, however, it is also possible to carry out such a check completely separately from such an optimization process, for example to check, before use, control parameters that are intended for the manufacture of a component but were created in a different way than in the aforementioned optimization process. It is also possible to subsequently check components that have already been manufactured, which are not to be destroyed and on which certain load tests cannot therefore be carried out. For this purpose, it is sufficient to know the process variables used during production and required for the process described above.

A possible structure of a testing device 80 which can be used for this purpose and a test method are described in detail, for example, in the patent application DE 10 2022 117 935 (see there, for example, FIGS. 24 and 25 with the associated description), to which reference can be made here in this respect or the content of which should be regarded as incorporated here in this respect. The verification device and the verification method described therein are equally applicable in conjunction with the devices and methods described in the present application.

Lastly, it should be pointed out once again that the devices and methods described in detail above are merely exemplary embodiments which can be modified by a person skilled in the art in a wide variety of ways without departing from the scope of the invention. In particular, the optimization process can be adapted almost at will to the current requirements and, for example, additional steps can be incorporated or steps can be combined or optimization criteria can be exchanged or extended. Optimization criteria can also be taken into account in different ways. It should also be noted at this juncture that although the method described above for forming a target function using a weighted sum of sub-functions may be preferred, the method is not necessarily limited to this. For example, sub-functionals can also be defined in the form of constraints, e.g. using the Lagrange multiplier method. These constraints can be, for example, equality or inequality constraints. Explanations in this regard can be found in basic works such as C. Richter, Optimierung in C++: Grundlagen und Algorithmen, 2016, Wiley-VCH, Berlin. With regard to AI-based optimization units, it should be pointed out once again that AI methods and concepts other than the neural networks described above can also be used. In particular, the training methods can be modified and adapted to the respective requirements. Furthermore, the use of the indefinite article “a” or “an” does not exclude the possibility that the features in question may be present more than once. Likewise, the term “unit” does not exclude the possibility that it consists of several interacting sub-components, which may also be spatially distributed.

### LIST OF REFERENCE SIGNS

1 production device/laser melting device
2 manufacturing product/component/object
2′ manufacturing product/component/buffer stop
2″ manufacturing product/component/square bar
3 process space/process chamber
4 chamber wall
5 container
6 container wall
7 working plane
8 construction field
10 carrier
11 base plate
12 construction platform
13 construction material (in container 5)
14 storage container
15 construction material (in storage container 14)
16 coater
17 radiant heater
20 irradiation device/exposure device
21 laser
22 impact surface of the energy beam
23 deflection device/scanner
24 focussing device
25 coupling window
50 controller
51 control unit
53 irradiation control interface
54, 54′ control data generation device
55 bus
56 terminal
57 data generation unit
58 decision unit
60 device for generating optimized process variable values
61 requirement interface unit
62 interface
63 interface
64 process variable interface unit
65 optimization unit/optimizer
70 device for determining property values
71 macro property determination unit
72 parameter set interface unit
73 scanning direction interface unit
74 interface
75 interface
80 testing device
AD requirement data
BEW basic property values
BSD control data/exposure control data
DBS property database system/database system
DS data memory
E energy beam/laser beam
EDA macro property database
EDB basic property database
ERR error value
ES method step decision
FS focus control data
G area
GD geometric data
H horizontal direction
HS heating control data
HS2, HS3 layer scanning direction arrangement/hatching direction arrangement/hatching strategy
HWR main heat flow direction
KB Back propagation step
KNSP, KNWS combined neural network
KPS candidate parameter sets
L, L1, L2, L3, L4 layers
LH hidden layer
LI input layer
LO output layer
LS laser control data
MS microstructure
MS1, MS2, MS3 method steps
MWA macro property values
NN AI-based optimization unit/neural network
NNW, NPS, NSV AI-based optimization unit/neural network
NO, NO′ classic optimization process/optimizer
PAS parameter set selector
PGO optimized process variable values
PS parameter set
PS′ start parameter set
PS_{ON}, PSV_{ON}, PSV′_{ON}, PSV″_{ON} predicted values
PS_{OR}, PSV_{OR}, PSV′_{OR}, PSV″_{OR} reference value
PSV″ output variable
PS_{σ} input variable/stress-optimized parameter set
PST input variable/temperature-optimized parameter set
PSD control data/process control data
PSS parameter set suitability value/PS score
PSSG overall PS score
QA quality requirements/quality requirement data
RO reference orientation
S scanning direction/movement direction of the impact surface
SD scan control data
SG segments
SG′ start segments
SGG segment boundaries
SGI segment information
SG0 powder segment
SG1, SG2, SG3 segments
SSV segment scanning direction distribution
SSV′ start segment scanning direction distribution
SSV1, SSV2, SSV3, SSV4 segment scanning direction distribution
ST coating control data
S0 to S10 method steps
S31 to S36 sub-steps
S6a, S6b, S6c, S9a, S9b sub-steps
TE method step end
TF1, . . . , TFi, . . . , TFn sub-functions/sub-functionals
TSD carrier control data
TX texture
V vertical direction
VG method step comparison
x, y spatial directions in layer plane
z main build direction
ZF target function
φ_{α} process parameter set

$${σ}_{ij}^{S}$$

homogenized field variable/homogenized stress state/input variable
φ₁₁, φ₂₂, φ₃₃, σ₁₂, σ₁₃, σ₂₃ matrix elements of the homogenized stress state
\dot{T} temperature profile function/cooling rate/input variable
ψ₁, ψ₂, . . . , ψ₃₆₀ values of the segment scanning direction distribution SSV

1. A method for generating optimized process variable values for an additive manufacturing process of a manufacturing product from a plurality of layers of a construction material, said method having the following method steps:
providing requirement data of the manufacturing product,
performing an optimization process in order to determine the optimized process variable values while taking into consideration the requirement data, wherein at least one optimized scanning direction distribution for at least one region of the manufacturing product is determined as an optimized process variable value using an AI-based optimization unit, and
providing the optimized process variable values.

2. The method according to claim 1, wherein in the optimization process at least one optimum parameter set, which comprises a defined group of process parameter values, is selected as at least one further optimized process variable value from a number of candidate parameter sets, using an AI-based optimization unit.

3. The method according to claim 1, wherein the manufacturing product is divided into a plurality of segments using geometric data of the requirement data, and the optimization process is carried out in such a way that optimized process variable values are determined for each of the individual segments.

4. The method according to claim 1, wherein the optimization process comprises a plurality of iteration steps and at least one AI-based optimization unit is used in at least one iteration step and/or wherein in the optimization process at least one start process variable value is first determined using an AI-based optimization unit.

5. The method according toa claim 1, wherein at least one AI-based optimization unit comprises at least one neural network.

6. The method according toa claim 1, wherein at least one parameter set suitability value is determined for at least one region of the manufacturing product, for at least a number of possible scanning direction distributions and/or at least some of the candidate parameter sets in each case, and an optimized scanning direction distribution is determined and/or an optimum parameter set is selected from the candidate parameter sets using the parameter set suitability values,
wherein parameter set suitability values are determined for different pairs of segment scanning direction distributions and candidate parameter sets in each case.

7. The method according to claim 6, wherein for at least some of the scanning direction distributions and/or candidate parameter sets, several requirement-specific parameter set suitability values are determined for different requirement data in each case,
wherein the requirement-specific parameter set suitability values for a scanning direction distribution and/or a candidate parameter set are combined to form an overall parameter set suitability value in each case.

8. The method according to claim 7, wherein, within the optimization process, optimized process variable values are determined for the manufacturing product such that optimized process variable values are determined for each of the individual segments and are optimized in respect of an overall parameter set suitability value in the respective segment and in respect of a sum parameter set suitability value in the manufacturing product.

9. The method according to claim 6, wherein a scanning direction distribution is determined and/or an optimum parameter set is selected from the candidate parameter sets for a segment using the AI-based optimization unit,
wherein an AI-based optimization unit is used, during the generation of which the AI-based optimization unit was trained using parameter set suitability values.

10. The method according tom claim 8, wherein the process variable values optimized in respect of a sum parameter set suitability value in the manufacturing product is determined using a combinatorial optimization process, a simulated annealing method and/or a quantum annealing method.

11. A method for generating control data for a production device for additive manufacturing of at least one manufacturing product from a plurality of layers of a construction material in an additive manufacturing process, said method having the following method steps:
providing optimized process variable values generated for the additive manufacturing process in a method according to claim 1,
generating the control data for the production device in such a way that the optimized process variable values in the additive manufacturing process are sufficiently achieved in accordance with a predefined evaluation criterion,
wherein, within the additive manufacturing process, construction material is built up and selectively solidified, wherein, for solidification on a construction field, the construction material is irradiated with at least one energy beam, wherein an impact surface of the energy beam is moved on the construction field in order to melt the construction material in a target region in and around the impact surface.

12. A method for controlling a production device for additive manufacturing of a manufacturing product, wherein control data for the device is generated according to a method according to claim 11 and the production device is controlled using this control data.

13. A method for creating an AI-based optimization unit, to determine optimized process variable values for a plurality of different types of requirement data, the method comprising:
generating optimized process variable values for an additive manufacturing process of a manufacturing product from a plurality of layers of a construction material by:
providing requirement data of the manufacturing product;
performing an optimization process in order to determine the optimized process variable values while taking into consideration the requirement data, wherein at least one optimized scanning direction distribution for at least one region of the manufacturing product is determined as an optimized process variable value using an AI-based optimization unit; and
providing the optimized process variable values;
training at least one first AI-based optimization unit, which determines optimized process variable values of a first type of process variable based on a first type of requirement data; and
training at least one second AI-based optimization unit, which determines optimized process variable values of a second type of process variable based on the first type of requirement data or which determines optimized process variable values of the first type of process variable and/or optimized process variable values of the second type of process variable based on a second type of requirement data; and
creating and an AI-based combination optimization unit is then created using a training method in which at least the first and second AI-based optimization units are coupled together to monitor the training of the AI-based combination optimization unit.

14. A device for generating optimized process variable values for an additive manufacturing process of a manufacturing product, said device having the following units:
a requirement interface unit, designed to provide requirement data of the manufacturing product,
an optimization unit, designed to carry out an optimization process in order to determine the optimized process variable values while taking into consideration the requirement data, comprising at least one AI-based optimization unit in order to determine at least one optimized scanning direction distribution for at least one region of the manufacturing product as an optimized process variable value,
a process variable value interface unit, designed to provide the optimized process variable values.

15. A control data generation device for generating control data for a production device for additive manufacturing of a manufacturing product in an additive manufacturing process,
in which manufacturing process construction material is built up and selectively solidified, wherein the construction material is irradiated with at least one energy beam for solidification on a construction field, wherein an impact surface of the energy beam is moved on the construction field in order to melt the construction material in a target region in and around the impact surface,
wherein the control data generation device comprises at least the following units:
a device according to claim 14 and/or an interface to a device according to claim 14 for transferring optimized process variable values,
a data generation unit for generating the control data for the production device in such a way that the optimized process variable values are sufficiently achieved in the additive manufacturing process in accordance with a predetermined evaluation criterion.

16. A controller for a production device for additive manufacturing of a manufacturing product in an additive manufacturing process, wherein the controller comprises a control data generation device according to claim 15 and/or an interface to a control data generation device according to claim 15 for transferring control data and is designed to control the production device using this control data.

17. A production device for additive manufacturing of manufacturing products in an additive manufacturing process with at least one controller according to claim 16.

18. A non-transitory computer-readable recording medium having stored thereon instructions that cause a processor to carry out all the steps of the method according to claim 1.

19. (canceled)

20. (canceled)
